(19) United States
(12) Patent Application Publication
(10) Pub. No.: US 2015/0332545 A1
(43) Pub. Date: Nov. 19, 2015

(54) GAMING MACHINE

(71) Applicants: UNIVERSAL ENTERTAINMENT CORPORATION, TOKYO (JP); ARUZE GAMING AMERICA, INC., Las Vegas, NV (US)

(72) Inventors: Kenta KITAMURA, Tokyo (JP); Susumu MIO, Tokyo (JP); Ai GENDA, Tokyo (JP)

(73) Assignees: Universal Entertainment Corporation; Aruze Gaming America, Inc.

(21) Appl. No.: 14/712,935

(22) Filed: May 15, 2015

(30) Foreign Application Priority Data
May 16, 2014 (JP) 2014-102184

(51) Int. Cl. G07F 17/32; G07F 17/34

(52) U.S. Cl. CPC G07F 17/3213; G07F 17/34

(57) ABSTRACT

Provided is a gaming machine that can prevent the player from getting bored with symbol effects until the symbols have been rearranged. The gaming machine randomly determines symbols to be rearranged in a display region, identifies an arrangement pattern of special symbols in the display region determined with the symbols determined in the symbol determination processing, and determines symbol effects by motion of symbols from start of movement until completion of rearrangement of the symbols based on the arrangement pattern.

### CROSS-REFERENCE TO RELATED APPLICATIONS

This application claims the benefit of Japanese Patent Application No. 2014-102184 filed on May 16, 2014, which application is incorporated herein by reference in its entirety.

### FIELD OF THE INVENTION

The present invention relates to a gaming machine and, in particular, relates to a gaming machine that rearranges symbols in each unit game, in the process of which the manner of scrolling the symbols is changed to produce effects.

### BACKGROUND OF THE INVENTION

A gaming machine scrolls symbols and rearranges a part of the symbols in a display area in each unit game. If a winning pattern is made in the display area with the rearranged symbols, the player gains a benefit (for example, refer to U.S. Pat. No. 4,097,048).

Considering diverse tastes of players, various gaming machines have been developed. For example, gaming machines different in symbol pattern, game scenario, effects (by sound, image, or reel action) have been developed. Gaming machines that offer a bonus game or a free game under predetermined conditions have also been developed (for example, refer to U.S. Pat. Nos. 4,508,345 and 7,942,733).

In typical, effects by images are provided by a liquid crystal display device. Scrolling symbols may be performed by so-called video reels or by mechanical reels which are made of annular reel strips with symbols thereon.

The mechanical reels are real reels with symbols thereon to be rotated mechanically; the manner to rearrange the symbols tends to be monotonous compared with video reels that display symbols on a liquid crystal display device.

### BRIEF SUMMARY OF THE INVENTION

The present invention has been accomplished in view of the foregoing issues and an object of the present invention is not to bore the player with symbol effects until the symbols have been rearranged.

A gaming machine according to an embodiment is a slot machine comprising:

a symbol display device including a display region for displaying a result of a unit game by rearranging symbols including special symbols; and

a controller programmed to perform the following processing of (1-1) to (1-3):

(1-1) symbol determination processing of randomly determining symbols to be rearranged in the display region;

(1-2) processing of identifying an arrangement pattern of the special symbols in the display region, the arrangement pattern being determined with the symbols determined in the symbol determination processing; and

(1-3) symbol effect determination processing of determining symbol effects by motion of symbols from start of movement until completion of rearranging the symbols based on the arrangement pattern.

Since the symbol effects by motion of symbols from start of movement until completion of rearranging of the symbols are determined based on an arrangement pattern of special symbols, symbol effects associated with the symbols to be finally rearranged can be determined. Symbol effects matching and consistent with the symbols to be finally rearranged can be provided.

In the gaming machine according to an embodiment, the controller is programmed to perform the following processing of (2-1) and (2-2):

(2-1) processing of identifying the number of special symbols to be displayed among the symbols determined in the symbol determination processing; and

(2-2) symbol effect determination processing of determining symbol effects by motion of symbols from start of movement until completion of rearranging the symbols based on the number of special symbols to be displayed and the arrangement pattern.

Since the symbol effects are determined based on both of the number and the arrangement pattern of special symbols, diverse symbol effects that are consistently and smoothly played out can be provided.

In the gaming machine according to an embodiment,

the symbol display device is capable of displaying a plurality of symbol arrays being scrolled, the plurality of symbol arrays being composed of the symbols,

the symbol display device starts the movement by starting displaying scroll of all the symbol arrays, and

the symbol display device completes the rearranging by stopping displaying the scroll of all the symbol arrays.

The symbol effects include:
first effects from the start of the movement until stop of display of scroll of a part of the symbol arrays; and
second effects by displaying scroll of remaining symbol array or arrays after stopping displaying scroll of the part of the symbol arrays.

Since two stages of effects of the first effects and the second effects are provided from the start of movement until the completion of rearranging, diverse effects can be provided.

In the gaming machine according to an embodiment, the second effects are determined based on the first effects.

Since the second effects are determined based on the first effects, diverse but consistent effects between the two-stage effects can be provided even though two stages of effects are provided.

In the gaming machine according to an embodiment, the controller is programmed to perform the following processing of (5-1) to (5-3):

(5-1) processing of determining whether the number of special symbols in the symbols determined in the processing of (1-1) is a predetermined number or more;

(5-2) processing of rearranging the symbols by stopping the plurality of symbol arrays and determining a payout corresponding to the number of the special symbols in a case where the number of the special symbols is the predetermined number or more; and

(5-3) processing of stopping symbol arrays to show a special symbol first among the plurality of symbol arrays and stopping remaining symbol arrays not to show a special symbol afterwards in a case where the number of the special symbols is less than the predetermined number.

If determined symbols include a predetermined number or more of special symbols, the gaming machine stops a plurality of symbol arrays to rearrange the symbols and determines a payout. In contrast, if the determined symbols include special symbols less than the predetermined number, the gaming machine first stops the symbol arrays to show a special symbol (first effects) and then stops the symbol arrays not to show a special symbol (second effects). Accordingly, even in the case where special symbols are less than the predetermined number and no payout is provided, the player can feel expectation that the predetermined number or more of special symbols may appear by the end of the second effects even after the end of the first effects.

The gaming machine of the present invention can prevent the player from getting bored with symbol effects until the symbols have been rearranged.

These and other aspects, features and advantages of the present invention will become readily apparent to those having ordinary skill in the art upon a reading of the following detailed description of the invention in view of the drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a view illustrating a general configuration of a gaming machine;

FIG. 2 is a view illustrating a game system including the gaming machine;

FIG. 3 is a view illustrating an overall configuration of the gaming machine;

FIG. 4 is an exploded perspective view of a reel device and a reel cover;

FIG. 5 is a front view of the reel cover;

FIG. 6 is an exploded structural view of the reel device and the reel cover;

FIG. 7 is an exploded perspective view of the reel device and the reel cover;

FIG. 8 is a front view of a part of a backlight unit;

FIG. 9 is a schematic view illustrating a layout of buttons on a control panel of the gaming machine;

FIG. 10 is an electric block diagram of the gaming machine;

FIG. 11 is a block diagram illustrating electric circuitry of reel assemblies;

FIG. 12 is a block diagram illustrating processing of a game program executed by the main CPU of the motherboard;

FIG. 13 is a view illustrating an example of a payline definition table;

FIG. 14 is a view illustrating an example of a symbol determination table used in the base game mode;

FIG. 15 is a view illustrating an example of a symbol determination table used in the free game mode;

FIG. 16 is a view illustrating an example of a payout table;

FIG. 17 is a diagram illustrating state transitions in the gaming machine;

FIGS. 18A to 18C provide diagrams illustrating a structure of a reel strip;

FIG. 19 is a view illustrating a disposition of JACKPOTS;

FIG. 20 is a flowchart of main control processing in the gaming machine;

FIG. 21 is a flowchart of coin-insertion/start check processing in the gaming machine;

FIG. 22 is a flowchart of symbol lottery processing in the gaming machine;

FIG. 23 is a flowchart of effect content determination processing in the gaming machine;

FIG. 24 is a flowchart of symbol display control processing in the gaming machine;

FIG. 25 is a flowchart of payout determination processing in the gaming machine;

FIG. 26 is a flowchart of free game mode processing in the gaming machine;

FIG. 27 is a flowchart of Kind number identification processing in the gaming machine;

FIG. 28 is a flowchart of stop pattern identification processing in the gaming machine;

FIGS. 29A and 29B are tables for identifying a stop pattern;

FIGS. 30A and 30B are tables for identifying a stop pattern;

FIGS. 31A and 31B are tables for identifying a stop pattern;

FIGS. 32A and 32B are tables for identifying a stop pattern;

FIGS. 33A and 33B are tables for identifying a stop pattern;

FIGS. 34A and 34B are tables for identifying a stop pattern;

FIGS. 35A and 35B are tables for identifying a stop pattern;

FIGS. 36A and 36B are tables for identifying a stop pattern;

FIG. 37 is a table for identifying a stop pattern;

FIGS. 38A and 38B are views illustrating an example of a predictive effect lottery table;

FIGS. 39A and 39B are views illustrating an example of a predictive effect lottery table;

FIGS. 40A and 40B are views illustrating an example of a predictive effect lottery table;

FIGS. 41A and 41B are views illustrating an example of a predictive effect lottery table;

FIGS. 42A and 42B are views illustrating an example of a predictive effect lottery table;

FIGS. 43A and 43B are views illustrating an example of a predictive effect lottery table;

FIGS. 44A and 44B are views illustrating an example of a predictive effect lottery table;

FIGS. 45A and 45B are views illustrating an example of a predictive effect lottery table;

FIGS. 46A-1, 46A-2, 46B-1 and 46B-2 are views illustrating an example of a li-zhi effect lottery table;

FIGS. 47A-1, 47A-2, 47B-1 and 47B-2 are views illustrating an example of a li-zhi effect lottery table;

FIGS. 48A-1, 48A-2, 48B-1 and 48B-2 are views illustrating an example of a li-zhi effect lottery table;

FIGS. 49A-1, 49A-2, 49B-1 and 49B-2 are views illustrating an example of a li-zhi effect lottery table;

FIGS. 50A-1, 50A-2, 50B-1 and 50B-2 are views illustrating an example of a li-zhi effect lottery table;

FIGS. 51A-1, 51A-2, 51B-1 and 51B-2 are views illustrating an example of a li-zhi effect lottery table;

FIGS. 52A-1, 52A-2, 52B-1 and 52B-2 are views illustrating an example of a li-zhi effect lottery table;

FIGS. 53A-1, 53A-2, 53B-1 and 53B-2 are views illustrating an example of a li-zhi effect lottery table;

FIGS. 54A to 54E are views illustrating a specific example of reel effects;

FIGS. 55A to 55G are views illustrating a specific example of reel effects;

FIGS. 56A to 56C are views illustrating a specific example of reel effects; and

FIGS. 57A to 57D are views illustrating a specific example of reel effects.

### DETAILED DESCRIPTION OF THE PREFERRED EMBODIMENT

### <<<Overview>>>

A slot machine 10 is a kind of gaming machine. The present embodiment describes a slot machine 10 by way of example of a gaming machine; however, the gaming machine is not limited to this and may be an apparatus that can independently conduct a certain kind of base games and further, bonus games developed from the base games.

Base games in the present embodiment are conducted in a slot machine 10. The base games are slot games that rearrange a plurality of symbols each time. The base games are games conceptually contrasting with free games of bonus games.

Rearrangement of the symbols in slot games is performed by five reels M3a to M3e that are mechanically rotatable. The rearranged symbols are shown in a display window 150 of a symbol display unit 40.

The slot games provide a base game mode and a free game mode. The base game mode is to conduct at least one unit game (base game) which rearranges, under the condition where some game value is bet, symbols in the display window 150 and provides a normal payout in accordance with the rearranged symbols. The free game mode is to conduct at least one unit game (free game) which rearranges, when symbols rearranged in a base game satisfy a predetermined condition, symbols under conditions different from those of a base game and provides a payout in accordance with the rearranged symbols.

Symbol is a generic term representing a RED7, BLUE7, 3BAR, 2BAR, 1BAR, BONUS, or JACKPOT symbol. The term symbol in the present embodiment also includes a blank symbol (BLANK).

The term game value represents coins, bills, or electrically valuable information corresponding to these. The game value in the present embodiment is not specifically limited and may be game media such as medals, tokens, electric money, or tickets. The tickets are not specifically limited and may be later-described tickets with barcodes.

The bonus games in the present embodiment may be any kind of games as far as they are different from base games. In the present embodiment, free games are conducted as bonus games. Free games can be conducted with a smaller bet of game value than base games. A smaller bet of game value includes zero bet. Accordingly, free games may be games that do not require a bet of game value and pays game value in the amount corresponding to the rearranged symbols. In other words, free games can be defined as games that are started without assuming game value consumption.

Rearranging means an action of arranging symbols in the display window 150 again after releasing an arrangement of symbols. An arrangement of symbols is released by start of a unit game (slot game) and subsequently, another set of symbols are arranged again (rearranged). The rearranged symbols determine a result of the unit game to terminate the unit game. Arrangement means a state in which symbols are visible by the player in the outside.

### <<<<Overview of Configuration of Gaming Machine in Embodiment>>>>

A gaming machine according to the present embodiment comprises:

a symbol display device (e.g., the reel device M1 to be described later) including a display region (e.g., the display window 150 to be described later) for displaying a result of a unit game by rearranging symbols including special symbols (e.g., JACKPOTs to be described later); and

a controller (e.g., the main CPU 222 to be described later) programmed to perform the following processing of (1-1) to (1-3):

(1-1) symbol determination processing of randomly determining symbols to be rearranged in the display region (e.g., step S2014 to be described later);

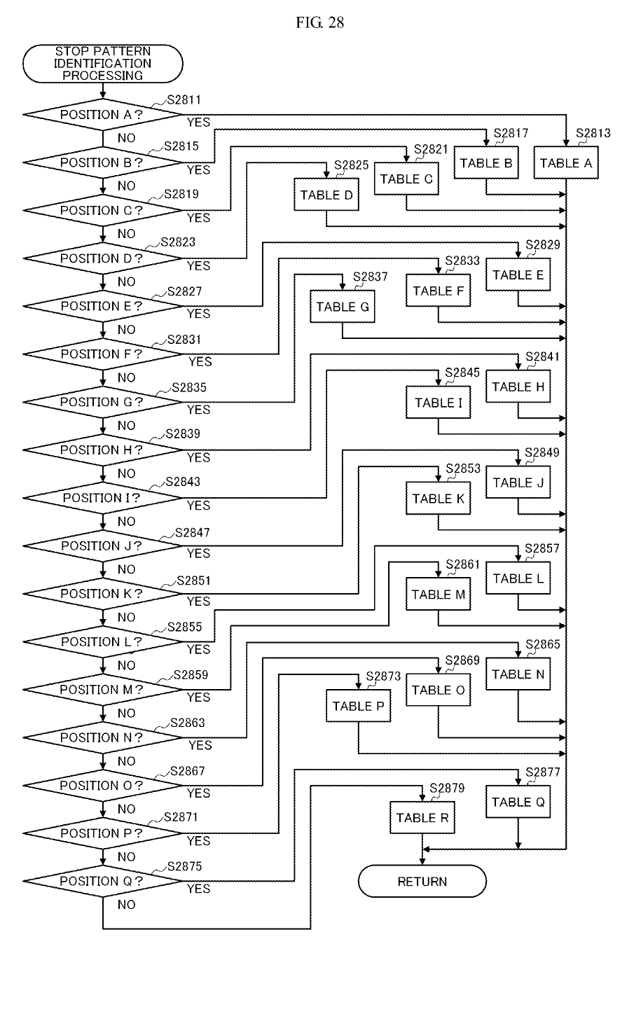

(1-2) processing of identifying an arrangement pattern of the special symbols in the display region, the arrangement pattern being determined with the symbols determined in the symbol determination processing (e.g., step S2315 and stop pattern identification processing in FIG. 28 to be described later); and

(1-3) symbol effect determination processing of determining symbol effects (e.g., predictive effects and li-zhi effects to be described later) by motion of symbols from start of movement until completion of rearranging the symbols based on the arrangement pattern (e.g., steps S2317 and S2319 to be described later).

Since the symbol effects by motion of symbols from start of movement until completion of rearranging of the symbols are determined based on an arrangement pattern of special symbols, symbol effects associated with the symbols to be finally rearranged can be determined. Symbol effects matching and consistent with the symbols to be finally rearranged can be provided.

In the gaming machine according to the present embodiment, the controller is programmed to perform the following processing of (2-1) and (2-2):

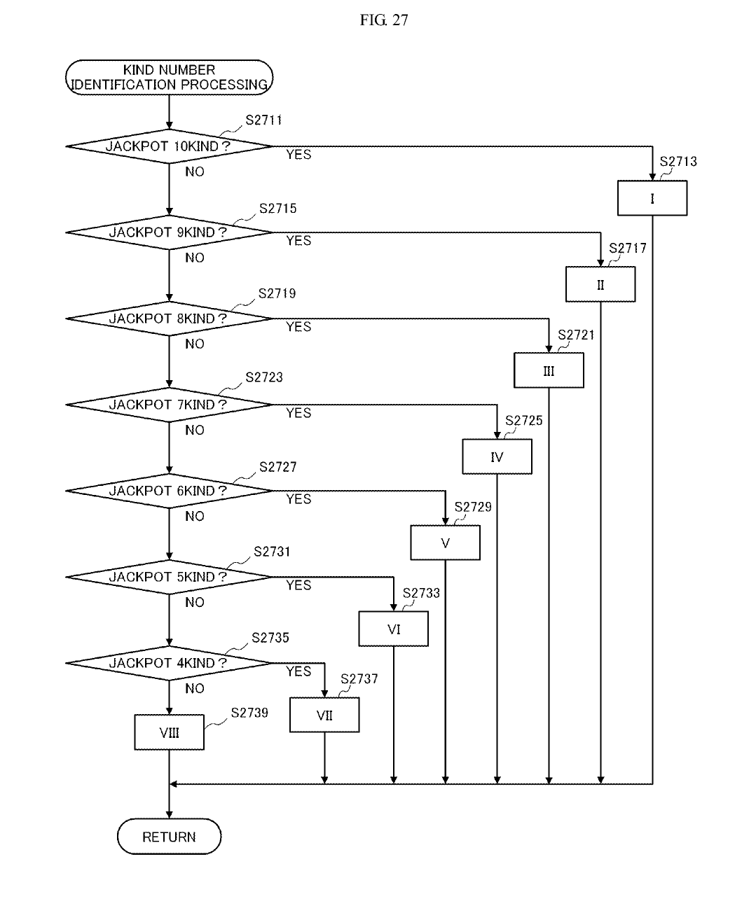

(2-1) processing of identifying the number of special symbols to be displayed among the symbols determined in the symbol determination processing (e.g., step S2313 and Kind number identification processing in FIG. 27 to be described later); and

(2-2) symbol effect determination processing of determining symbol effects (e.g., predictive effects and li-zhi effects to be described later) by motion of symbols from start of movement until completion of rearranging the symbols based on the number of special symbols to be displayed and the arrangement pattern (e.g., steps S2317, S2319, S2321, and S2323 to be described later).

Since the symbol effects are determined based on both of the number and the arrangement pattern of special symbols, diverse symbol effects that are consistently and smoothly played out can be provided.

In the gaming machine according to the present embodiment,

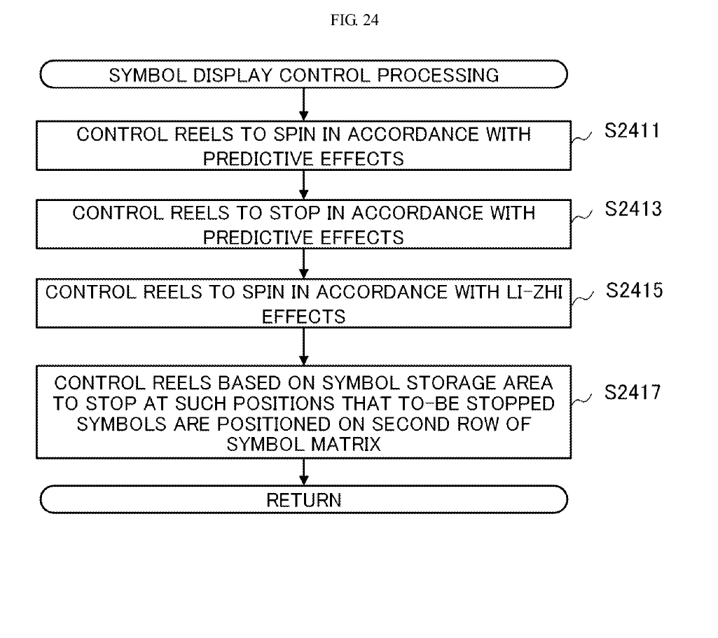

the symbol display device is capable of displaying a plurality of symbol arrays being scrolled (e.g., the symbol display control processing in FIG. 24 to be described later), the plurality of symbol arrays being composed of the symbols,

the symbol display device starts the movement by starting displaying scroll of all the symbol arrays (e.g., step S2411 to be described later), and

the symbol display device completes the rearranging by stopping displaying the scroll of all the symbol arrays (e.g., step S2415 to be described later).

The symbol effects include:
first effects (e.g., step S2411 (predictive effects) to be described later) from the start of the movement until stop of display of scroll of a part of the symbol arrays; and
second effects (e.g., step S2413 (li-zhi effects) to be described later) by displaying scroll of remaining symbol array or arrays after stopping displaying scroll of the part of the symbol arrays.

Since two stages of effects of the first effects and the second effects are provided from the start of movement until the completion of rearranging, diverse effects can be provided.

In the gaming machine according to the present embodiment, the second effects are determined based on the first effects.

Since the second effects are determined based on the first effects, consistent effects between the first effects and the second effects can be provided even though two stages of effects are provided.

In the gaming machine according to the present embodiment, the controller is programmed to perform the following processing of (5-1) to (5-3):

(5-1) processing of determining whether the number of special symbols in the symbols determined in the processing of (1-1) is a predetermined number or more (e.g., step S2313 and the Kind number identification processing in FIG. 27 to be described later);

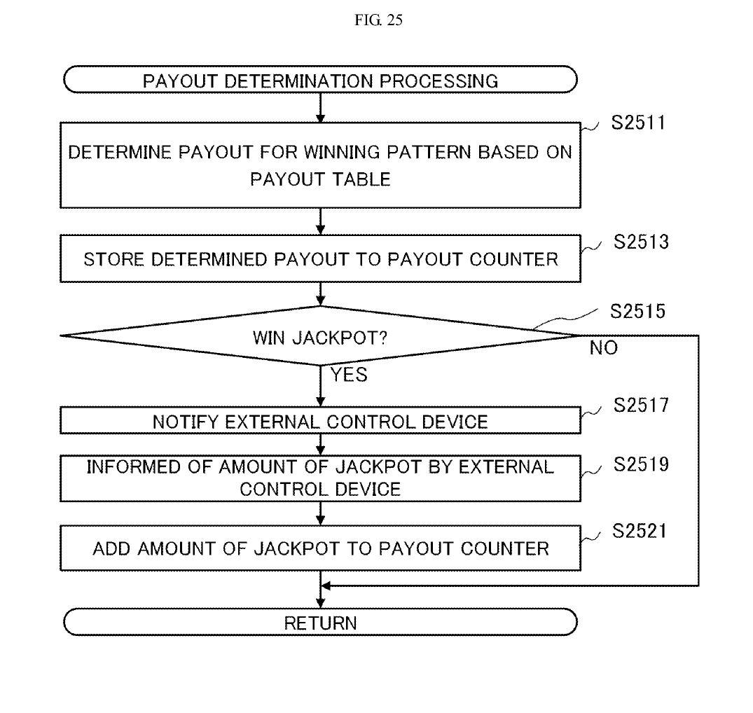

(5-2) processing of rearranging the symbols by stopping the plurality of symbol arrays (e.g., predictive effects and li-zhi effects to be described later) and determining a payout corresponding to the number of the special symbols (e.g., payout determination processing in FIG. 25 to be described later) in a case where the number of the special symbols is the predetermined number or more; and

(5-3) processing of stopping symbol arrays to show a special symbol first among the plurality of symbol arrays (e.g., predictive effects to be described later) and stopping remaining symbol arrays not to show a special symbol afterwards (e.g., li-zhi effects to be described later) (e.g., symbol display control processing in FIG. 24 to be described later) in a case where the number of the special symbols is less than the predetermined number.

If determined symbols include a predetermined number or more of special symbols, the gaming machine stops a plurality of symbol arrays to rearrange the symbols and determines a payout. In contrast, if the determined symbols include special symbols less than the predetermined number, the gaming machine first stops the symbol arrays to show a special symbol (first effects) and then stops the symbol arrays not to show a special symbol (second effects). Accordingly, even in the case where special symbols are less than the predetermined number and no payout is provided, the player can feel expectation that the predetermined number or more of special symbols may appear by the end of the second effects even after the end of the first effects.

The foregoing has provided processing of (5-2) that rearranges the symbols by stopping the plurality of symbol arrays and determines a payout corresponding to the number of special symbols in a case where the number of special symbols is the predetermined number or more and the processing of (5-3) that stops symbol arrays to show a special symbol first among the plurality of symbol arrays and stops the remaining symbol arrays not to show a special symbol afterwards in a case where the number of special symbols is less than the predetermined number.

In addition to such processing or instead of the processing of (5-2), the following processing (5-4) may be performed:

(5-4) processing of stopping symbol arrays to show a special symbol first among the plurality of symbol arrays and stopping symbol arrays not to show a special symbol afterwards in a case where the number of the special symbols is the predetermined number or more.

That is to say, symbol arrays to show a special symbol can be stopped first in either case where the number of special symbol is less than a predetermined number or not.

In the case where the number of special symbols is the predetermined number or more, if the gaming machine 10 performs only the processing of (5-3), symbol arrays to show a special symbol stop first, the player who sees symbol arrays to show a special symbols stop knows that the special symbols are less than the predetermined number and no payout is provided at an earlier stage. Accordingly, a player familiar with this gaming machine finds out no payout is to be provided when symbol arrays to show a special symbol are stopped first, so that it could be hard to attract the player until the end of the unit game. Players of this gaming machine may gradually decrease.

However, the player cannot know the result of a unit game by stopping symbol arrays to show a special symbol first in either case where the special symbols are less than the predetermined number or not. Accordingly, even if the player is familiar with the gaming machine, the player cannot predict the game result and is attracted until the end of the unit game; the gaming machine will not lose the players for a long period.

A gaming machine according to the present embodiment comprises:

a symbol display device (e.g., the reel device M1 to be described later) including a display region (e.g., the display window 150 to be described later) for displaying a result of a unit game by rearranging symbols including special symbols (e.g., JACKPOTs to be described later) in a form of a matrix;

a memory for storing tables; and

a controller programmed to perform the following processing of (1-1) to (1-8):

(1-1) symbol determination processing of randomly determining symbols to be rearranged in the display region (e.g., step S2014 to be described later);

(1-2) processing of identifying the final number of special symbols included in the symbols determined in the symbol determination processing and to be finally displayed (e.g., step S2313 and Kind number identification processing in FIG. 27 to be described later);

(1-3) processing of identifying an arrangement pattern of special symbols determined with the symbols determined in the symbol determination processing (e.g., step S2315 and stop pattern identification processing in FIG. 28 to be described later); and

(1-4) first table selection processing of selecting a first table for determining first motion of the symbols (e.g., predictive effects to be described later) from start of movement until an intermediate state between the start of movement and completion of rearranging the symbols based on the final number and the arrangement pattern (e.g., step S2317 to be described later);

(1-5) first motion determination processing of determining the first motion with reference to the first table (e.g., step S2319 to be described later);

(1-6) second table selection processing of selecting a second table for determining second motion of the symbols (e.g., li-zhi effects to be described later) from the intermediate state until the completion of rearranging the symbols based on the final number, the arrangement pattern, and the first table (e.g., step S2321 to be described later);

(1-7) second motion determination processing of determining the second motion with reference to the second table (e.g., step S2323 to be described later); and

(1-8) symbol motion control processing of controlling the symbols to perform the first motion and the second motion (e.g., symbol display control processing in FIG. 24 to be described later).

Two kinds of tables enable control of symbol effects in the stage from the start of movement until the intermediate state and the stage from the intermediate state until completion of rearrangement; combinations of the two kinds of tables provide diverse symbol effects. Meanwhile, since the second table is determined based on not only the number and the arrangement pattern of special symbols but also the first table, the effects from the intermediate state until the completion of rearrangement can match with the effects from the start of movement until the intermediate state, achieving smooth transition of effects from the intermediate state.

In the gaming machine according to the present embodiment, the symbol display device is capable of displaying a plurality of symbol arrays being scrolled (e.g., the symbol display control processing in FIG. 24 to be described later), the plurality of symbol arrays being composed of the symbols,

the symbol display device starts the movement by starting displaying scroll of all the symbol arrays (e.g., step S2411 to be described later), and

the symbol display device completes the rearranging by stopping displaying the scroll of all the symbol arrays (e.g., step S2415 to be described later).

Since the effects are provided by displaying scroll of the symbol arrays, the player can watch the effects without averting the eyes from the symbol arrays, while grasping the process of the unit game without missing.

In the gaming machine according to the present embodiment, the controller is programmed to perform the following processing of (3-1) to (3-4):

(3-1) first kind of payout determination processing of determining to provide a first kind of payout in a case where the final number is a first predetermined number or more (e.g., providing a fixed payout (normal payout) in the case of four or five JACKPOTs);

(3-2) second kind of payout determination processing of determining to provide a second kind of payout in a case where the final number is a second predetermined number or more, the second predetermined number is greater than the first predetermined number (e.g., providing a payout from the progressive jackpot in the case of six or more JACKPOTs)

(3-3) first-a stop processing of displaying stop of scatter symbols not less than the first predetermined number and less than the second predetermined number included in a part of the symbol arrays in the display region, when stopping display of scroll of the part of the symbol arrays and keeping display of scroll of the remaining symbol arrays in accordance with the first motion in a case where the final number is the second predetermined number or more (e.g., showing four or five stopped scatter symbols first (predictive effects) in the case where nine scatter symbols are to be finally stopped); and

(3-4) first-b stop processing of displaying stop of the final number of scatter symbols in the display region, when stopping the remaining symbol arrays and rearranging the determined symbols in accordance with the second motion after the processing of (3-3) (e.g., showing nine stopped scatter symbols finally (li-zhi effects)).

Since the gaming machine provides both of the first kind of payout (normal payout) and the second kind of payout (progressive jackpot payout) while raising expectation for not only the first kind of payout but also the second kind of payout, the player can receive more benefit.

In the gaming machine according to the present embodiment, the controller is programmed to perform the following processing of (4-1) and (4-2):

(4-1) second-a stop processing of displaying stop of scatter symbols not less than the first predetermined number and less than the second predetermined number included in a part of the symbol arrays in the display region, when stopping display of scroll of the part of the symbol arrays and keeping display of scroll of the remaining symbol arrays in accordance with the first motion in a case where the final number is not less than the first predetermined number and less than the second predetermined number (e.g., showing four or five stopped scatter symbols first (predictive effects); and

(4-2) second-b stop processing of displaying stop of the final number of scatter symbols in the display region, when stopping the remaining symbol arrays and rearranging the determined symbols in accordance with the second motion after the processing of (4-1) (e.g., showing only five stopped scatter symbols finally (li-zhi effects)).

The unit game proceeds while raising expectation for not only the first kind of payout (normal payout) but also the second kind of payout (progressive jackpot payout).

In the gaming machine according to the present embodiment,

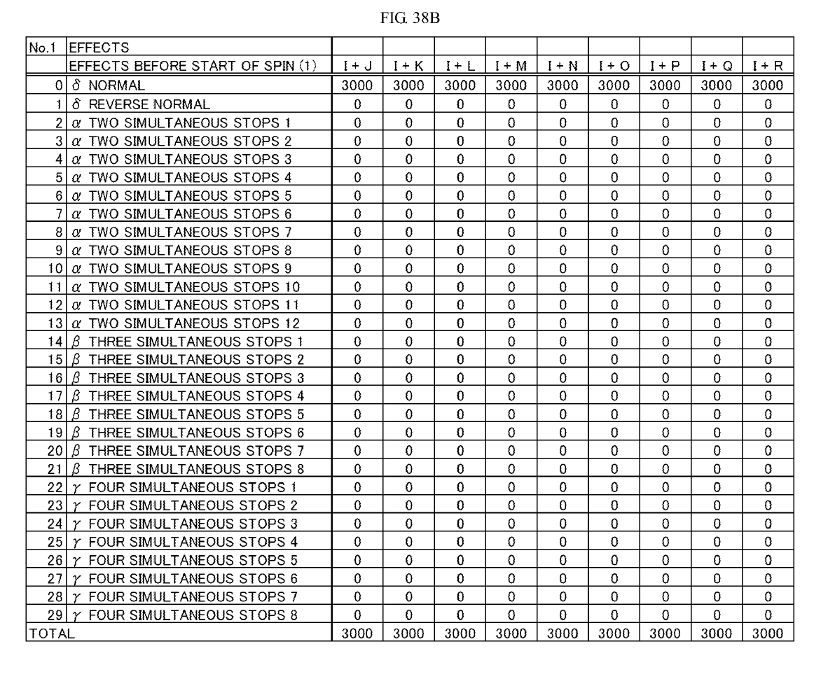

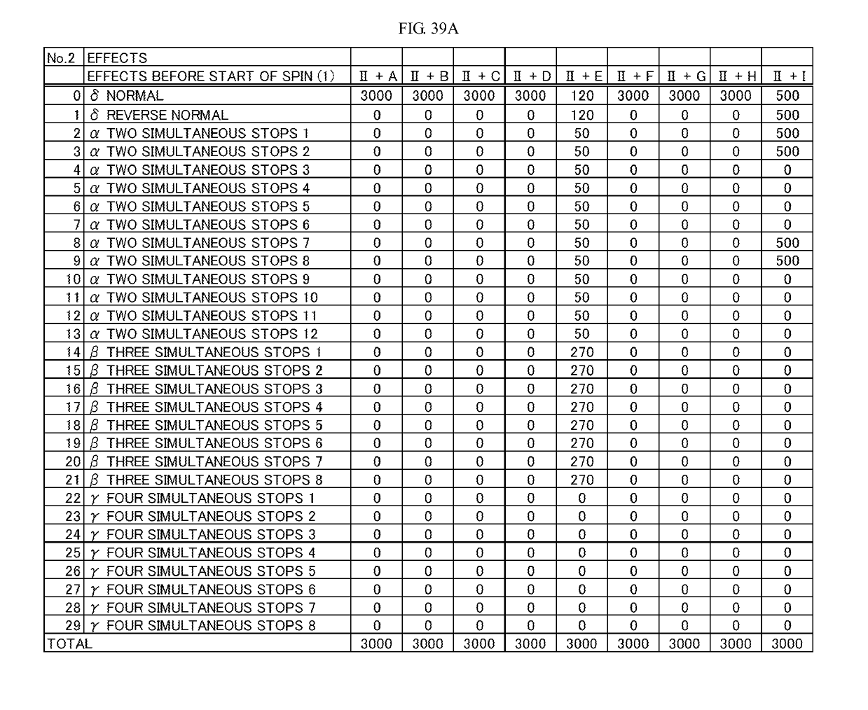

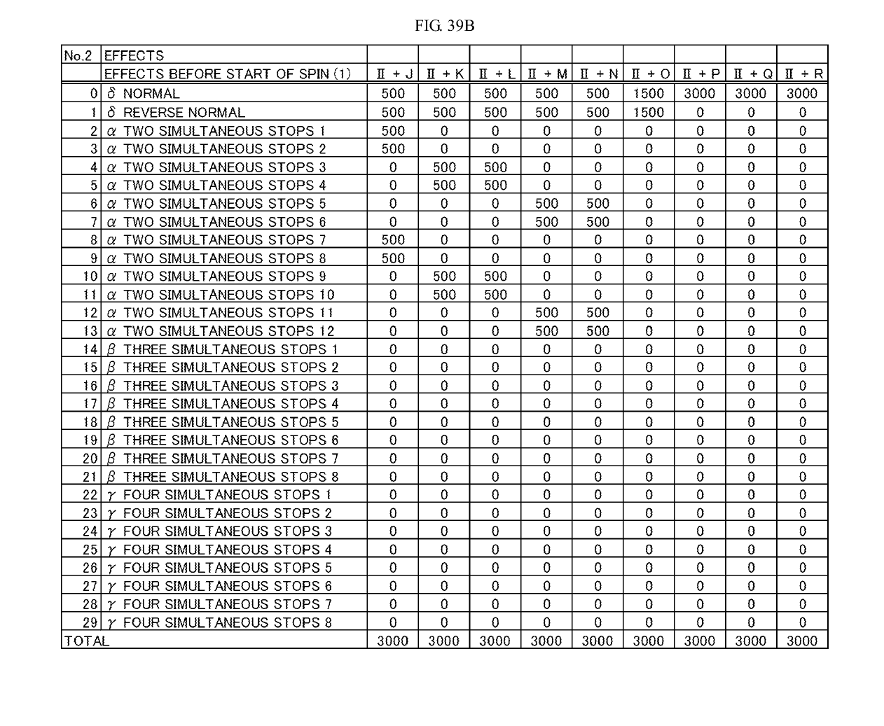

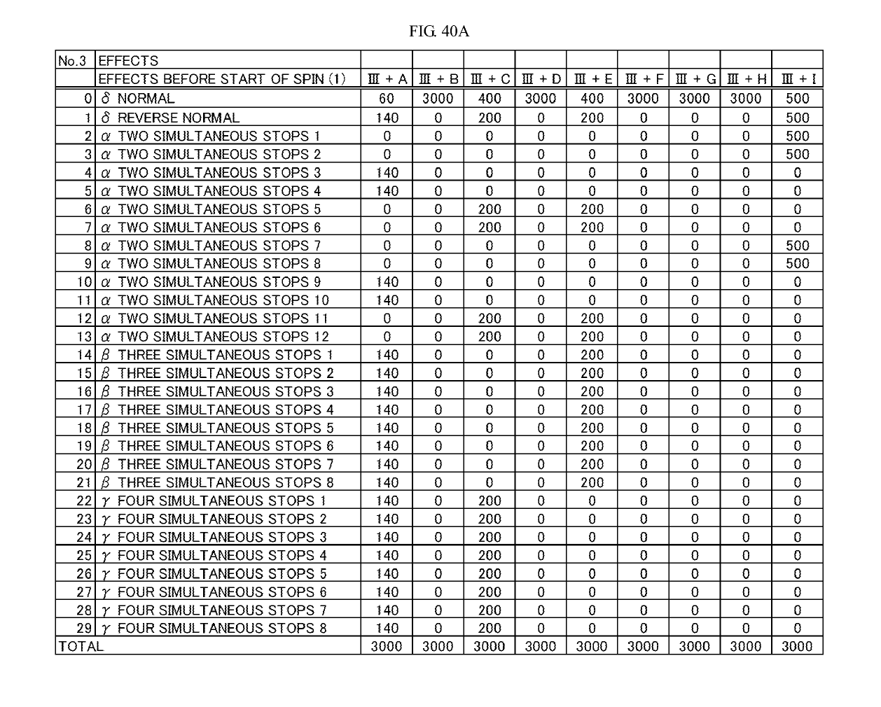

the memory stores first tables which are tables for determining motion of the plurality of symbol arrays from the start of movement until the intermediate state and for randomly selecting one kind of motion for the first motion from a plurality of kinds of motion (e.g., predictive effect lottery tables in FIGS. 38A to 45B to be described later), and

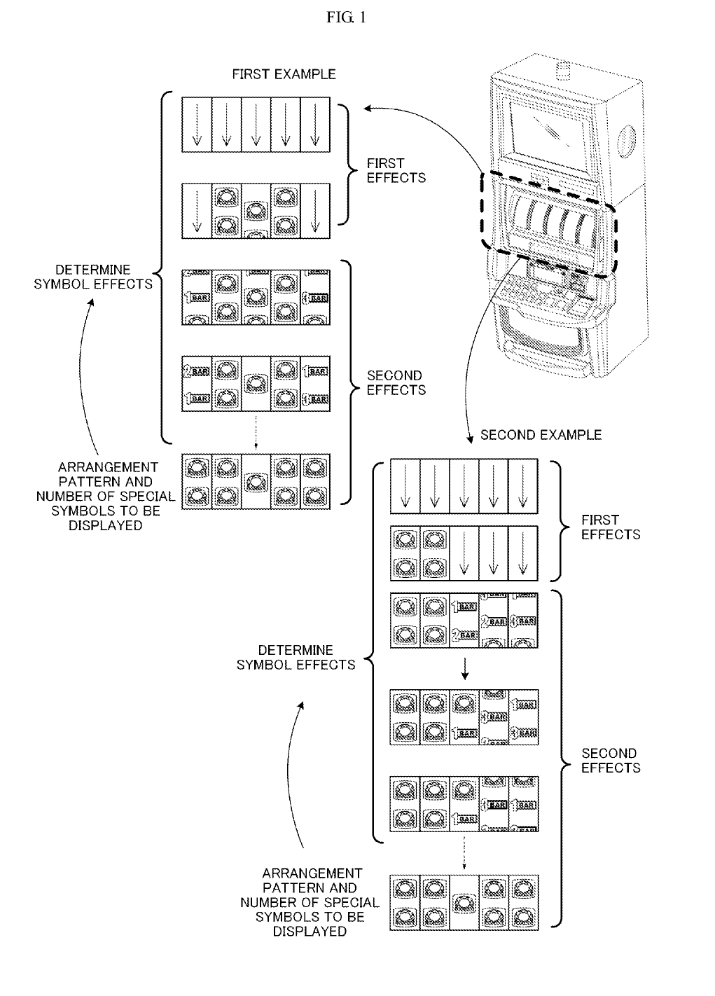

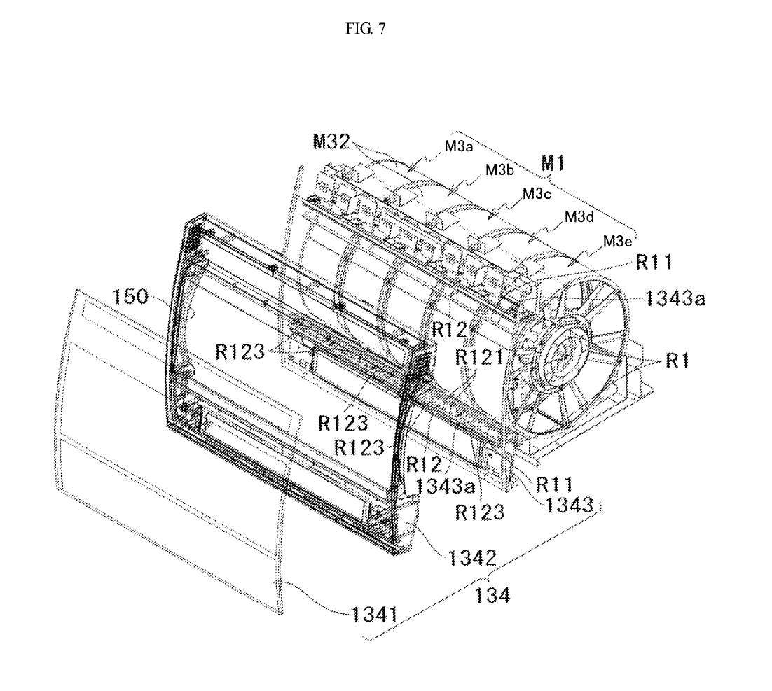

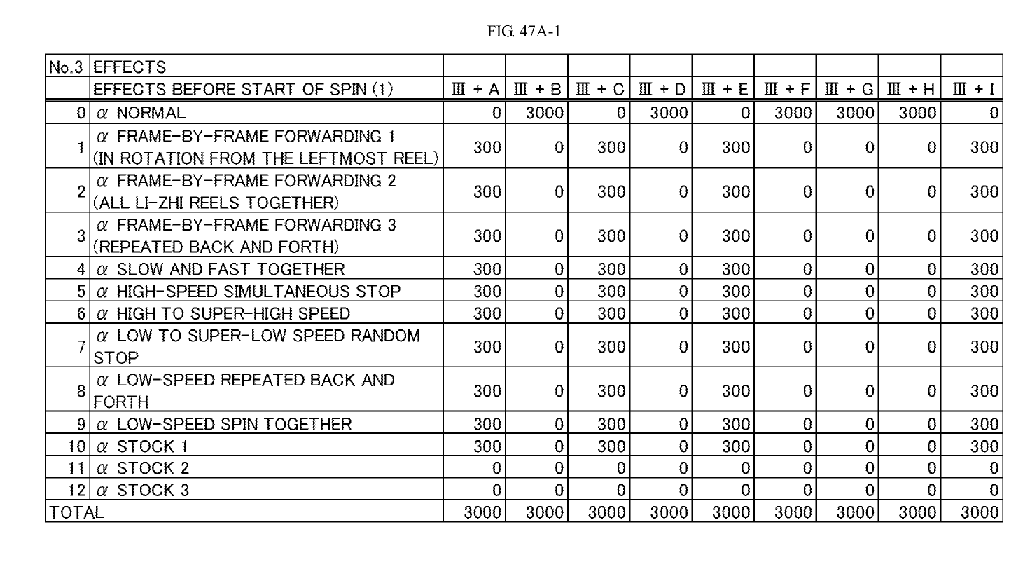

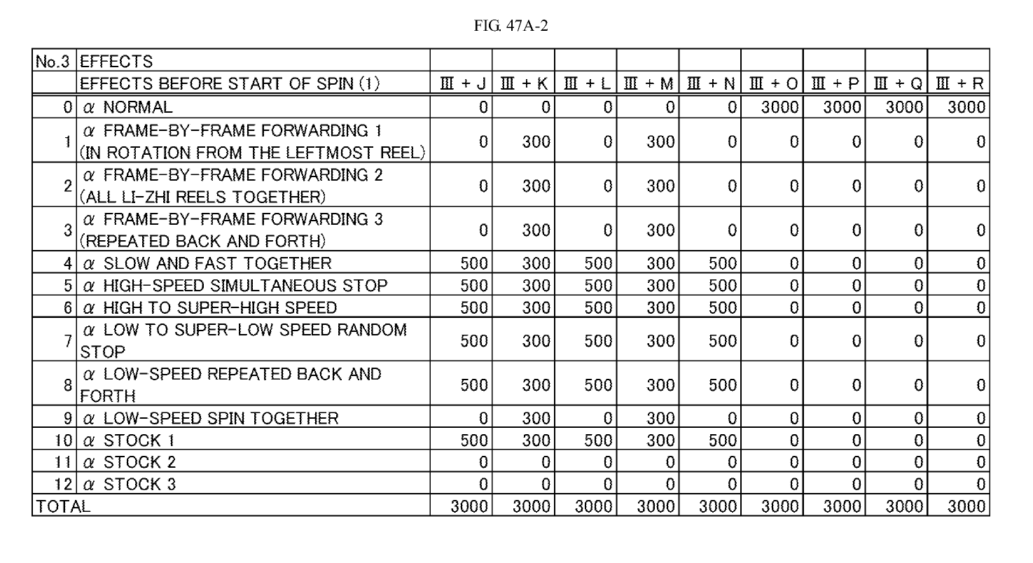

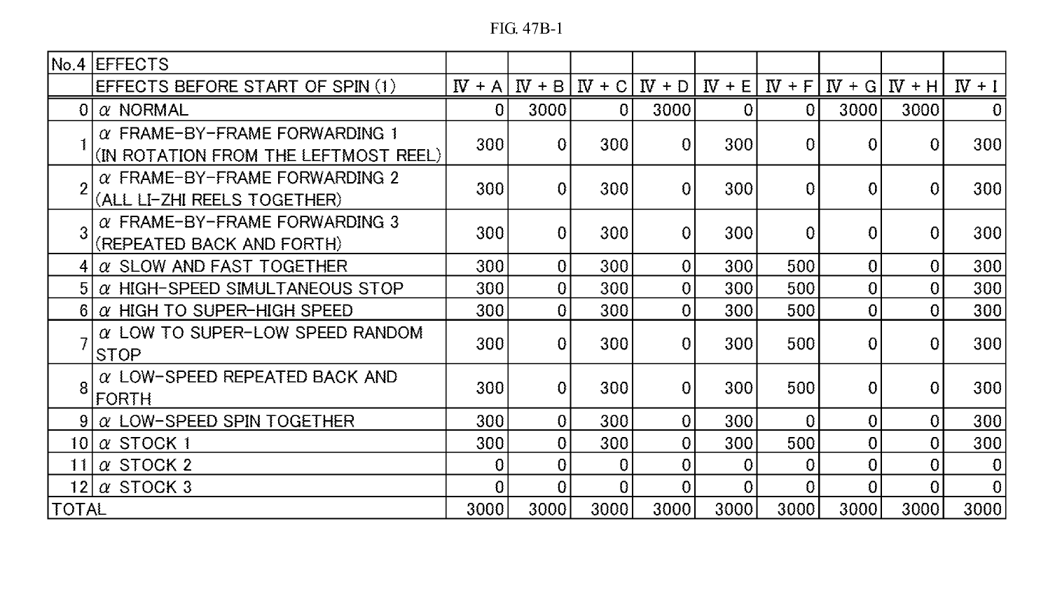

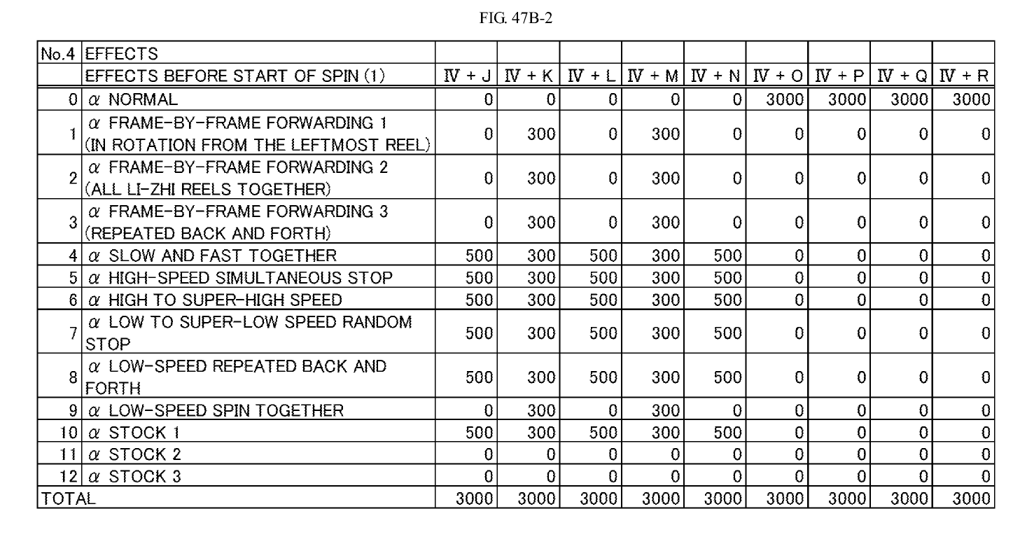

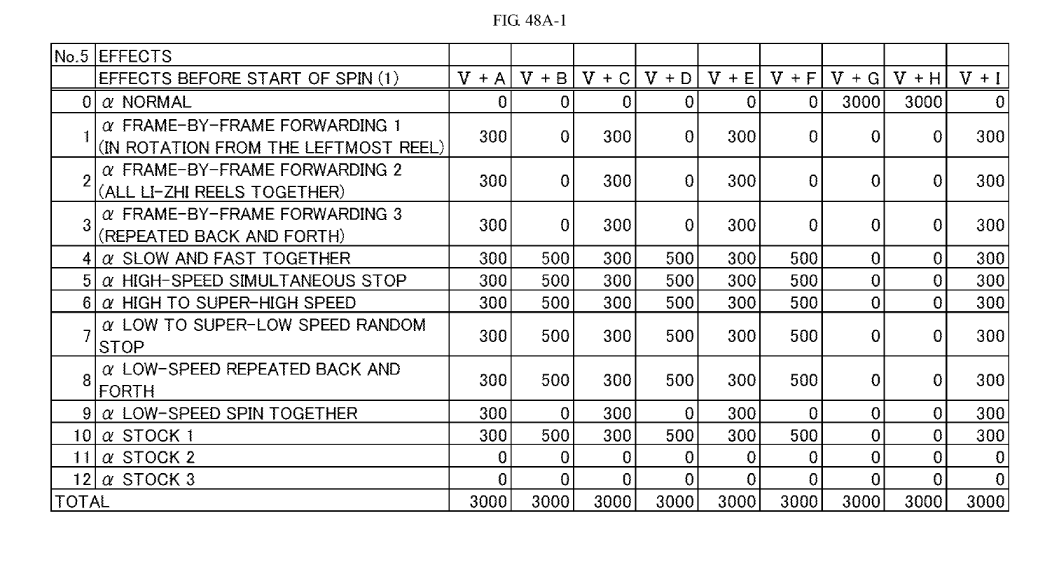

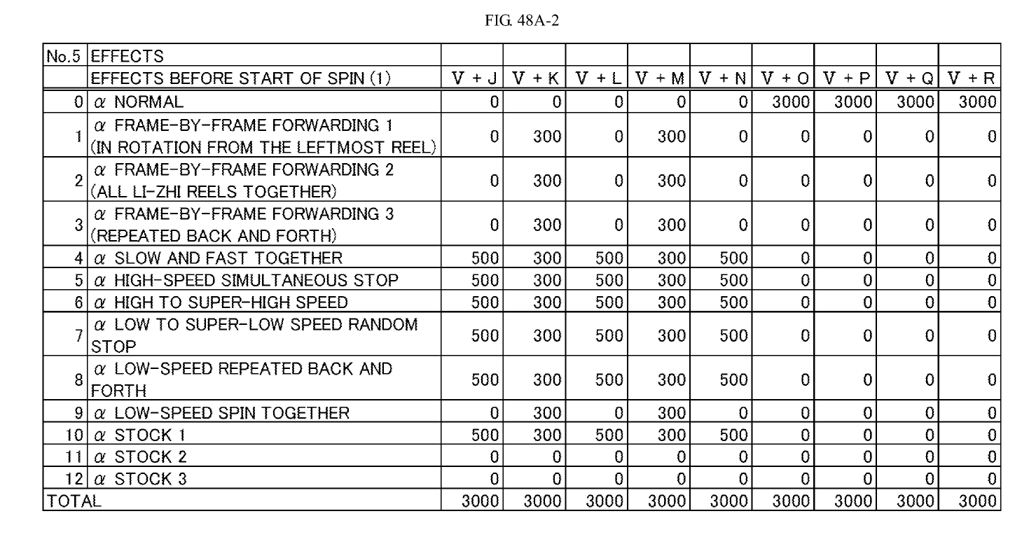

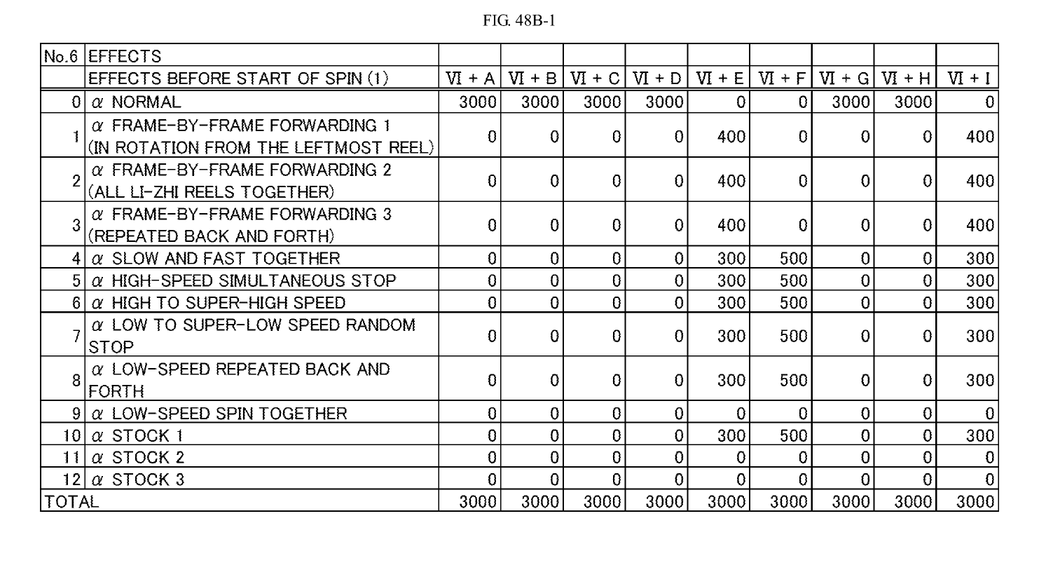

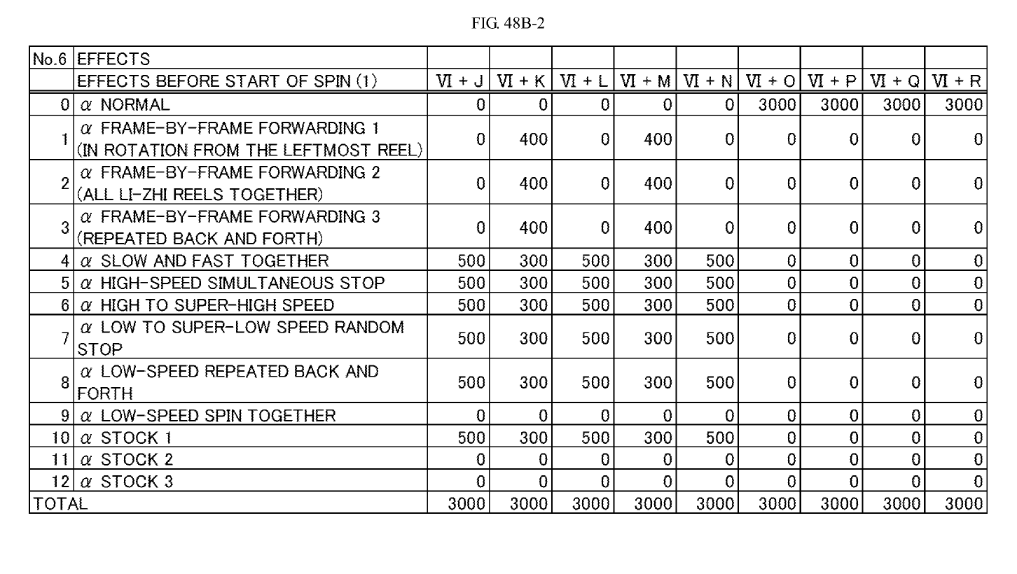

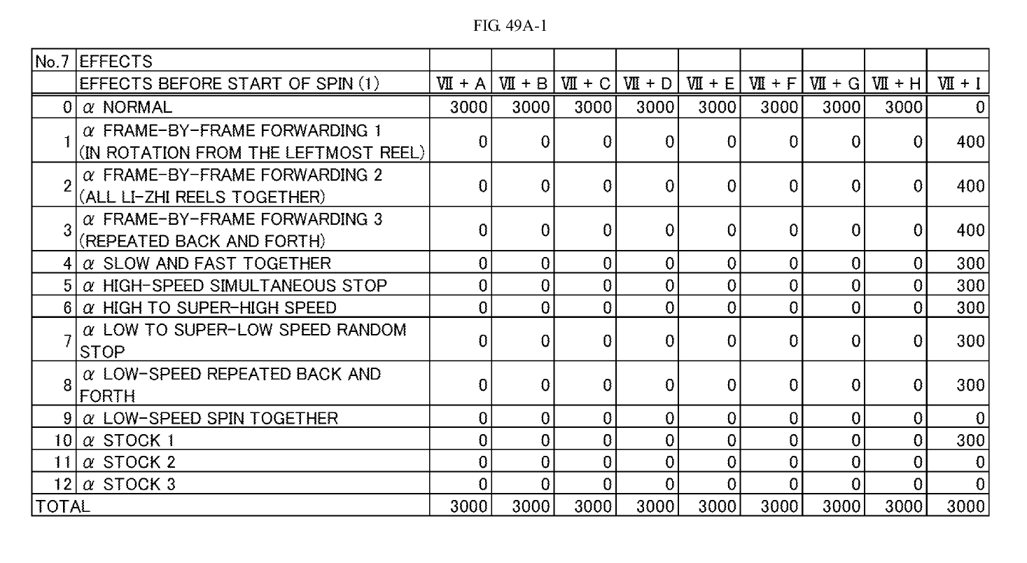

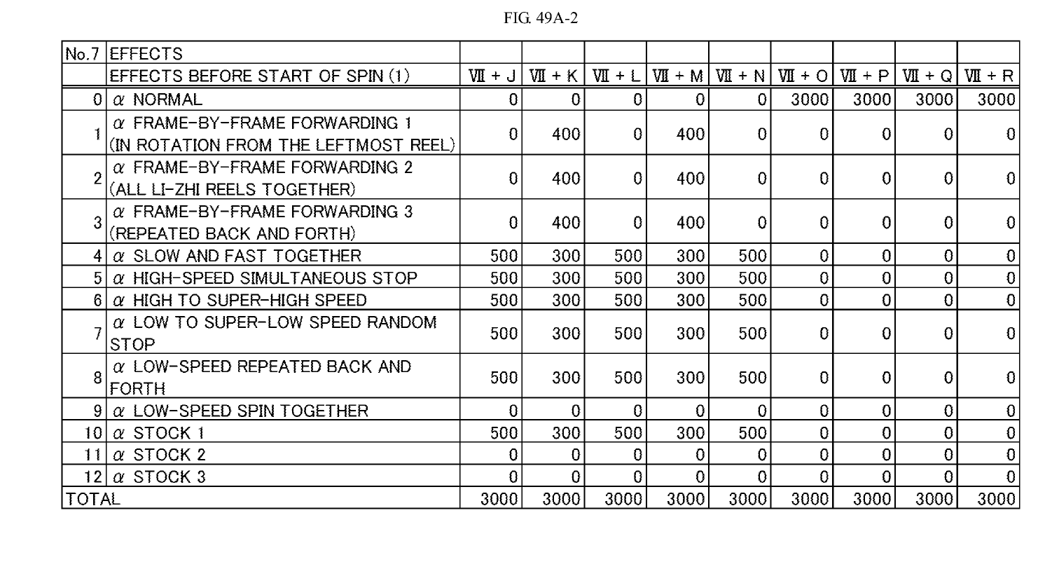

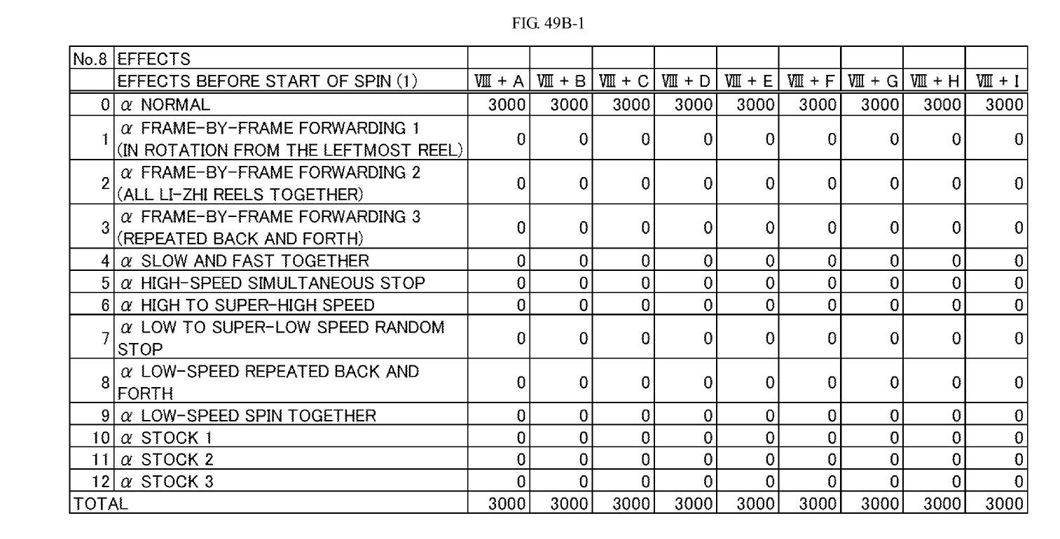

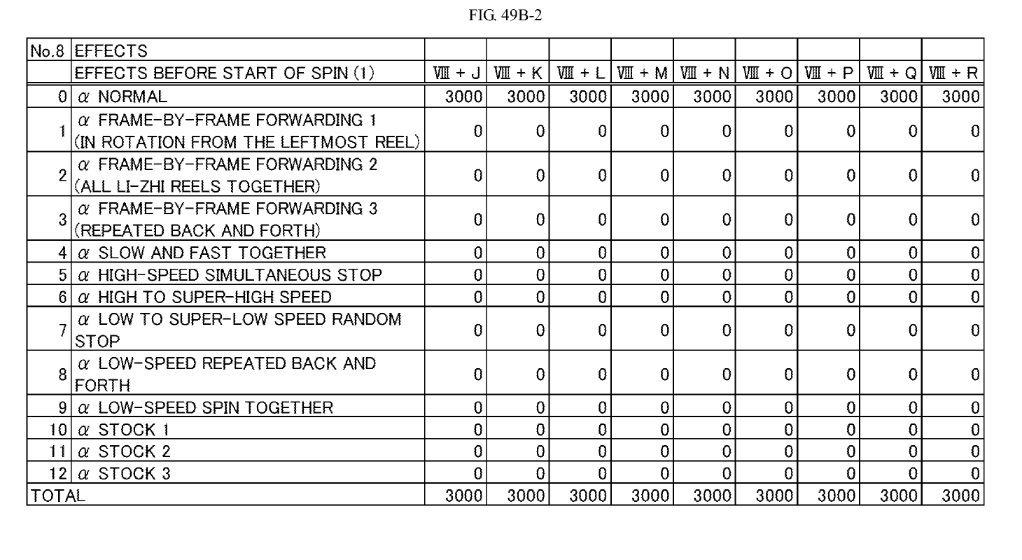

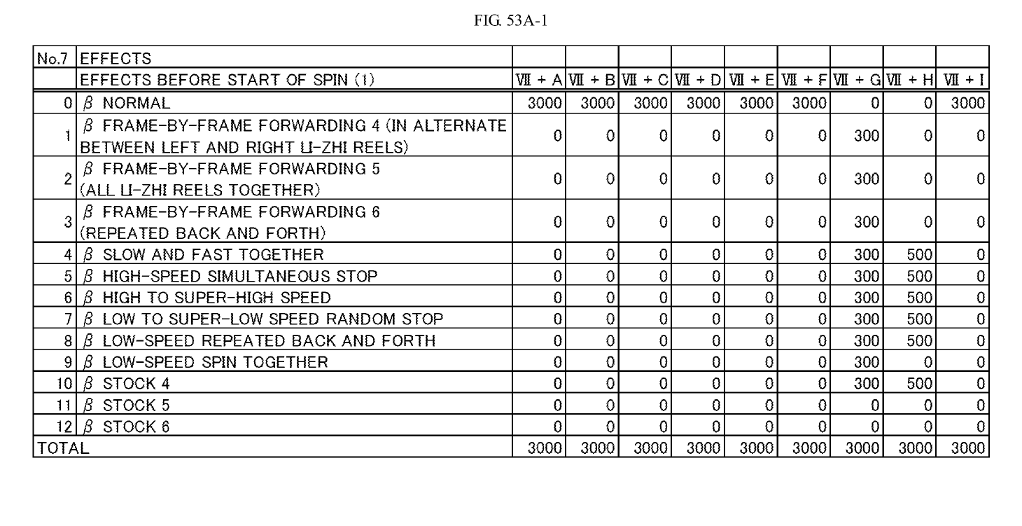

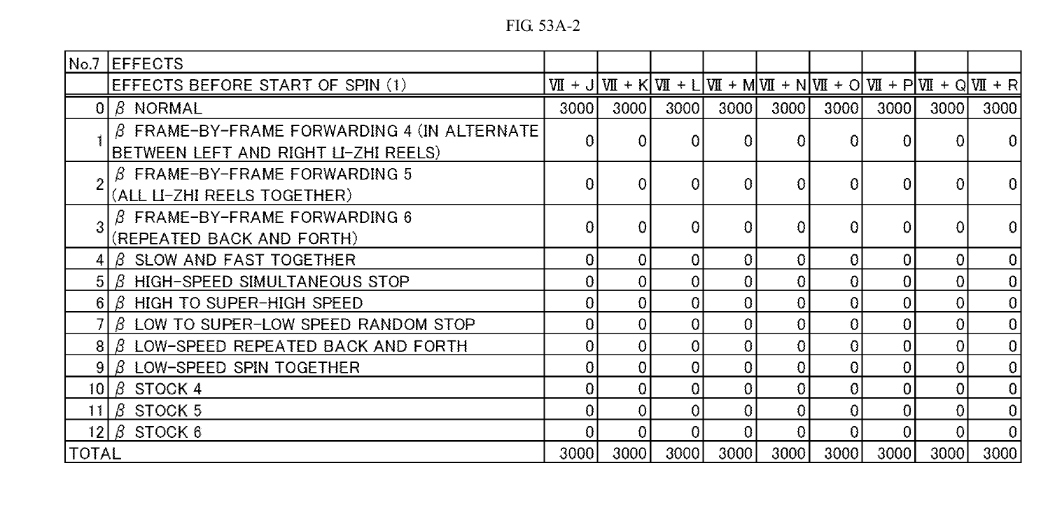

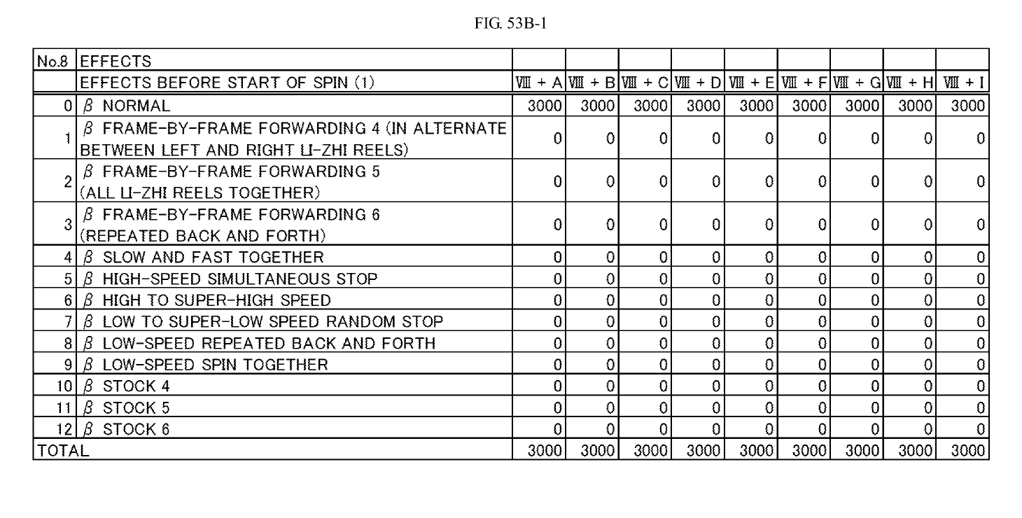

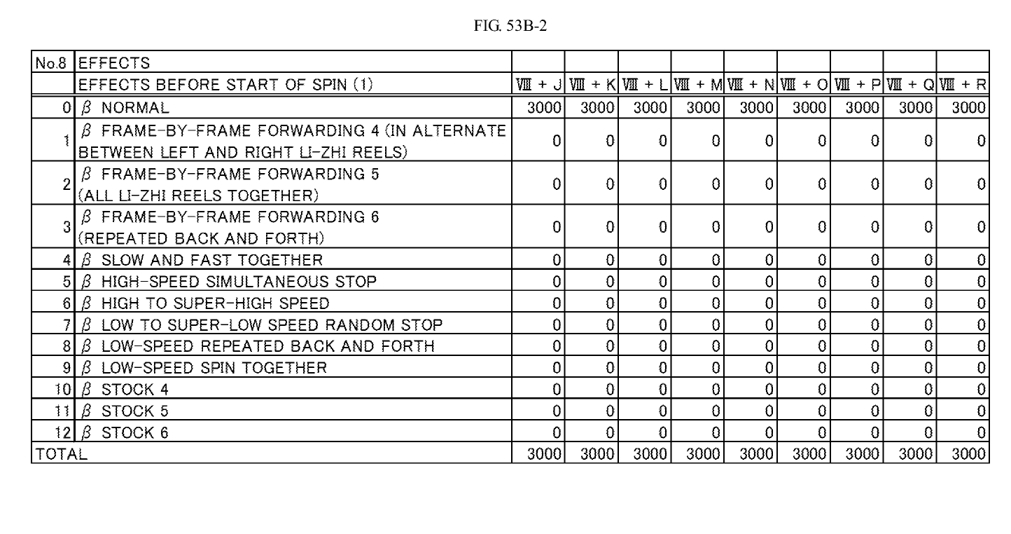

the memory stores second tables which are tables for determining motion of the plurality of symbol arrays from the intermediate state until the rearranging and for randomly selecting one kind of motion for the second motion from a plurality of kinds of motion (e.g., li-zhi effect lottery tables in FIGS. 46A-1 to 53B-2 to be described later).

In the gaming machine according to the present embodiment,

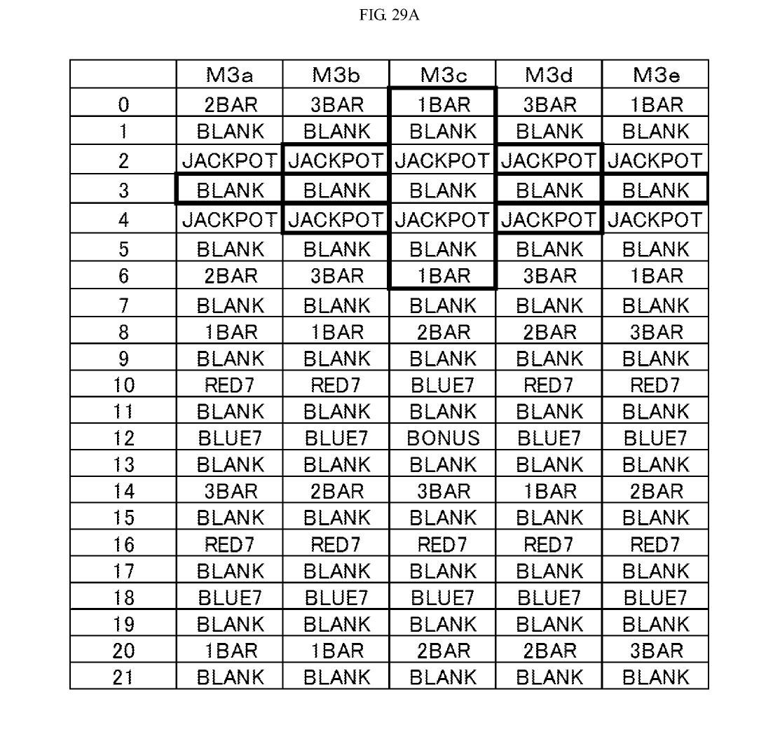

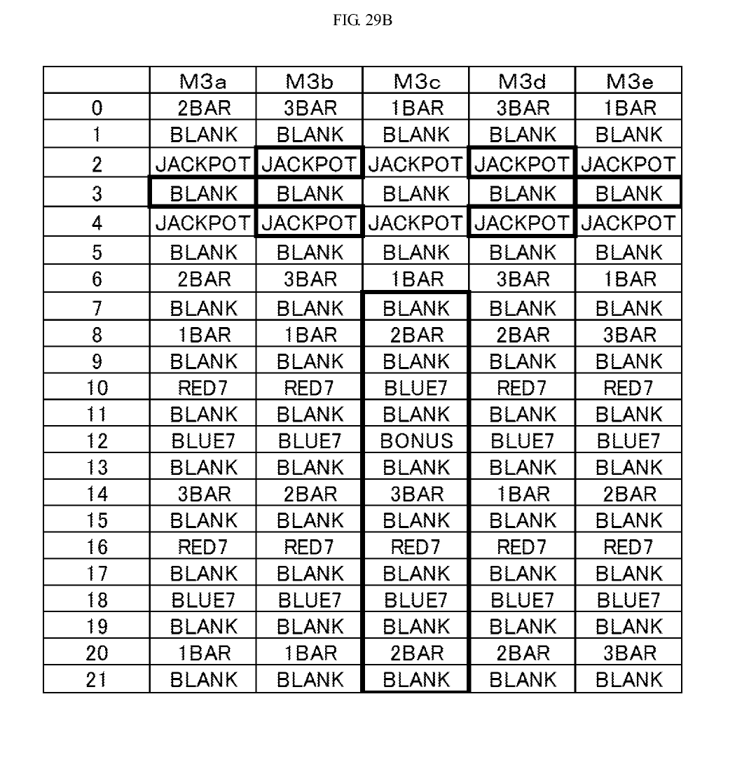

the memory stores stop pattern tables storing a plurality of stop patterns of the special symbols (e.g., the tables to identify the stop pattern of JACKPOTS to determine a second identifier in FIGS. 29A to 37 to be described later), and

the processing of (1-3) identifies an arrangement pattern of special symbols from the plurality of stop patterns with reference to the stop pattern tables based on the final number of the special symbols (e.g., steps S2313 and S2315 to be described later).

Since the arrangement pattern of special symbols is identified from a plurality of stop patterns with reference to the stop pattern tables based on the final number of special symbols to be displayed, smooth effects can be determined.

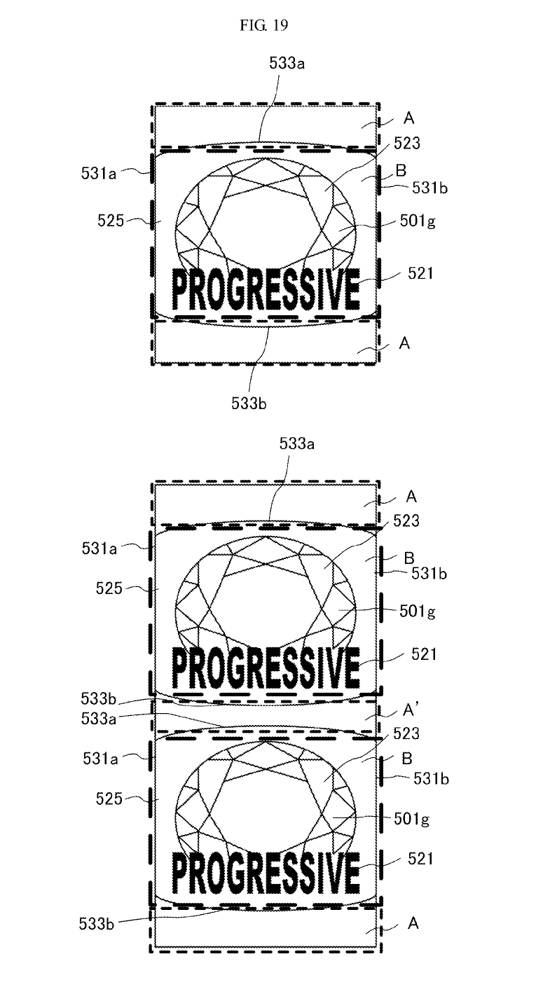

A reel strip for a gaming machine according to the present embodiment comprises a symbol area (e.g., the area B surrounded by a thick dashed line in FIG. 19) including a winning element symbol (e.g., a JACKPOT to be described later) based on which winning or not is determined and a blank area (e.g., the area A surrounded by a dashed line in FIG. 19) including a blank symbol irrelevant to determination of winning.

The symbol area and the blank area are disposed to be adjacent to each other, and

the blank area is formed seamlessly with the symbol area as a part of the symbol area.

The blank area is formed seamlessly with the adjacent symbol area. Accordingly, a part of the blank area formed like a part of the symbol area can be seen by the player as if the symbol area were enlarged. The emphasized symbol area enables the player to see the symbol area distinctly.

The reel strip for a gaming machine according to the present embodiment further comprises a swelling part (e.g., the background part 525 to be described later) surrounding the winning element symbol.

A part of the swelling part is placed to overlap with the blank area (e.g., the first curve part 533a or the second curve part 533b to be described later).

A part of the swelling part is placed to overlap with the blank area and is in the blank area. The remaining part of the swelling part is placed to overlap with the symbol area and is in the symbol area. It is preferable that the part of the swelling part be formed seamlessly with the remaining part of the swelling part. The part of the swelling part is a blank area but can be formed as if the symbol area was enlarged with the part of the swelling part, enabling the player to see the winning element symbol in the symbol area distinctly. It is sufficient if the swelling part functions as the background of the winning element symbol and can be seen as the background of the winning element symbol.

The reel strip for a gaming machine according to the present embodiment has a first end and a second end (e.g., the first straight part 531a and the second straight part 531b to be described later) having a long length along a longitudinal direction and opposed to each other.

The symbol area is a rectangular area having a first length along the first end and the second end,

the blank area is a rectangular area (e.g., the area B surrounded by a thick dashed line in FIG. 19) having a second length along the first end and the second end, and

a part of the swelling part is curved outward from the symbol area toward the blank area in a section between the first end and the second end (e.g., the first curve part 533a or the second curve part 533b to be described later).

Clear definitions of the symbol area and the blank area are provided, which make it clear that the part of the swelling part is not a symbol area but a blank area, while enabling the player to see as if the symbol area was enlarged.

The reel strip for a gaming machine according to the present embodiment includes winning element symbols of scatter symbols (e.g., JACKPOTs and a BONUS to be described later) and non-scatter symbols (e.g., RED7s, BLUE7s, 3BARs, 2BARs, and 1BARs to be described later).

The scatter symbols are formed inside symbol areas,

the non-scatter symbols are formed inside non-scatter symbol areas different from the symbol areas, and

the non-scatter symbol areas are formed separately from the symbol areas.

If rearranged symbols include scatter symbols, a winning pattern may be completed depending on the number of rearranged scatter symbols. The player counts the rearranged scatter symbols to determine whether a winning pattern is completed. Accordingly, providing a large scatter symbol inside a symbol area and overlapping a part of a swelling part with a blank area enable the player to easily see the scatter symbol. As a result, the player can easily count the scatter symbols to speedily and easily find out whether a winning pattern is completed.

As to non-scatter symbols, a winning pattern is completed when non-scatter symbols are arranged along a payline at rearrangement. Accordingly, the player determines whether a winning pattern is completed or not depending on whether non-scatter symbols are arranged in a winning pattern. Since non-scatter symbols are formed separately from symbol areas and not expanded into blank areas, the player is prevented from mistaking the arrangement of non-scatter symbols. Accordingly, the player can clearly recognize non-scatter symbols are arranged along a payline.

In the reel strip for a gaming machine according to the present embodiment,

the winning element symbol includes a pictorial figure (e.g., the picture of a diamond 523 to be described later), and

the symbol area and the swelling part include a background part (e.g., the background part 525 to be described later) to be a background of the winning element symbol.

The background part can join the background of a winning element symbol in the symbol area and the background of the winning element symbol in the blank area, so that the blank area can look like a part of the symbol area, emphasizing the winning element symbol for the player.

The reel strip for a gaming machine according to the present embodiment further comprises:

a first symbol area (e.g., the upper symbol area B to be described later) including a winning element symbol;

a second symbol area (e.g., the lower symbol area B to be described later) including a winning element symbol and disposed opposite to a first symbol area along the longitudinal direction;

a first blank area (e.g., the blank area A′ to be described later) disposed between a first symbol area and a second symbol area and adjacent to the first symbol area and the second symbol area;

a second blank area (e.g., the upper blank area A to be described later) disposed opposite to the first blank area across the first symbol area; and

a third blank area (e.g., the lower blank area A to be described later) disposed opposite to the second blank area across the second symbol area.

In a case where the first symbol area and the second symbol area are provided to be adjacent to each other on the reel strip, the boundaries of the first symbol area and the second symbol area from the three blank areas of the first, the second, and the third blank areas can be clearly defined using the three blank areas.

Forming a part of the first blank area like a part of the first symbol area and forming another part of the first blank area like a part of the second symbol area by forming the first symbol area seamlessly with the first blank area and by forming the second symbol area seamlessly with the first blank area enable the first symbol area and the second symbol area to be seen as if these symbol areas were enlarged.

In the reel strip for a gaming machine according to the present embodiment, the blank area is formed in a single color and in a lightness different from a lightness of the background part.

Since the blank area is formed in a single color but different in lightness from the background part, the player can clearly recognize that the blank area is a blank area and an area between symbol areas. It should be noted that the blank area and the background part need to be different in one of the hue, the lightness, and the saturation, as well as the lightness.

A reel strip for a gaming machine according to the present embodiment comprises:

a symbol area (e.g., the area B surrounded by a thick dashed line in FIG. 19) including a winning element symbol (e.g., a JACKPOT to be described later) based on which winning or not is determined;
a blank area (e.g., the area A surrounded by a dashed line in FIG. 19) including a blank symbol irrelevant to determination of winning; and

a background part (e.g., the background part 525 to be described later) being a background of the winning element symbol.

The symbol area has a rectangular shape;

the blank area has a rectangular shape;

the symbol area is disposed adjacent to the blank area;

the winning element symbol is disposed to be included inside the symbol area and the background part; and

the background part is formed to be protruding from the symbol area into the blank area (e.g., the background part 525 to be described later).

The area of the background part is protruding from the symbol area into the blank area and disposed to overlap with both of the symbol area and the blank area. Accordingly, although the winning element symbol itself is disposed inside the symbol area, the background part shows the symbol area as if the symbol area was enlarged, emphasizing the winning element symbol.

In the reel strip for a gaming machine according to the present embodiment,

a boundary between the symbol area and the blank area is a straight line;

the background part is defined by two straight parts opposed to each other and two curve parts ended by the two straight parts and opposed to each other;

the two straight parts are provided along a longitudinal direction of the reel;

one of the two curve parts includes a swelling part swelling toward the blank area and crossing the boundary between the symbol area and the blank area; and

a part of the swelling part is located to overlap with the blank area.

Although the winning element symbol itself is disposed inside the symbol area, the swelling part swelling toward the blank area shows the symbol area as if the symbol area was swelling, emphasizing the winning element symbol.

### <<<<Specific Overview of Gaming Machine in Embodiment>>>>

An overview of a gaming machine 10 in the present embodiment is as follows. Details are described later.

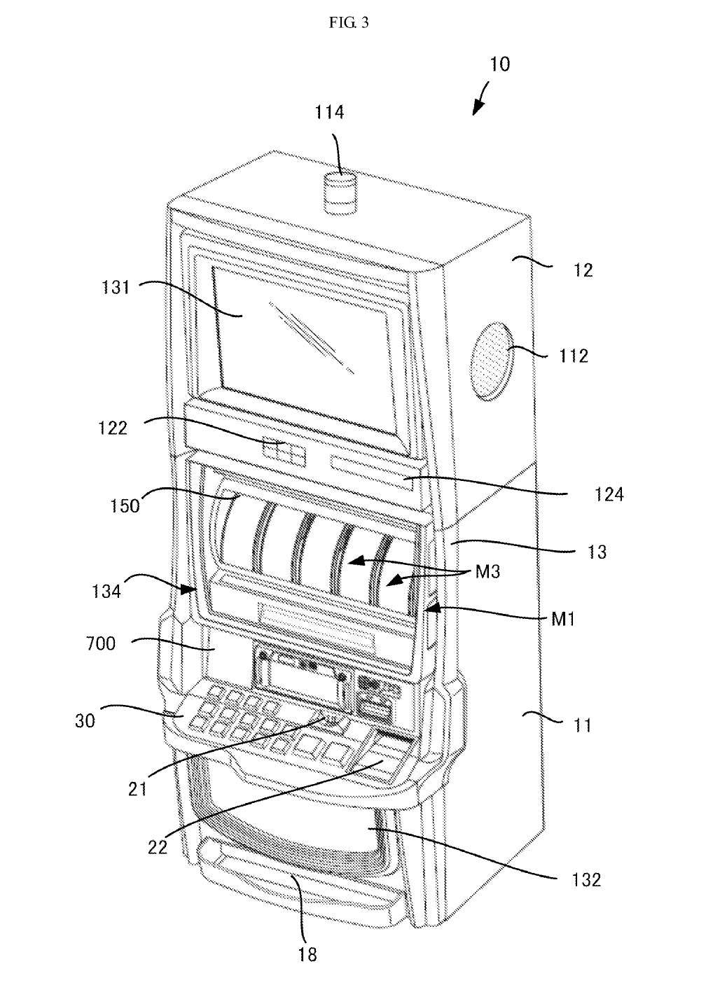

The gaming machine 10 includes five reels M3a, M3b, M3c, M3d, and M3e from the left to the right as seen from the player. The five reels M3a to M3e are mechanically controlled to spin or stop with electric motors. In the gaming machine 10, symbols on each of the five reels M3a to M3e are stopped on three rows of the top row, the middle row, and the bottom row in a display window 150 of the symbol display unit 40 (see FIG. 3). When the five reel M3a to M3e are stopped, fifteen symbols (=5 reels×3 rows) in total are rearranged in the display window 150.

The gaming machine 10 has thirty paylines in the display window 150. A win or a loss is determined depending on the kind and the number of the symbols arranged along the paylines. The gaming machine 10 enables the thirty paylines with the minimum bet of one credit. That is to say, the thirty paylines are always valid in the gaming machine 10 of the present embodiment regardless of the bet.

The bet patterns in the gaming machine 10 are the following four patterns: (1) 30, 60, 90, 120, and 150; (2) 30, 60, 90, 150, and 300; (3) 30, 60, 150, 300, and 450; and (4) 30, 60, 150, 300, and 600. One of these four bet patterns is set to the gaming machine 10. The bet pattern is set by a clerk of an amusement hall, such as a casino.

As mentioned above, thirty paylines are always valid. Accordingly, the bets in the first bet pattern are 1, 2, 3, 4, and 5 per payline. The bets in the second bet pattern are 1, 2, 3, 5, and 10 per payline. The bets in the third bet pattern are 1, 2, 5, 10, and 15 per payline. The bets in the fourth bet pattern are 1, 2, 5, 10, and 20 per payline. As understood from these, the maximum bets in the four bet patterns are 5, 10, 15, and 20 per payline.

The gaming machine 10 includes symbols of RED7, BLUE7, 3BAR, 2BAR, 1BAR, JACKPOT, and BONUS. With respect to the RED7, BLUE7, 3BAR, 2BAR, and 1BAR, a win or a loss is determined on a left-to-right basis. The number of the same kind of symbols successively arranged along a payline from the left to the right determines a win or a loss.

That is to say, the kind and the number of symbols successively arranged along a payline, starting from the leftmost reel M3a toward the rightmost reel M3e determines a payout. Accordingly, when a specific kind of symbols are arranged successively along a payline starting from the reel M3b, M3c, or M3d, the game result is not a win and no payout is provided.

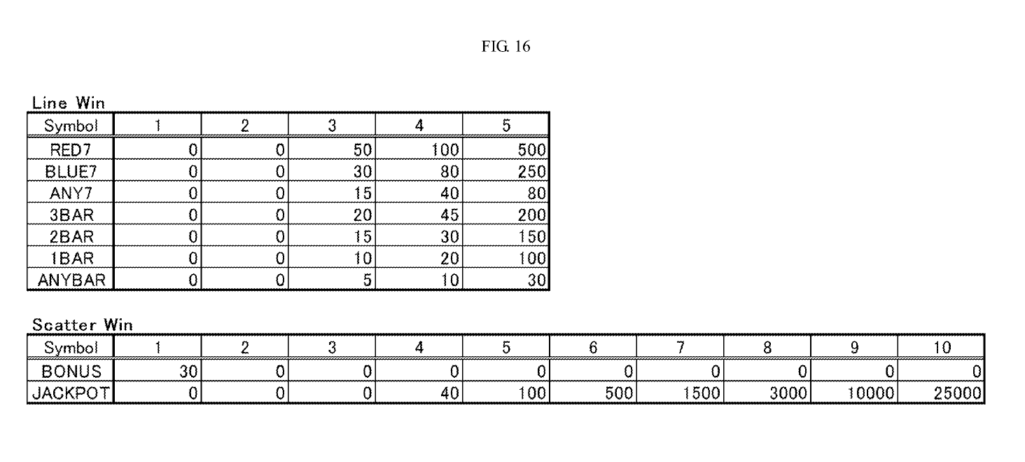

As shown in FIG. 16 to be described later, winning patterns of nine kinds of symbols are defined. The details of the winning patterns are described later. When two kinds of symbols of RED7s and BLUE7s are mixed and arranged along a payline, the combination is regarded as a kind ANY7 and a predetermined payout is provided. When two kinds of symbols BLUE7s and RED7s are mixed and arranged along a payline, the combination is also regarded as ANY7 and a predetermined payout is provided.

When three kinds of symbols of 3BARs, 2BARs, and 1BARs are mixed and arranged along a payline, the combination is regarded as a kind ANYBAR and a predetermined payout is provided. When three kinds of symbols of 2BARs, 3BARs, and 1BARs are mixed and arranged along a payline, the combination is also regarded as ANYBAR and a predetermined payout is provided. When three kinds of symbols of 1BARs, 3BARs, and 2BARs are mixed and arranged along a payline, the combination is also regarded as ANYBAR and a predetermined payout is provided.

JACKPOTs and BONUSes are scatter symbols. When a required number of JACKPOTs or BONUSes appear in the display window 150, a win is determined.

On each reel, two JACKPOTs are successively disposed across a BLANK. The BONUS is provided only on the third reel.

In a base game mode, a free game trigger is completed when a BONUS of a scatter symbol appears in the display window 150. In response to the free game trigger, the game mode changes from the base game mode to a free game mode.

In a free game mode, a unit game can be conducted that can win a jackpot easily. Furthermore, when a BONUS appears in the display window 150 in the free game mode, a retrigger is completed. In response to the retrigger, another unit game is added in the free game mode.

The gaming machine 10 has a feature of progressive jackpot. The feature of progressive jackpot pays out the amount in the progressive jackpot accumulated until the time when JACKPOTs of Kind No. 6 or higher (six or more JACKPOTs) are rearranged in the display window 150 to win the progressive jackpot.

In the gaming machine 10, a predetermined amount to be stored is added to the amount in the progressive jackpot in each unit game. The amount in the progressive jackpot to be paid out at winning the progressive jackpot is the entire accumulation.

As will be described later, when JACKPOTs of Kind No. 4 or higher (four or more JACKPOTs) are rearranged in the display window 150, a payout for the Kind number (normal payout) is provided. As described above, when JACKPOTs of Kind No. 6 or higher are rearranged in the display window 150, the amount in the progressive jackpot is provided. Accordingly, when JACKPOTs of Kind No. 6 or higher are rearranged in the display window 150, the amount in the progressive jackpot is provided in addition to the payout for the Kind number. In other words, when JACKPOTs of Kind No. 6 or higher are rearranged in the display window 150, both of the payout for the Kind number and the payout from the progressive jackpot are provided.

### <Overall Game System>

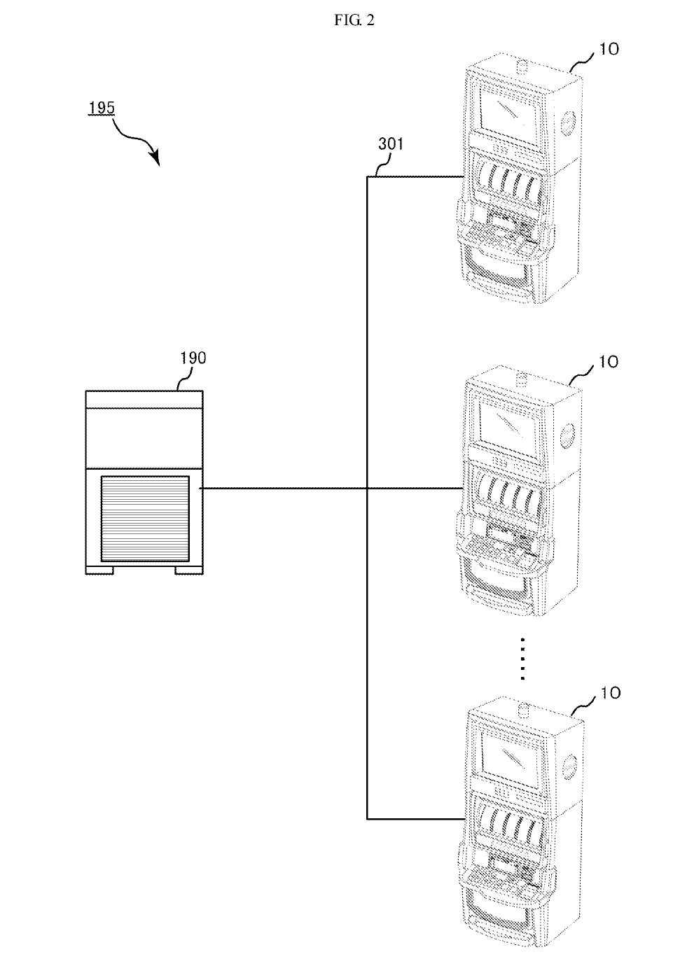

The basic features of the gaming machine 10 have been described above. Next, with reference to FIG. 2, a game system including the gaming machine is described. FIG. 2 is a view illustrating the game system including the gaming machine according to the embodiment of the present invention.

A game system 195 includes a plurality of gaming machines 10, and an external control device 190 that is connected to the gaming machines 10 through a communication line 301.

The external control device 190 controls the plurality of gaming machines 10. In the present embodiment, the external control device 190 is a so-called hall server which is installed in an amusement hall having the plurality of gaming machines 10. Each of the gaming machines 10 is assigned a unique identification number; the external control device 190 identifies a gaming machine 10 that sends data to the external control device 190 with the identification number. Also in the case where the external control device 190 sends data to a gaming machine 10, the identification number is used to designate the destination.

The game system 195 may be constructed within a single amusement hall where various games can be conducted, such as a casino, or may be constructed among a plurality of amusement halls. In the case where the game system 195 is constructed in a single amusement hall, the game system 195 may be constructed in each floor or section of the amusement hall. The communication line 301 may be wired or wireless, and can adopt a dedicated line, an exchange line or the like.

### <Overall Configuration of Gaming Machine>

The game system according to the present embodiment has been described above. Next, with reference to FIG. 3, an overall configuration of the gaming machine 10 is described. FIG. 3 is a view illustrating the overall configuration of the gaming machine according to the embodiment of the present invention.

The gaming machine 10 accepts coins, bills, and electrically valuable information corresponding to these as game media. Particularly in the present embodiment, credit data such as monetary data stored in an IC card is used.

The gaming machine 10 includes a cabinet 11, a top box 12 placed on the top of the cabinet 11, and a main door 13 provided on the front of the cabinet 11.

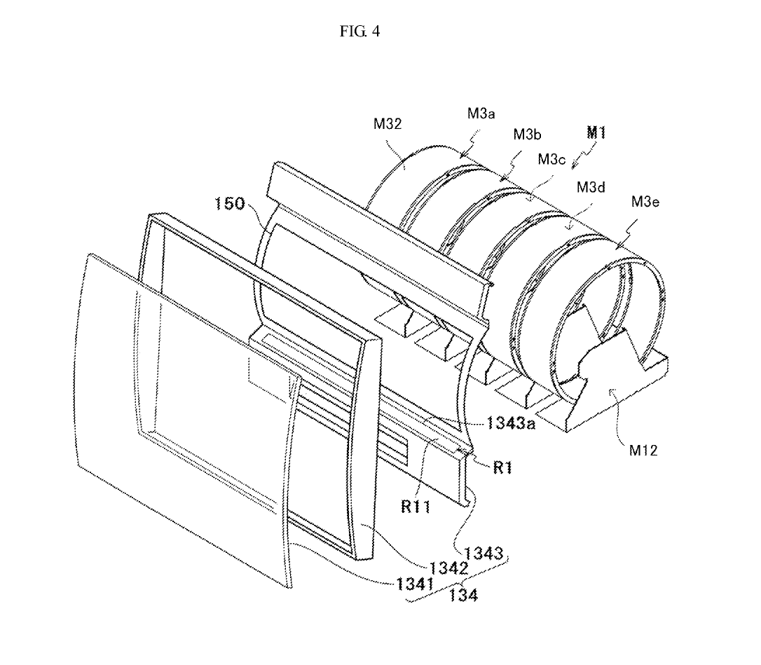

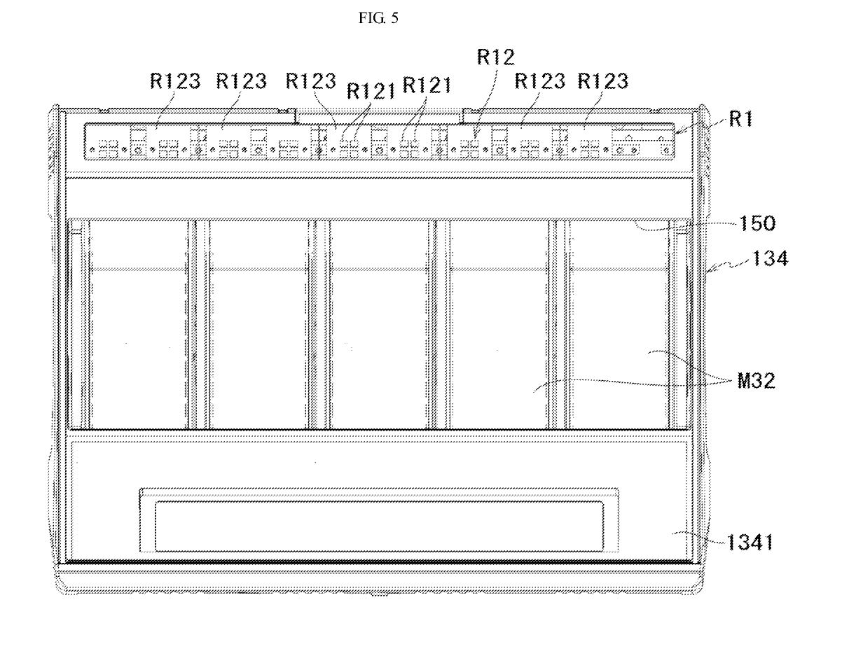

A reel device M1 is provided on the main door 13. A reel cover 134 is provided on the front of the reel device M1. As illustrated in FIGS. 4 to 7, the reel cover 134 includes a clear panel 1341, a panel frame 1342 to which the clear panel 1341 is attached on the front thereof, and a panel holder 1343 for holding the panel frame 1342. The panel holder 1343 is provided with illumination units R1. Each illumination unit R1 includes a transparent panel R11 provided in an opening 1343a of the panel holder 1343 and a light source device R12 for emitting visible light. The illumination unit R1 will be described later in detail.

The reel cover 134 has a display window 150 at the center as illustrated in FIG. 3. The display window 150 allows fifteen symbols of five columns by three rows to be seen from the outside as a symbol matrix. Three symbols of each column are a part of the symbols arrayed on the outer surface of a reel M3 (one of the reels M3a to M3e). Each reel M3 moves upward or downward while changing the speed to show three of the symbols thereon, enabling the symbols shown in the display window 150 to be rearranged or stopped after being scrolled vertically.

Although the present embodiment describes a gaming machine 10 including a reel device M1 employing a mechanical reel system, the gaming machine 10 of the present invention may employ a video reel system that displays mimic reels or a mixture of the video reel system and the mechanical reel system. The reel cover 134 may be equipped with a touch panel. In such a case, the player can input various instructions by operating the touch panel. The touch panel sends input signals to the main CPU 222. The reel cover 134 may further be equipped with a transparent liquid crystal panel instead of the clear panel 1341. If the reel cover 134 includes a transparent liquid crystal panel, combinations of effects are available using the symbols of the reel device M1, visual information by visible light from the illumination units R1, and videos and images on the transparent liquid crystal panel.

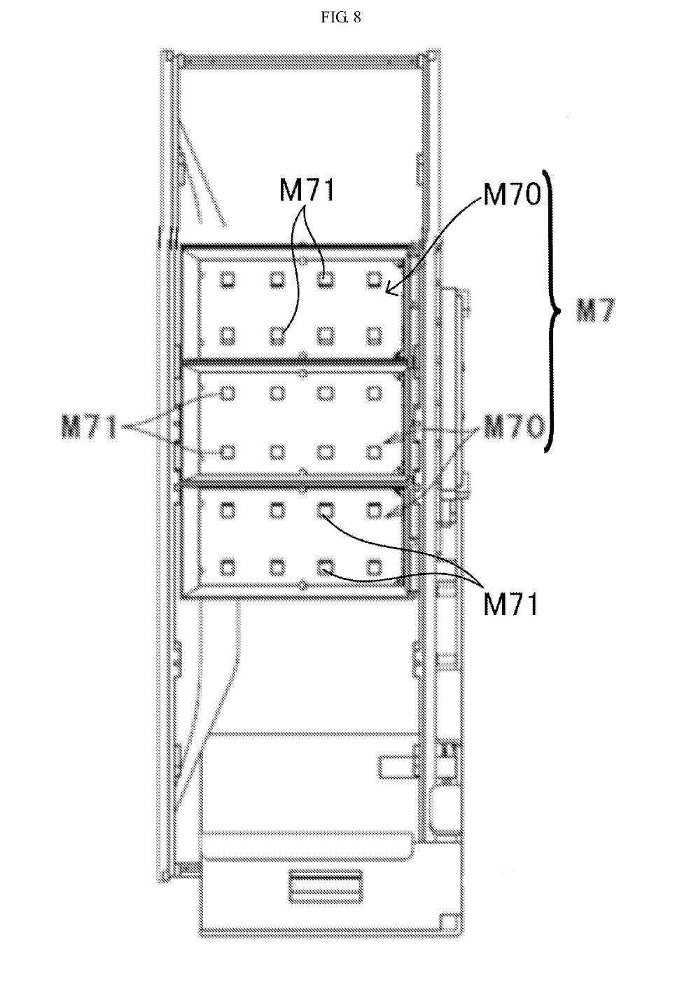

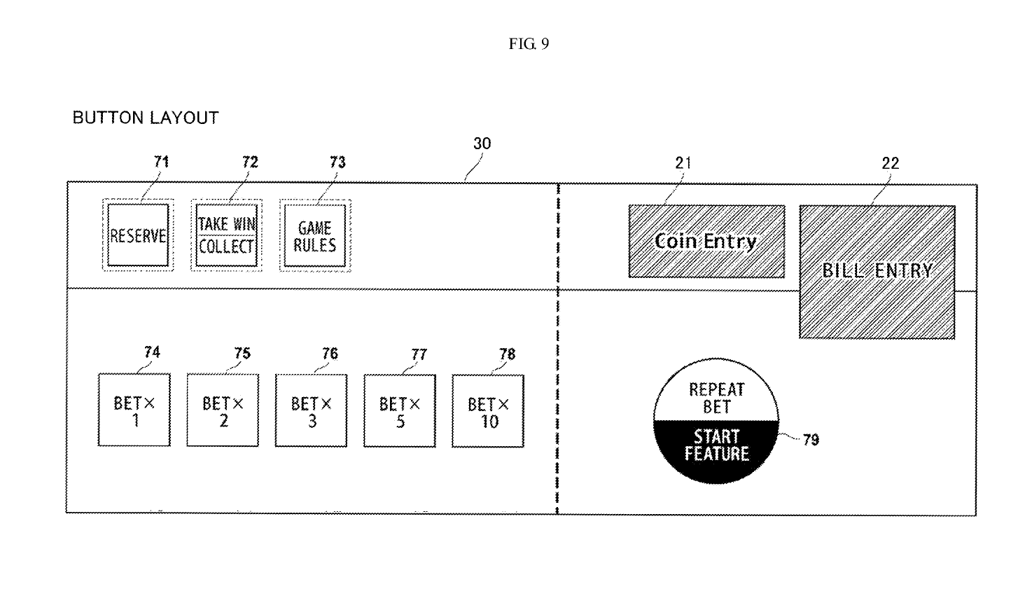

The reel device M1 includes backlight units M7 inside thereof. The details of the backlight units M7 will be described later with reference to FIG. 8.

Below the reel device M1, a control panel 30 is provided. The control panel 30 includes various buttons and further, a coin entry 21 for receiving coins into the cabinet 11 and a bill entry 22.

Specifically, the control panel 30 includes a RESERVE button 71, a COLLECT button 72, a GAME RULES button 73, a 1-BET button 74, a 2-BET button 75, a 3-BET button 76, a 5-BET button 77, and a 10-BET button 78 as a part of the control panel 30 is schematically illustrated in FIG. 9. The RESERVE button 71, the COLLECT button 72, and the GAME RULES button 73 are disposed in the upper left area of the control panel 30. The 1-BET button 74, the 2-BET button 75, the 3-BET button 76, the 5-BET button 77, and the 10-BET button 78 are disposed in the lower left area of the control panel 30. Further, a START button 79 is disposed at the lower middle of the control panel 30.

The RESERVE button 71 is used when the player leaves the machine for a minute or wants to ask a staff of the amusement hall for exchange. The RESERVE button 71 is also used to store the remaining credit to the IC card inserted in the IC card reader 60. The COLLECT button 72 is used to instruct the gaming machine 10 to pay out the credited coins to a coin tray 18. If the player is unfamiliar with the rules of the game or the operation of the machine, the GAME RULES button 73 is used. In response to a press of the GAME RULES button 73, a variety of help information comes up on an upper image display panel 131.

The BET buttons 74 to 78 are used to set the amount of bet. Each time the player presses the 1-BET button 74, one credit is bet on each active payline from the player's current credit. If the player presses the 2-BET button 75, two credits are bet on each active payline to start a unit game. If the player presses the 3-BET button 76, three credits are bet on each active payline to start a unit game. If the player presses the 5-BET button 77, five credits are bet on each active payline to start a unit game. If the player presses the 10-BET button 78, ten credits are bet on each active payline to start a unit game. The START button 79 (so-called spin button) is used to instruct the gaming machine to start spinning the reels M3a to M3e under the bet condition determined before.

On the lower front of the main door 13 and below the control panel 30, a coin tray 18 for receiving discharged coins and a belly glass 132 on which a picture of a character of the gaming machine 10 may be printed.

An upper image display panel 131 is provided on the front of the top box 12. The upper image display panel 131 is made of a liquid crystal panel, and forms a display. The upper image display panel 131 displays images for effects, images showing introduction of the game contents, and images to explain the game rules. Further, the top box 12 is provided with speakers 112 and a lamp 114. The gaming machine 10 produces effects by displaying images, outputting sounds, and outputting the light.

A data display 124 and a keypad 122 are provided below the upper image display panel 131. The data display 124 includes a fluorescent display, LEDs, and the like to display data on the membership retrieved from an IC card inserted from a PTS terminal 700 or the data inputted by the player with the keypad 122, for example. The keypad 122 is for inputting data.

### <Reel Device M1>

The reel device M1 in the gaming machine 10 is structured to hold a plurality of reels M3a to M3e so that the reels M3a to M3e have rotational axes on the same horizontal line. The reel device M1 includes reel assemblies M11 for rotationally driving the reels M3a to M3e to rearrange the symbols arrayed on their outer surfaces and reel assembly holders M12 for holding the reel assemblies M11 removably. In the following description, when the individual reel assemblies M11 need to be specified depending on the location, the reel assemblies M11 are referred to as the first to the fifth reel assemblies M11a to M11e from the left to the right as seen from the front.

Each reel assembly M11 includes a reel M3 with symbols arrayed on the outer surface and a reel assembly holder M12 for supporting the reel M3. Each reel M3 has an annular reel strip M32 on which one or more symbols are arrayed.

### <Reel Assembly M11: Backlight Unit M7>

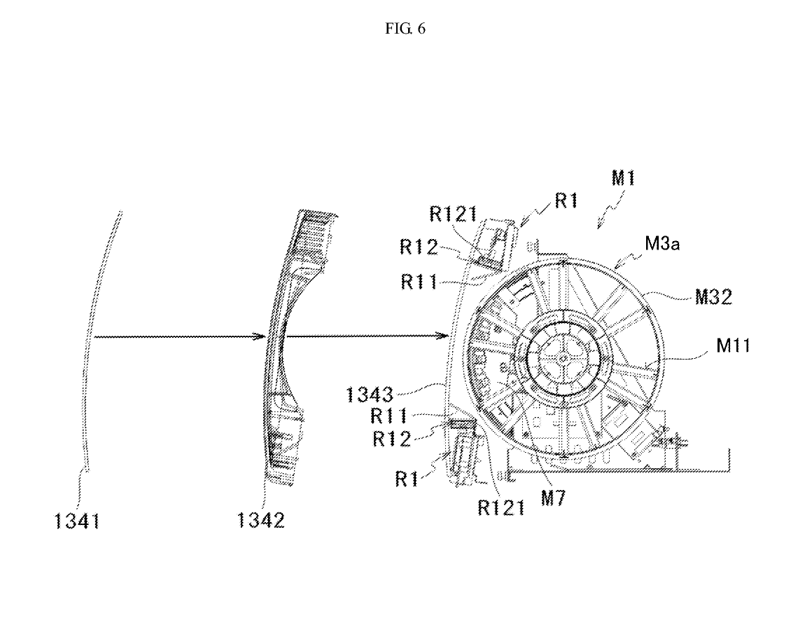

As illustrated in FIG. 6, a backlight unit M7 is provided behind the circumferential surface of each reel M3 structured as described above. The backlight unit M7 is placed so that the illumination light emitted from behind the circumferential surface of the reel M3 toward the reel strip M32 can be seen from the outside of the gaming machine 10 through the reel strip M32. As a result, the symbols look as if the symbols were displayed on the reel strip M32 for the player.

Although not clearly illustrated in the drawings, the five reels M3a to M3e are each provided with a backlight unit M7. As illustrated in FIG. 8, the backlight unit M7 is a unit including a plurality of modules M70 (three modules in the present embodiment) each including a plurality of light sources M71 disposed like a matrix. Each light source M71 is a full-color LED including a red LED element for emitting red light, a blue LED element for emitting blue light, and a green LED element for emitting green light in a package, for example. In each light source M71, the red LED element, blue LED element, and green LED element are independently controlled by the main CPU 222 about ON/OFF or the intensity of the light when the LED element is ON. That is to say, the light sources M71 can produce a desired color of visible light by tuning the light volume of each LED element.

### <Illumination Unit R1>

As illustrated in FIGS. 5 to 7, in front of the reel device M1, illumination units R1 for emitting visual information toward the reels M3a to M3e of the reel device M1 are provided. The illumination units R1 are provided at an upper place and a lower place than the reel device M1 including the reels M3a to M3e. Accordingly, the illumination units R1 are outside the visible field when the reels M3a to M3e are viewed through the display window 150 from the outside of the cabinet 11. The illumination units R1 can produce effects in the display window 150 using reflection of the visible light emitted toward the reels M3a to M3e, like the effects in the display window 150 produced by a transparent liquid crystal panel or a half mirror provided in front of the reels M3a to M3e. The illumination unit R1 enables producing effects in the display window 150 without securing any installation space for the transparent liquid crystal panel or the like in front of the reels M3a to M3e.

Only either one of the illumination units R1 may be provided at an upper place or a lower place than the reel device M1. Specifically, an illumination unit R1 may be placed upper or lower and outer than the display window 150 and configured to emit visible light wider than the total width of the reels M3a to M3e held by the reel device M1.

The illumination units R1 are provided on the reel cover 134 which functions as the front wall including the display window 150 of the reel device M1. The illumination units R1 and the reel cover 134 are joined as a unit. Accordingly, when the reel cover is attached to the cabinet 11, the illumination units R1 can be attached together.

The illumination units R1 are configured to illuminate the front of the reel device M1 with visible light. In other words, the illumination unit R1 is configured to illuminate the non-effective range of the symbols other than the effective range of the symbols with the visible light.

Specifically, each illumination unit R1 includes a transparent panel R11 (transparent member) fit in an opening 1343a of the panel holder 1343 and a light source device R12 for emitting visible light. The transparent panel R11 is colored to provide visual information in a specific color when the visible light passes through the transparent panel R11. The transparent panel R11 has substantially the same width as that of the reel device M1. The light source device R12 is formed to emit visible light in the entire width of the transparent panel R11.

The light source device R12 includes a plurality of full-color LEDs R121 having the same configuration as the light sources M71 of the backlight unit M7. A full-color LED R121 is a light source using light emitting diode chips in the three primary colors of red, green, and blue; visible light in a desired color can be produced by tuning the light volumes of the LEDs in the three colors. The full-color LEDs R121 are disposed like a matrix in the directions of the width and the depth. Specifically, as illustrated in FIG. 5, the light source device R12 includes LED units R123 disposed in one-to-one correspondence with the reels M3a to M3e. Each LED unit R123 includes two sets of four full-color LEDs R121 of two columns by two rows; the two sets of LEDs R121 are disposed in parallel in the width direction of the reel strip M32. This configuration enables adjustment of the position to illuminate the reel device M1 by controlling which full-color LED to light.

### <Electrical Configuration of Gaming Machine>

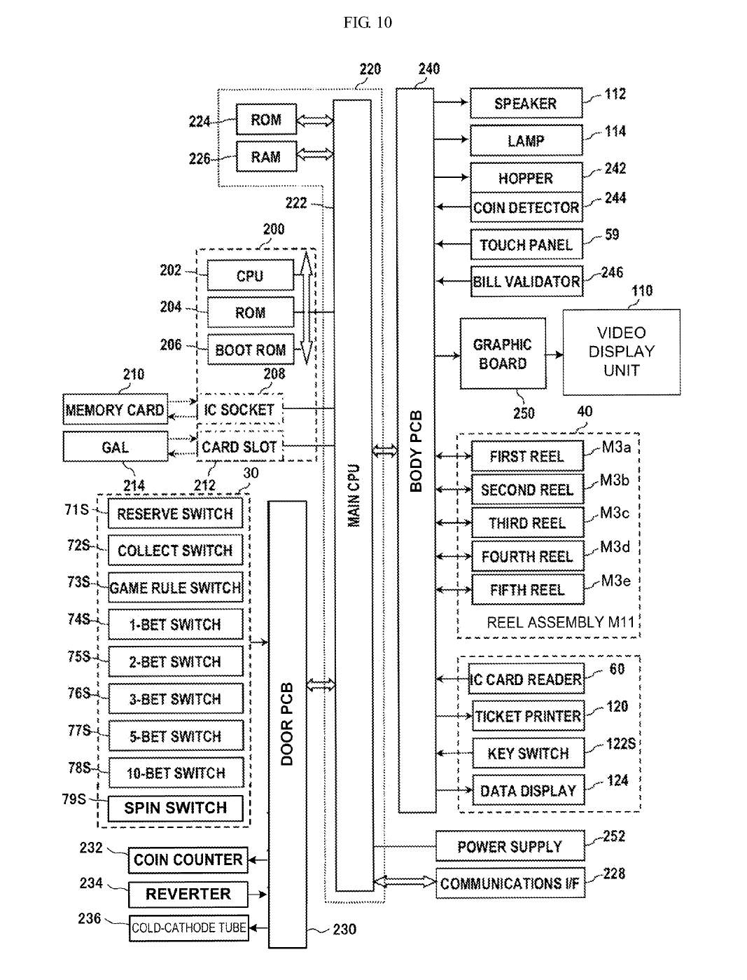

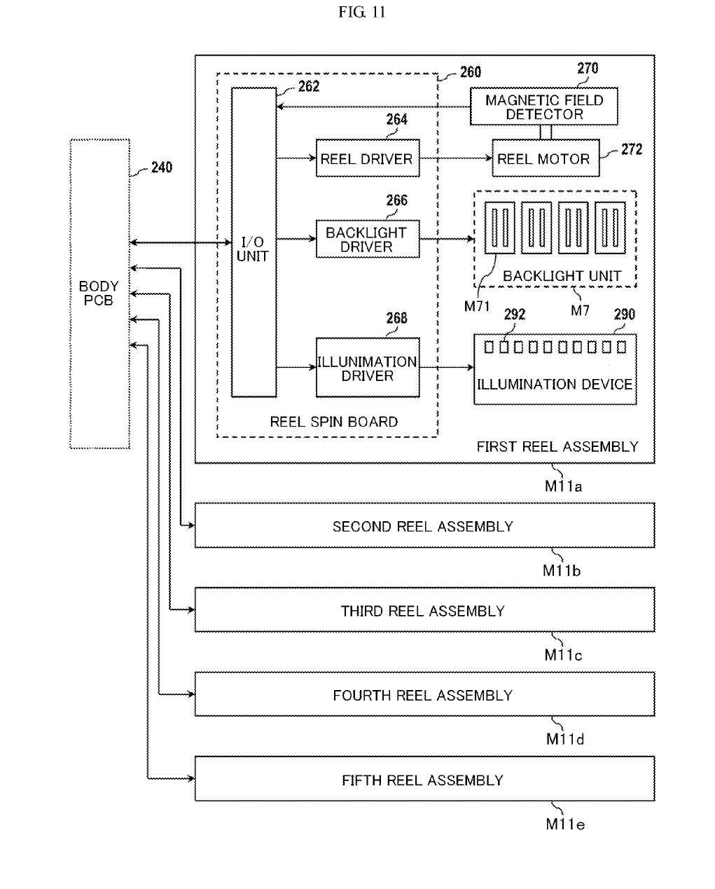

FIG. 10 is an electrical block diagram of the gaming machine 10 illustrated in FIG. 3. The gaming machine 10 includes a gaming board 200, a motherboard 220, a door PCB 230, and a body PCB 240.

The gaming board 200 includes a CPU 202, a ROM 204 accessible from the CPU 202 via an internal bus, and a boot ROM 206 accessible from the CPU 202 via the internal bus. The gaming board 200 further includes an IC socket 208 that can accommodate a memory card 210 and communicate with the memory card 210 and a card slot 212 provided for a general array logic (GAL) 214.

The memory card 210 includes a non-volatile memory, and stores a game program and a game system program.

The IC socket 208 is formed so that a memory card 210 can be inserted thereinto and removed therefrom. The IC socket 208 is connected to the motherboard 220 by an IDE bus. The game executed by the gaming machine 10 can be changed by replacing the memory card 210 with a different one. Alternatively, the game executed by the gaming machine can be changed by removing the memory card 210 from the IC socket 208, writing a different program to the memory card 210, and inserting the memory card 210 into the IC socket 208 again.

The GAL 214 is a type of programmable logic device (PLD) having a fixed OR array structure. The GAL 214 is provided with a plurality of input ports and output ports. In response to receipt of given data via an input port, the GAL 214 outputs data corresponding to the input data from an output port.

The card slot 212 is formed so that the GAL 214 can be inserted thereinto and removed therefrom, and is connected to the motherboard 220 by a PCI bus.

The CPU 202, the ROM 204, and the boot ROM 206 interconnected by the internal bus are connected with the motherboard 220 by a PCI bus. The PCI bus enables signal transmission between the motherboard 220 and the gaming board 200 and power supply from the motherboard 220 to the gaming board 200.

The ROM 204 stores programs. The boot ROM 206 stores a pre-authentication program, a boot code to be used by the CPU 202 for activating the pre-authentication program. An authentication program is a tamper check program for authenticating the game program and the game system program. The pre-authentication program is a program for authenticating the authentication program. The authentication program and the pre-authentication program are written to prove that the program to be the subject has not been tampered.

The motherboard 220 is a commonly available main board. The motherboard 220 executes a game program and a game system program. The motherboard 220 includes a main CPU 222, a ROM 224, a RAM 226, and a communication interface 228.

The ROM 224 is a memory device for storing programs to be executed by the main CPU 222. The ROM 224 persistently stores programs such as the BIOS together with other data. The ROM 224 may be a flash memory. When the BIOS is executed by the main CPU 222, the program of the BIOS initializes the peripheral devices. Furthermore, the program of the BIOS loads the game program and the game system program stored in the memory card 210 through the gaming board 200. Although the ROM 224 may be rewritable, a write-protected memory device may be used as the ROM 224.

The RAM 226 stores data and programs to be used in operation of the main CPU 222. For example, when the game program or the authentication program is loaded, the RAM 226 can store the program. The RAM 226 has a working space to execute a program. For example, the working space stores a bet count, a payout count, a credit count and the like, which are retained when the game is being executed. Tables defining symbols, symbol codes, winning combinations, and their probabilities are also retained when the game is being executed. Furthermore, the RAM 226 stores a symbol determination table, a BONUS and JACKPOT symbol value determination table, and a payout table. The symbol determination table stores mapping information between the symbol codes and the random numbers to determine a symbol based on a random number. The RAM 226 holds a mode flag and a game counter. The mode flag is a flag for indicating the game mode. The game counter is a count value indicating the number of unit games already executed or to be executed.

The RAM 226 further stores count values of a plurality of counters. The plurality of counters include a payout counter, a credit counter 320, a free game counter 324, and a bet counter. Some of the count values may be held by an internal register of the main CPU 222.

The main CPU 222 communicates with an external controller through the communication interface 228. For example, the external controller includes a server (external control device 190) connected by a communication line as shown in FIG. 2.

The motherboard 220 is connected with the door PCB 230 and the body PCB 240. The motherboard 220 can communicate with the door PCB 230 and the body PCB 240 using USB. The motherboard 220 is connected with a power supply 252. The main CPU 222 of the motherboard 220 activates and operates using the electric power supplied from the power supply 252. The motherboard 220 passes part of the electric power to the game board 200 through the PCI bus to activate the CPU 202. The door PCB 230 and the body PCB 240 are connected with input devices. The input devices include a switch, a sensor, and peripheral devices the operations of which are controlled by the main CPU 222. The door PCB 230 is connected with a control panel 30, a coin counter 232, a reverter 234, and a cold cathode tube 236.

The control panel 30 includes a RESERVE switch 71S, a COLLECT switch 72S, a GAME RULES switch 73S, a 1-BET switch 74S, a 2-BET switch 75S, a 3-BET switch 76S, a 5-BET switch 77S, a 10-BET switch 78S, and a SPIN (START) switch 79S, which are provided correspondingly to the various buttons 71 to 79. Each of the switches 71S to 79S outputs a signal to the main CPU 222 upon detection of press by the player.

The coin counter 232 and the reverter 234 are provided at the coin entry 21. The coin counter 232 validates a coin inserted into the coin entry 21 based on its material, shape and the like. The coin counter 232 outputs a signal to the main CPU 222 upon detection of a valid coin. Invalid coins are discharged from a coin tray 18. The reverter 234 operates based on a control signal outputted from the main CPU 222. The reverter 234 supplies valid coins validated by the coin counter 232 to a hopper 242 or a cash box (not shown). When the hopper 242 is not filled with coins, coins are guided to the hopper 242. When the hopper 242 is filled with coins, coins are guided to the cash box.

The cold cathode tube 236 is provided on the back of the video display unit 110 (upper image display panel 131). The cold cathode tube 236 functions as a backlight or a light based on a control signal from the main CPU 222.

The body PCB 110 is connected with the speakers 112, the lamp 114, the hopper 242, a coin detector 244, a touch panel 59, the bill validator 246, the reel assemblies M11, an IC card reader 60, a graphic board 250, a ticket printer 120, a key switch 122S and a data display 124.

The lamp 114 goes on and out based on a control signal from the main CPU 222. The speakers 112 output sounds such as BGM, based on a control signal from the main CPU 222.

The hopper 242 operates based on a control signal from the main CPU 222, and ejects coins corresponding to the specified amount of payout from the coin payout exit (not shown) provided between the belly glass 132 and the coin tray 18. The coin detector 244 outputs a signal to the main CPU 222 upon detection of coins ejected from the hopper 242.

The touch panel 59 detects a place touched by the player and outputs a signal corresponding to the detected place to the main CPU 222. The bill validator 246 outputs a bill detection signal corresponding to the face amount of a bill to the main CPU 222 upon detection of a valid bill.

The graphic board 250 controls a video display unit 110 and the display panel of the symbol display unit 40 in accordance with a control signal from the main CPU 222. The graphic board 250 includes a video display processor (VDP) for creating video data and a video RAM for temporarily storing the video data. The video data is created with the game program stored in the RAM 226.

The IC card reader 60 retrieves data stored in an IC card inserted into the IC socket 208 and supplies the retrieved data to the main CPU 222. The IC card reader 60 also writes data supplied from the main CPU 222 to an IC card.

The ticket printer 120 prints a barcode conveying information such as a value of the credit counter 320 stored in the RAM 226, a date and time, the identification number of the gaming machine 10, and the like on a ticket in accordance with a control signal from the main CPU 222 to output a barcode ticket.

The key switch 122S is provided on the back of a keypad 122, and outputs a key detection signal to the main CPU 222 when the keypad 122 is pressed by the player.

The data display 124 displays information related to the information entered with the keypad 122 in accordance with a control signal from the main CPU 222.

The body PCB 240 is electrically connected with the reel assemblies M11. As mentioned above, the reel assemblies M11 include the first to the fifth reels M3a to M3e.

FIG. 11 is a block diagram illustrating the electric circuitry of the reel assemblies M11. The reel M3a is provided on a reel spin board 260. The reel spin board 260 includes an input/output (I/O) unit 262 which is capable of communicating with the body PCB 240. The reel spin board 260 further includes a reel driver 264, a backlight driver 266, and an illumination driver 268, which are connected with the I/O unit 262.

The I/O unit 262 is connected with a magnetic field detector 270. The magnetic field detector 270 includes a magnetic sensor for sensing the intensity of magnetic field and outputting a magnetism detection signal proportional to the intensity of the magnetic field and a sensor fixer for fixing the magnetic sensor to a predetermined position. The magnetic sensor senses the intensity of the magnetic field generated by a magnet. The magnet is attached to a rotary shaft of a reel motor 272 and spins with the reel M3a.

The reel driver 264 supplies electric power to the reel motor 272. The backlight driver 266 separately supplies electric power to the individual light sources M71 of the backlight unit M7. The illumination driver 268 supplies electric power to individual light sources 292 of an illumination device 290 separately.

The second to the fifth reels M3b to M3e have the same configuration as the first reel M3a; the detailed description thereof is omitted.

### <Functions of Game Program>

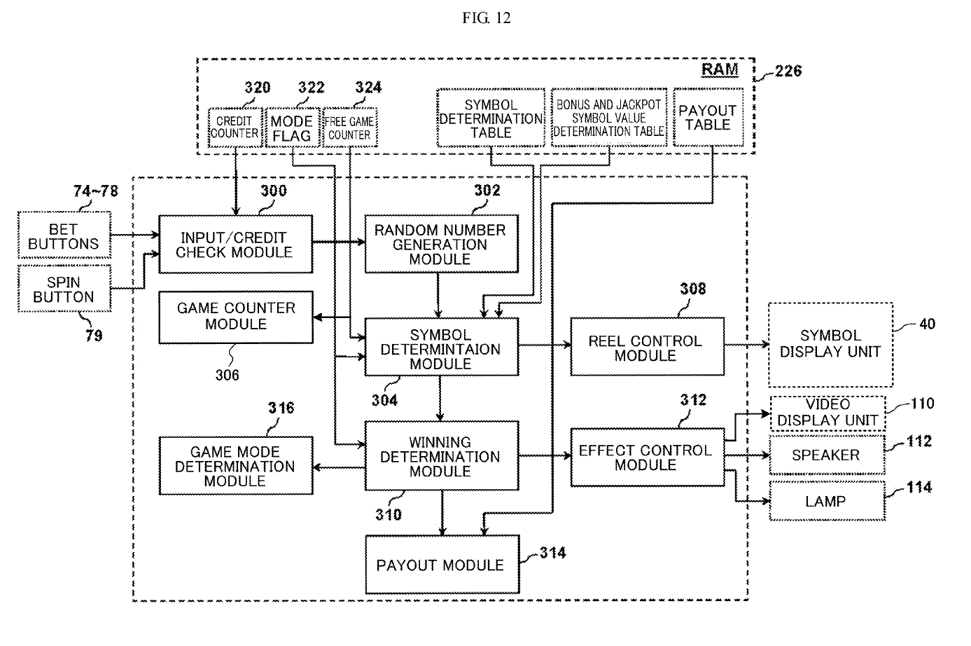

FIG. 12 is a functional block diagram illustrating functions of a game program executed by the main CPU 222 of the motherboard 220. When the power is supplied to the gaming machine 10, the main CPU 222 retrieves the authenticated game program and game system program from the memory card 210 through the game board 200 and writes them to the RAM 226. The game program is executed in such a loaded state in the RAM 226.

In a preferred embodiment, the game program includes an input/credit check module 300, a random number generation module 302, a symbol determination module 304, a game counter module 306, a reel control module 308, a winning determination module 310, an effect control module 312, a payout module 314, and a game mode determination module 316.

The input/credit check module 300 constantly checks whether any of the BET buttons 74 to 78 or the SPIN button 79 is pressed in an idle state where the reels M3a to M3e are still. Upon press of one of the BET buttons 74 to 78 or the SPIN button 79, the input/credit check module 300 checks whether any credit remains for the player with reference to the credit counter 320 stored in the RAM 226. If the player has at least one credit, the input/credit check module 300 invokes the random number generation module 302.

The random number generation module 302 generates random numbers to be used by the symbol determination module 304. In the present embodiment, the random number generation module 302 generates five random numbers. The five random numbers are used for the first to the fifth reels M3a to M3e. In addition, random numbers to determine values for the BONUS and JACKPOT symbols are also generated.

After extracting all the five random numbers, the symbol determination module 304 determines to-be stopped symbols for the reels M3a to M3e separately with reference to a symbol code determination table stored in the RAM 226. The symbol determination module 304 determines five to-be stopped symbols on the plurality of scroll lines (e.g., five reels M3a to M3e) and shows symbols associated with the individual scroll lines (e.g., five reels M3a to M3e) in the display window 150 of the symbol display unit 40. The symbol determination module 304 also determines values for the BONUS and JACKPOT symbols with reference to a BONUS and JACKPOT symbol value determination table stored in the RAM 226 after extracting the random numbers to determine the values for the BONUS and JACKPOT symbols.

The reel control module 308 controls the reel assemblies M11 by supplying the stop position information in accordance with the determined symbols. In accordance with the control, the reels M3a to M5e are spun and stopped at the positions specified by the stop position information. That is to say, the symbols are scrolled with the spin of the reels M3a to M3e and subsequently, the reels M3a to M3e are stopped so that the determined symbols will be rearranged at the vertical center of the display window 150 of the symbol display unit 40.

The winning determination module 310 determines whether the rearranged symbols make a predetermined winning combination. If the rearranged symbols make a winning combination, the effect control module 312 controls the symbol display unit 40 and other devices such as the speakers 112, the lamp 114, and the video display unit 110 in accordance with the winning combination and the game mode. The effects include performances by video and audio and performances by backlight change and illumination. The payout module 314 determines the amount of payout depending on the completed winning combination and provides the amount of payout to the player.

Each time a unit game ends, the game mode determination module 316 determines the game mode of the next unit game. If the rearranged symbols complete a free game trigger in a base game mode, the game mode determination module 316 switches the game mode from the base game mode to the free game mode. If an exit requirement is satisfied in the free game mode, the game mode determination module 316 switches the game mode from the free game mode to the base game mode. In the other cases, the game mode determination module 316 maintains the same game mode. The game mode determination module 316 may be executed by the winning determination module 310.

The game counter module 306 sets the number of free games in accordance with the winning combination at the winning determination module 310 and manages the number of free games by decrementing the free game counter 324 by one when a free game is conducted. If a predetermined winning combination is made in a free game mode, the game counter module 306 adds a value corresponding to the winning combination to the free game counter 324 storing the number of remaining free games. The value of the free game counter 324 is stored in the RAM 226. The game counter module 306 may be configured to belong to the symbol determination module 304.

It should be noted that, the input/credit check module 300 may be an independent input/credit check device 300; the random number generation module 302 may be an independent random number generation device 302; the symbol determination module 304 may be an independent symbol determination device 304; the game counter module 306 may be an independent game counter device 306; the reel control module 308 may be an independent reel control device 308; the winning determination module 310 may be an independent winning determination device 310; the effect control module 312 may be an independent effect control device 312; the payout module 314 may be an independent payout device 314; and the game mode determination module 316 may be an independent game mode determination device 316′. In this way, the game program can be configured as an aggregate of independent devices. Some of these devices may be integrated into one device. In any case, these devices may be processing, components, devices, or units as far as they can execute the game program.

### <Payline>

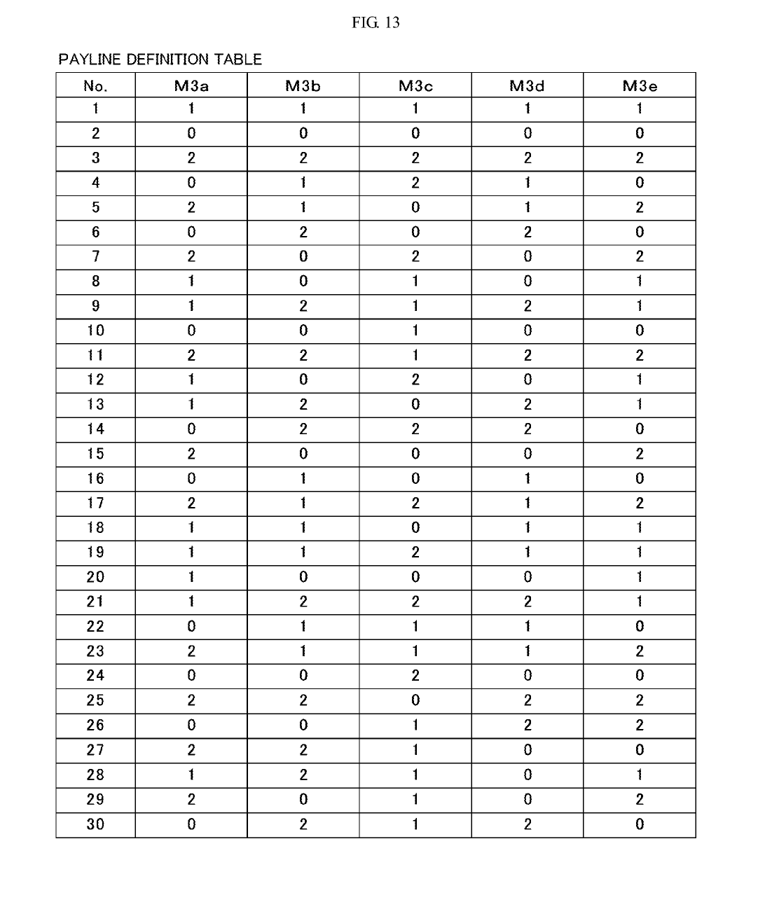

FIG. 13 is a view illustrating an example of a payline definition table defining paylines employed in the gaming machine 10. In the gaming machine 10, thirty paylines are defined within a symbol matrix. The payline definition table defines paylines each formed by connecting one of the top row, the middle row, and the bottom row in the display window 150 from the first to the fifth reels M3a to M3e.

For example, the payline definition table indicates that a payline (Payline No.=1) is formed of the middle row of the first reel M3a (the first column), the middle row of the second reel M3b (the second column), the middle row of the third reel M3c (the third column), the middle row of the fourth reel M3d (the fourth column), and the middle row of the fifth reel M3e (the fifth column).

In the gaming machine 10 of the present embodiment, all of the thirty paylines are active regardless of the amount of bet or the player's choice. However, the paylines may be separately activated in accordance with the player's choice. The total number of paylines can be determined as appropriate depending on the size of the symbol matrix.

### <Symbol Determination Table>

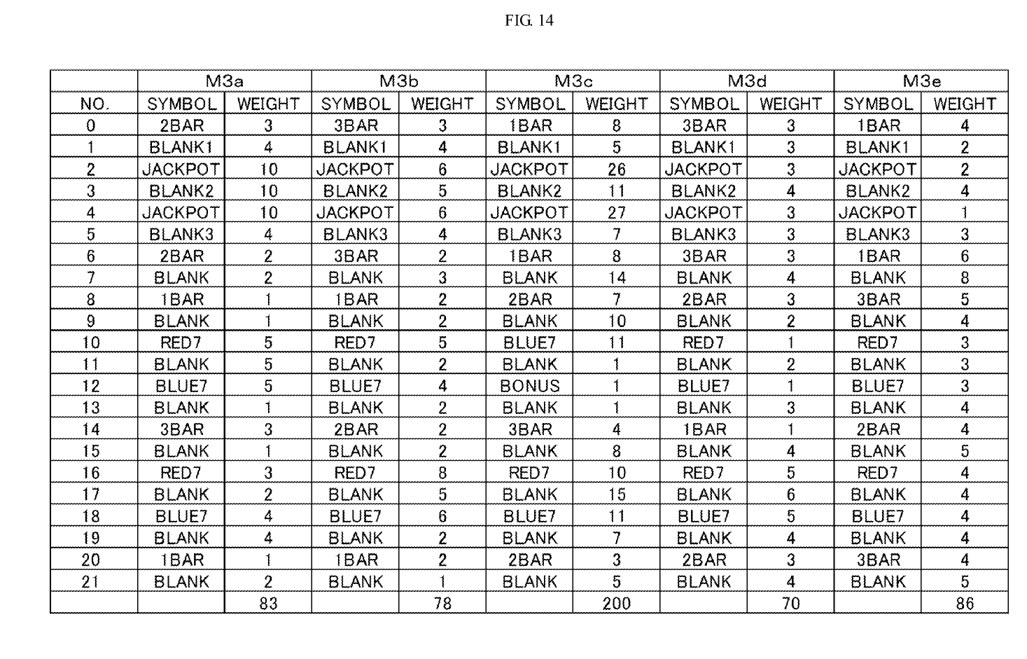

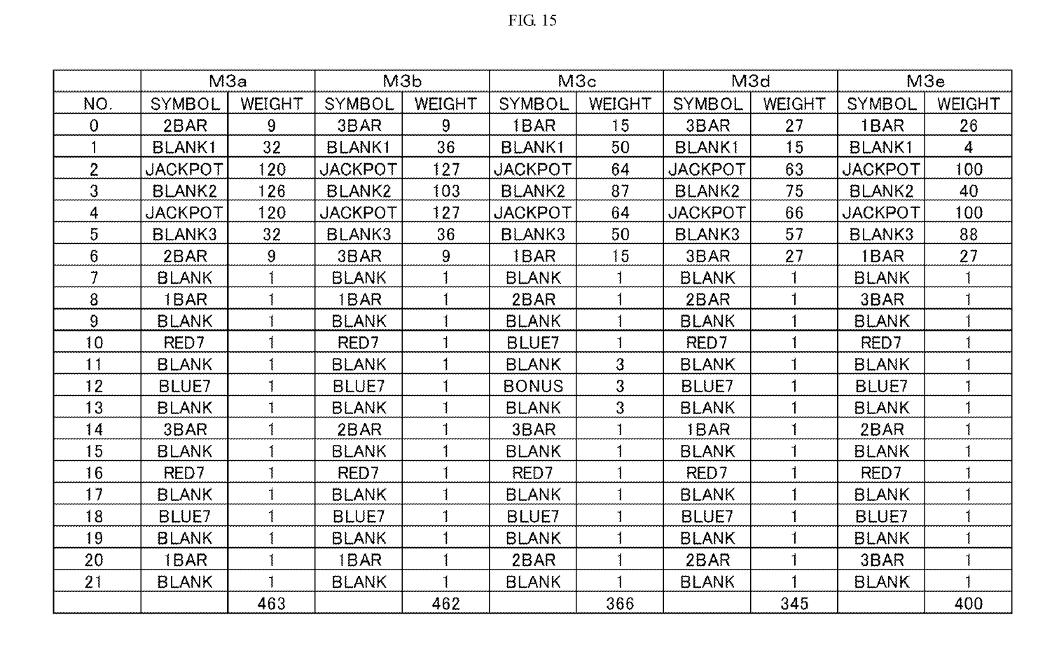

FIGS. 14 and 15 are views illustrating examples of symbol determination tables. FIG. 14 indicates weights in the base game mode and FIG. 15 indicates weights in the free game mode.

Each symbol determination table is a table defining symbols arrayed on the individual reels M3a to M3e and weights (appearance probabilities) determined for the symbols. The symbol determination table defines the probabilities for the symbols on the reels M3a to M3e to appear on the middle row of the symbol matrix (the middle row in the display window 150).

The symbol determination table defines the appearance probabilities of the symbols. For example, the 2BAR specified as code No. 0 of the first reel M3a has a weight of “3” and the appearance probability is 3/83 (the value 83 on the bottom row is the total sum of the weights indicated for convenience; this row is not requisite for the configuration of the symbol determination table).

In symbol lottery processing to be described later, five random numbers are extracted. The symbol determination table in FIG. 14 or 15 is referred to with the extracted random values to determine five symbols for the reels M3a to M3e. The reels M3a to M3e are controlled to stop so that the determined five symbols will be positioned on the middle row of the symbol matrix.

As illustrated in FIGS. 14 and 15, the weights in the free game mode are defined so that the JACKPOTs of No. 2, the BLANKs of No. 3, and the JACKPOTs of No. 4 will be drawn at higher probabilities compared to the weights in the base game mode. Accordingly, the JACKPOTs of No. 2, the BLANKs of No. 3, and the JACKPOTs of No. 4 are more likely to stop on the middle row of the symbol matrix in a unit game in a free game mode.

A BONUS is provided only at No. 12 of the reel M3c. As mentioned above, when the BONUS appears on any of the top row, middle row, and bottom row of the display window 150, a free game trigger is completed. That is to say, if symbol lottery processing draws any one of No. 11, No. 12, and No. 13 for the reel M3c, a free game trigger is completed.

JACKPOTs are provided at No. 2 and No. 4 on each of the five reels M3a to M3e. The JACKPOTs are also scatter symbols; ten JACKPOTs can appear in the display window 150 at maximum.

### <Payout Table>

FIG. 16 is a view illustrating an example of a payout table. The payout table in FIG. 16 defines winning patterns of nine kinds of symbols.

The payout table indicates relations among the kind of the symbols constituting the winning pattern, the Kind number, and the payout. The Kind number equals the number of constituent symbols of the winning pattern that are successively arranged from the left to the right along the payline. As mentioned above, the gaming machine 10 of the present embodiment determines a win or a loss on a left-to-right basis except for the scatter symbols of JACKPOT and BONUS. Accordingly, the amount of payout is determined depending on the kind and the number of symbols successively arranged along a payline, starting from the leftmost reel M3a toward the rightmost reel M3e.

The first winning patterns are patterns where three, four, and five RED7s are successively arranged along a payline. The second winning patterns are patterns where three, four, and five BLUE7s are successively arranged along a payline.

Taking examples of the first winning patterns, when RED7 symbols are successively arranged along a payline in the pattern of RED7-RED7-RED7 from the leftmost reel M3a, the Kind number is 3 and the payout is 50. When RED7 symbols are successively arranged along a payline in the pattern of RED7-RED7-RED7-RED7 from the leftmost reel M3a, the Kind number is 4 and the payout is 100. When RED7 symbols are successively arranged along a payline in the pattern of RED7-RED7-RED7-RED7-RED7 from the leftmost reel M3a, the Kind number is 5 and the payout is 500.

The third winning patterns are based on ANY7. The winning patterns of ANY7 are patterns of two kinds of symbols RED7s and BLUE7s mixed and arranged along a payline or two kinds of symbols of BLUE7s and RED7s mixed and arranged along a payline. The third winning patterns are patterns where three, four, and five symbols satisfying the condition of ANY7 are successively arranged along a payline.

The fourth winning patterns are patterns where three, four, and five 3BARs are successively arranged along a payline. The fifth winning patterns are patterns where three, four, and five 2BARs are successively arranged along a payline. The sixth winning patterns are patterns where three, four, and five 1BARs are successively arranged along a payline.

The seventh winning patterns are based on ANYBAR. The winning patterns of ANYBAR are patterns of three kinds of symbols 3BARs, 2BARs, and 1BARs mixed and arranged along a payline, three kinds of symbols 2BARs, 3BARs, and 1BARs mixed and arranged along a payline, or three kinds of symbols 1BARs, 3BARs, and 2BARs mixed and arranged along a payline. The seventh winning patterns are patterns where three, four, and five symbols satisfying the condition of ANYBAR are successively arranged along a payline.

The eighth winning pattern is based on the BONUS. The ninth winning patterns are based on JACKPOTs. The BONUS and the JACKPOTs are scatter symbols. Accordingly, the amount of payout is determined depending on only the number of symbols shown in the display window 150, regardless of the payline.

As mentioned above, the BONUS is provided only at No. 12 of the reel M3c. When this one BONUS appears, the payout is 30. The eighth winning pattern is a pattern where the payout is 30 when the BONUS on the reel M3c appears at the top, middle, or bottom row of the display window 150.

The JACKPOT is also a scatter symbol. When four JACKPOTs appear in the display window 150, the payout is 40. When five JACKPOTs appear in the display window 150, the payout is 100. When six JACKPOTs appear in the display window 150, the payout is 500. When seven JACKPOTs appear in the display window 150, the payout is 1500. When eight JACKPOTs appear in the display window 150, the payout is 3000. When nine JACKPOTs appear in the display window 150, the payout is 10000. When ten JACKPOTs appear in the display window 150, the payout is 25000. The ninth winning patterns are these patterns of JACKPOTs.

When four or more JACKPOTs appear, a payout for the number of JACKPOTs in the display window 150 is determined to be a normal payout (fixed payout). The gaming machine 10 of the present embodiment further has a progressive jackpot feature. When six or more JACKPOTs are rearranged in the display window 150, winning a progressive jackpot is determined and the amount accumulated in the progressive jackpot is also provided as a jackpot payout in addition to the fixed payout.

In the gaming machine 10, the winning determination module 310 determines whether any winning pattern defined in the payout table is completed every time a unit game is conducted. When one of the winning patterns defined in the payout table is completed, the winning determination module 310 retrieves the payout associated with the Kind number with reference to the payout table. The winning determination module 310 further determines whether any winning pattern is completed with the BONUS or JACKPOTs and retrieves the payout associated with the Kind number.

The payout module 314 provides an award in the amount based on the retrieved payout. When the winning determination module 310 determines that no winning pattern is completed, the winning determination module 310 determines a so-called loss.

The award may be provided to the player by discharging coins to the coin tray 92 or adding credits corresponding to the amount of award.

Although FIG. 16 provides only one payout table, different payout tables may be defined for the base game mode and the free game mode.

### <State Transitions of Games>

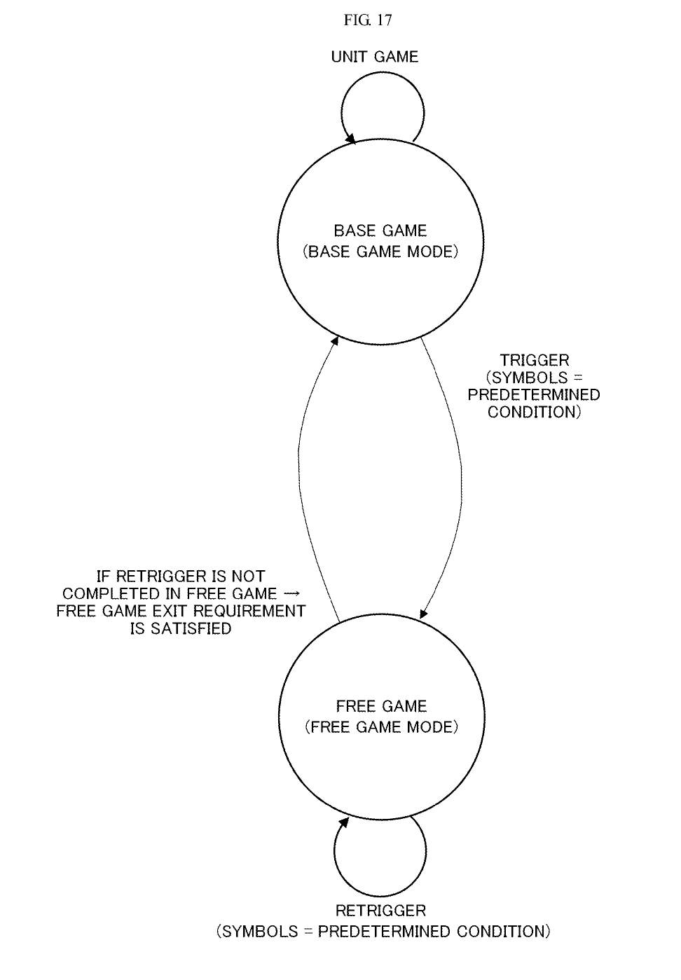

FIG. 17 is a diagram illustrating state transitions in the gaming machine 10. Specifically, FIG. 17 is a diagram illustrating transitions between the base game mode and the free game mode.

The gaming machine 10 has two kinds of game modes: a base game mode and a free game mode. The gaming machine 10 offers unit games basically in the base game mode. When a free game trigger (event) occurs in the base game mode, the game mode changes to the free game mode.

In the present embodiment, the free game trigger is a condition where the BONUS symbol appears in the display window 150 of the symbol display unit 40. The free game trigger can be a different condition.

As illustrated in FIG. 17, unit games in the base game mode are repeated until the BONUS appears in the display window 150 of the symbol display unit 40. In this base game mode, when one of the winning patterns illustrated in FIG. 16 is completed, an award in the amount according to the payout table is provided for the winning pattern.

When a free game trigger occurs in the base game mode, the game mode changes to the free game mode. The free game mode in the gaming machine 10 of the present embodiment provides one unit game. Basically, after conducting one unit game, the game mode returns from the free game mode to the base game mode.

A free game is a unit game which is the same game as a base game but does not require spending game media such as medals. The free game mode is specified so that the JACKPOT of No. 2, the BLANK of No. 3, and the JACKPOT of No. 4 on each of the five reels M3a to M3e are more likely to be drawn as illustrated in FIG. 15.

When a retrigger occurs in the free game mode, one unit game in the free game mode is added. Accordingly, only if a retrigger occurs, the free game mode is maintained; if no retrigger occurs, the game mode returns from the free game mode to the base game mode.

As understood from the above, the gaming machine 10 of the present embodiment provides only one unit game when the game mode is changed from the base game mode to the free game mode; there is no arrangement to provide different numbers of free games depending on the result of a unit game in the base game mode. Only when a retrigger occurs after entering the free game mode, one unit game is added. Whether to add a unit game is determined after entering the free game mode.

### <Structure of Reel Strip>

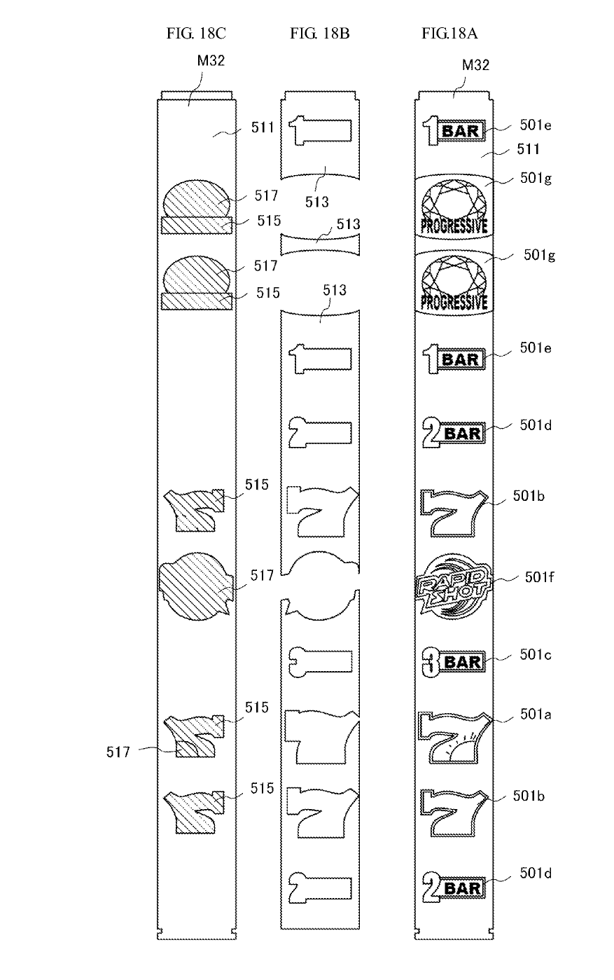

FIGS. 18A to 18C provide diagrams illustrating a structure of a reel strip M32. The reel strip M32 illustrated in FIGS. 18A to 18C is a reel strip to be used for the reel M3c. FIG. 18A is front view showing the right face of the reel strip M32, FIG. 18B is a front view showing one side of a hologram sheet, and FIG. 18C is a front view showing the back face of the reel strip M32.

On the reel strip M32 used for the reel M3c, RED7s 501a, BLUE7s 501b, 3BARs 501c, 2BARs 501d, 1BARs 501e, a BONUS 501f, JACKPOTs 501g are disposed, as shown in FIGS. 18A to 18C.

Each RED7 501a is a symbol formed of a red-colored number 7. Each BLUE7 501b is a symbol formed of a green-colored number 7. Each 3BAR 501c is a symbol formed of a number 3 and letters BAR; each 2BAR 501d is a symbol formed of a number 2 and letters BAR; each 1BAR 501e is a symbol formed of a number 1 and letters BAR; and the BONUS 501f is a symbol formed of letters RAPID SHOT and a circular figure. Each JACKPOT symbol 501g is a symbol mainly formed of letters PROGRESSIVE and a picture of a diamond.

Between two adjacent symbols of these RED7s 501a, BLUE7s 501b, 3BARs 501c, 2BARs 501d, 1BARs 501e, BONUS 501f, and JACKPOTs 501g, at least one BLANK is disposed.

The normal symbols such as the RED7s 501a, BLUE7s 501b, 3BARs 501c, 2BARs 501d, 1BARs 501e, BONUS 501f, and JACKPOTs 501g are symbols that can be a constituent of the winning patterns illustrated in FIG. 16.

The BLANK is a symbol that cannot be a constituent of the winning patterns. The BLANK is in a single color and does not include any picture inclusive of patterns. The BLANK may include a picture of decorative patterns if most of the area is single-colored or if the picture is so pale to look like a single-colored area.

The reel strip M32 includes a surface sheet 511, a hologram sheet 513, a light diffusion sheet 515, and a light diffusion sheet 517.

The surface sheet 511 is a transparent, flexible, and long strip-shaped sheet. For example, the surface sheet 511 is preferably made of a PET (polyethylene terephthalate) film.

The hologram sheet 513 is a single-colored, for example green-colored, sheet. For the hologram sheet 513, Sparkle fluorescent sheet, green, manufactured by Sun Grace Co., Ltd. may be used. The hologram sheet 513 is mainly used to show the BLANKs and is preferred to be in a single color. The light diffusion sheet 515 diffuses the light emitted from the backlight unit M7 and incident on the light diffusion sheet 515 in separate colors.

The light diffusion sheet 515 is preferably made of a soft PVC (polyvinyl chloride) film. For the light diffusion sheet 515, an effect sheet (for example, Sparkle made of soft PVC, manufactured by Three Like Co., Ltd.) may be used. The light diffusion sheet 515 forms the RED7s 501a, the BLUE7s 501b, and the parts of the letters PROGRESSIVE of the JACKPOTs 501g.

The light diffusion sheet 515 has a rough surface. Tiny projections and indentations having specific shapes form the rough surface. The projections and indentations are formed randomly. Each projection functions as a tiny convex lens. Each indentation functions as a tiny concave lens. These randomly formed projections and indentations diffuse the light emitted from the backlight unit M7 and incident on the light diffusion sheet 515.

The light diffusion sheet 517 is preferably made of a soft PVC (polyvinyl chloride) film. For the light diffusion sheet 517, an effect sheet (for example, Lens manufactured by Three Like Co., Ltd.) may be used. The light diffusion sheet 517 forms the BONUS symbol 501f and the parts of the picture of a diamond of the JACKPOTs 501g.

The light diffusion sheet 517 has a rough surface. Tiny projections and indentations having specific shapes form the rough surface. The projections and indentations are formed regularly. Each projection functions as a tiny convex lens. Each indentation functions as a tiny concave lens. These regularly formed projections and indentations diffuse the light emitted from the backlight unit M7 and incident on the light diffusion sheet 517.

The hologram sheet 513 has openings having the shapes of the symbols of RED7s 501a, BLUE7s 501b, 3BARs 501c, 2BARs 501d, 1BARs 501e, BONUS 501f, and JACKPOTs 501g. The symbols of RED7s 501a, BLUE7s 501b, 3BARs 501c, 2BARs 501d, 1BARs 501e, BONUS 501f, and JACKPOTs 501g are fit in the openings in the hologram sheet 513 and pasted.

### <Disposition of JACKPOT>

FIG. 19 illustrates a disposition of JACKPOTs on a reel strip M32. Two JACKPOTs are disposed across a BLANK (blank symbol). As illustrated in FIGS. 14 and 15, JACKPOTs are provided at code Nos. 2 and 4 and BLANKs are provided at code No. 3 on all the five reels M3a to M3e. Accordingly, on all of the five reels M3a to M3e, two JACKPOTs are disposed across a BLANK.

A BLANK is formed in a blank area A or A′ surrounded by a dashed line in FIG. 19. A JACKPOT (PROGRESSIVE) is formed in a symbol area B surrounded by a thick dashed line in FIG. 19.

As indicated by a dashed line in FIG. 19, each blank area A has a rectangular shape having a length of 18.7 mm along the longitudinal direction of the reel M3 (reel strip M32) and a width equal to the width of the reel M3 along the lateral direction of the reel M3. This rectangular area is a blank area. As mentioned above, BLANKs are symbols not to be a constituent of a winning pattern and are placed between normal symbols adjacent to each other to function as boundaries or separators of the normal symbols.

As indicated by a thick dashed line in FIG. 19, each symbol area B has a rectangular shape having a length of 60 mm along the longitudinal direction of the reel M3 (reel strip M32) and a width equal to the width of the reel M3 along the lateral direction of the reel M3. This rectangular area is a symbol area.

As illustrated in FIG. 19, a JACKPOT (symbol 501g) includes a letters PROGRESSIVE 521 and a picture of a diamond 523. The letters PROGRESSIVE 521 and the picture of a diamond 523 are both provided inside a symbol area surrounded by a thick dashed line B.

Around the letters PROGRESSIVE 521 and the picture of a diamond 523, a background part 525 is provided. The background part 525 has a first straight part 531a and a second straight part 531b opposed to each other and a first curve part 533a and a second curve part 533b opposed to each other.

The first straight part 531a and the second straight part 531b are straight lines parallel to each other and provided along the longitudinal direction of the reel strip M32. The first straight part 531a and the second straight part 531b each have a top end and a bottom end. The first straight part 531a is provided on and along the left end of the reel strip M32. The second straight part 531b is provided on and along the right end of the reel strip M32. Accordingly, the width of the background part 525 is the same as the width of the reel strip M32.

The first straight part 531a and the second straight part 531b are provided inside the symbol area. Accordingly, the lengths of the first straight part 531a and the second straight part 531b are shorter than the length of the symbol area in the reel strip M32 (the length of the symbol area in the longitudinal direction). Accordingly, on the left end and the right end of the reel strip M32, the background part 525 is provided inside the symbol area.

The first curve part 533a and the second curve part 533b have arc shapes and bend outward to be away from each other. The first curve part 533a and the second curve part 533b each have a left end and a right end. The right end of the first curve part 533a is joined to the top end of the second straight part 531b and the left end of the first curve part 533a is joined to the top end of the first straight part 531a. The right end of the second curve part 533b is joined to the bottom end of the second straight part 531b and the left end of the second curve part 533b is joined to the bottom end of the first straight part 531a.

The middle of the first curve part 533a is swelling (or protruding) toward the blank area adjacent to and above the symbol area. The middle of the second curve part 533b is swelling (or protruding) toward the blank area adjacent to and under the symbol area.

Accordingly, the middle of the first curve part 533a and the middle of the second curve part 533b are located in blank areas. In this way, parts of the background part 525 (the first straight part 531a and the second straight part 531b) are provided inside the symbol area and the middle of the first curve part 533a and the middle of the second curve part 533b are provided in blank areas. The background part 525 is not an area where a symbol is provided but an area functioning as a background surrounding the symbol. As mentioned above, the both of the letters PROGRESSIVE 521 and the picture of a diamond 523 (the JACKPOT (symbol 501g)) are provided inside the symbol area surrounded by the thick dashed line B.

Providing the background part 525 surrounding the JACKPOT (symbol 501g) can form an area expanding into blank areas, so that the JACKPOT (symbol 501g) can be made distinct.

As mentioned above, the symbols of a gaming machine are categorized into blank symbols of BLANKs and non-blank symbols of normal symbols. Non-blank symbols are symbols that can be a constituent of a winning pattern, namely winning element symbols. Blank symbols are symbols that will not be a constituent of a winning pattern.

These blank symbols and non-blank symbols are limited in size and location. For example, in the case where a physical reel strip having a length L has N physical stop positions, the space of each blank symbol must be sized at least (L/N)×0.4. Furthermore, each blank symbol must be completely away from both of the adjacent symbols. Still further, non-blank symbols and blank symbols must be located at the center of the area assigned thereto. In manufacturing a gaming machine, symbols have to be disposed on a reel strip for the gaming machine to satisfy these requirements.

The foregoing requirements can be satisfied by placing both of the letters PROGRESSIVE 521 and the picture of a diamond 523 inside a symbol area and providing an area expanding into blank areas to the background part 525 surrounding the JACKPOT (symbol 501g).

As described above, two symbol areas are disposed across a blank area. The blank area A′ in FIG. 19 located between two symbol areas is defined by the second curve part 533b of the upper symbol area and the first curve part 533a of the lower symbol area as indicated by a dashed line. In the blank area A′, the second curve part 533b of the upper symbol area and the first curve part 533a of the lower symbol area are formed distant at the both ends and closer at the middle.

Although the above-described example provides a large picture of a diamond 523 in the symbol area, it is preferable that, instead of enlarging the symbol itself, the background part 525 be enlarged to show a specific symbol as if the symbol were enlarged. Enlarging the background part 525 leads the symbol to be distinct so that the player can speedily and easily see whether any winning pattern is made.

### <<Contents of Program>>

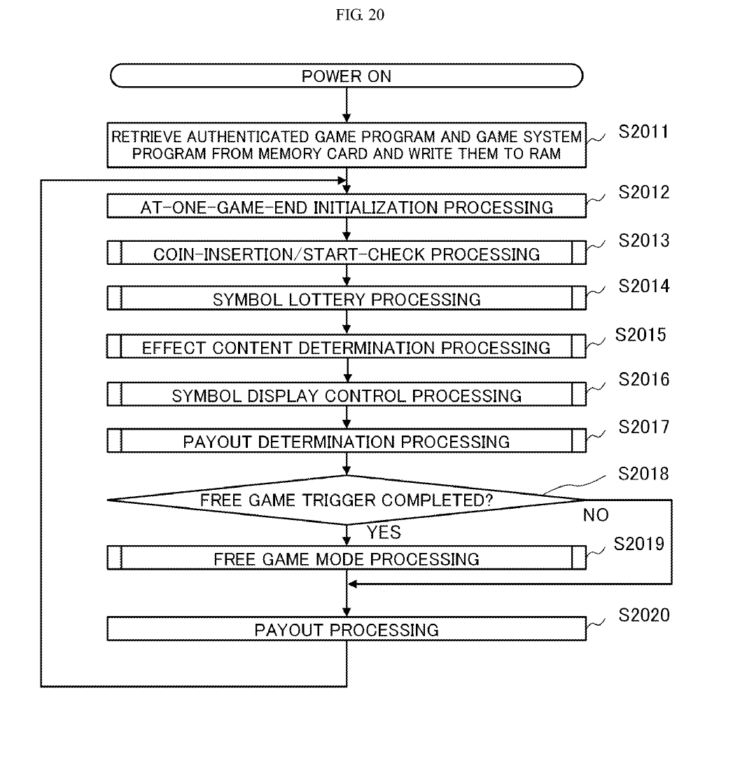

Next, with reference to FIGS. 20 to 28, the program to be executed by the gaming machine 10 is described.

### <Main Control Processing>

Now, with reference to FIG. 20, main control processing is described. FIG. 20 is a flowchart illustrating main control processing for the gaming machine 10 according to the embodiment of the present invention. The game mode in this main control in FIG. 20 is the base game mode.

First, when the power is supplied to the gaming machine 10, the main CPU 222 retrieves the authenticated game program and game system program from the memory card 210 through the gaming board 200, and writes the programs into the RAM 226 (step S2011).

Next, the main CPU 222 conducts at-one-game-end initialization processing (step S2012). For example, the main CPU 222 clears data that becomes unnecessary after each game in the working areas of the RAM 226, such as the bet count and the symbols determined by lottery.

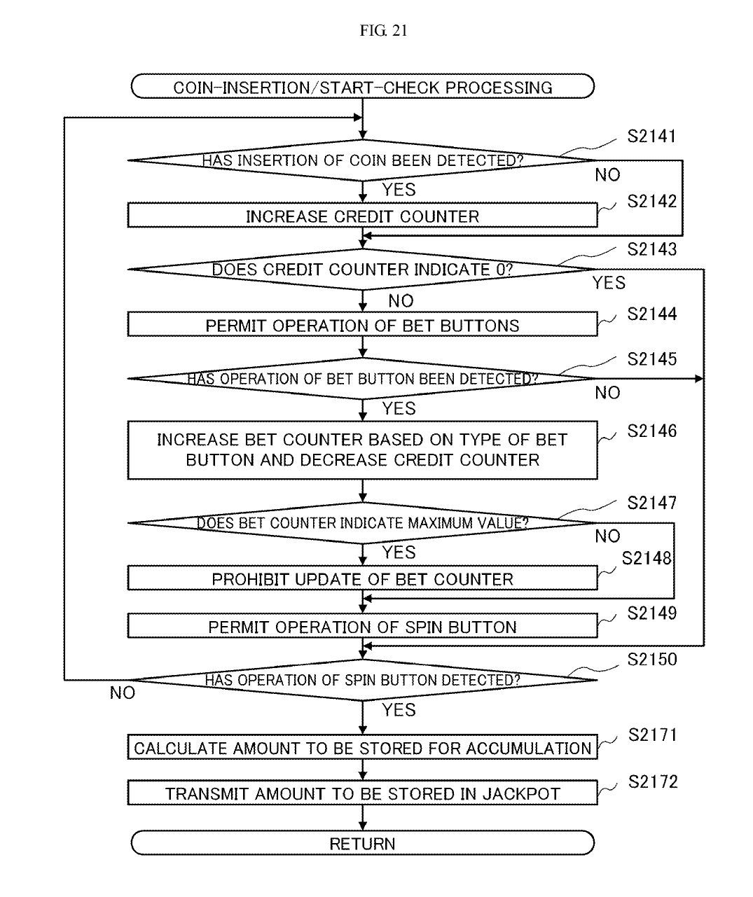

The main CPU 222 performs coin-insertion/start check processing which is described later with reference to FIG. 21 (step S2013). In the processing, whether input from any of the BET buttons and the spin button has been detected is checked.

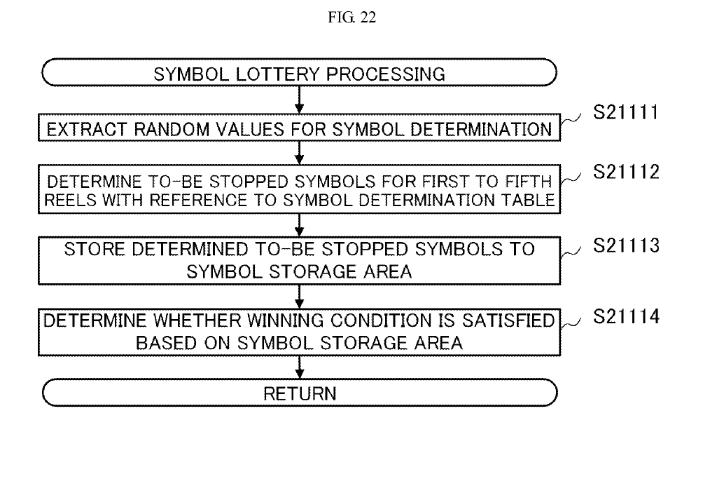

The main CPU 222 then conducts symbol lottery processing which is described later with reference to FIG. 22 (step S2014). In the processing, to-be stopped symbols are determined based on the random values for symbol determination and if a free game trigger is completed, the value for the BONUS symbol is further determined.

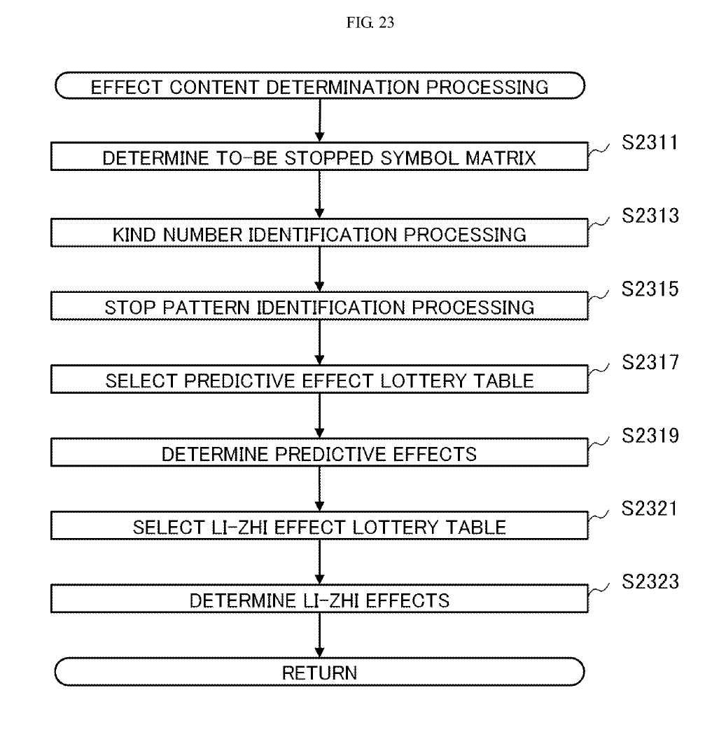

Next, the effect control module 312 executed by the main CPU 222 conducts effect content determination processing which is described later with reference to FIG. 23 (step S2015). The main CPU 222 extracts a random value for effects, and determines any of the effect contents from the preset plurality of effect contents by lottery, and executes the determined effect contents with a predetermined timing. For example, the effect control module 312 displays a video for presentation effects on the video display unit 110, outputs sounds from the speakers 112, lights up the lamp 114, and applies effects to the video, sounds, and illumination. If a free game trigger is completed, and if the player selects to play a free game, further effects such as a video played on the video display unit 110 are provided. The details thereof will be described later.

The main CPU 222 then conducts symbol display control processing which is described later with reference to FIG. 24 (step S2016). In the processing, scroll of the symbol array of each reel is started, and the to-be stopped symbol determined in the symbol lottery processing of step S2014 is stopped at a predetermined position. Furthermore, illumination control for each reel is performed based on the value of the BONUS symbol determined in the symbol lottery processing of step S2014.

Next, the main CPU 222 conducts payout determination processing which is described later with reference to FIG. 25 (step S2017). In the processing, the amount of payout is determined for the combination of symbols displayed along the payline in accordance with the payout table (see FIG. 16), and is stored into a payout storage area (payout counter) provided in the RAM 226. If a free game trigger is completed, the amount of payout is determined in accordance with a rule different from the rule for a base game, depending on the combination of the BONUS symbol.

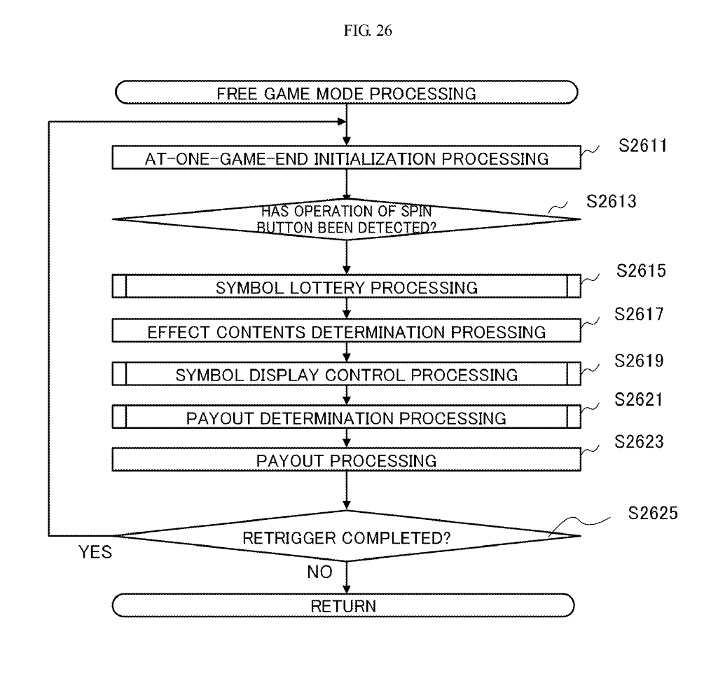

The main CPU 222 then determines whether or not a free game trigger has been completed (step S2018). When the main CPU 222 determines that a free game trigger has been completed (for example, if the game mode is the base game mode, the main CPU 222 determines that a free game trigger has been completed), the main CPU 222 conducts free game mode processing which is described later with reference to FIG. 26 (step S2019).

After the processing of step S2019 or when determining in step S2018 that a free game trigger is not completed, the main CPU 222 conducts payout processing (step S2020). The main CPU 222 adds the value stored in the payout storage area (payout counter) to a value stored in a credit storage area (credit counter 320) provided in the RAM 226. It is to be noted that operations of the hopper 242 may be controlled so that coins corresponding to the value stored in the payout counter will be discharged from the coin payout exit. Alternatively, operations of the ticket printer 120 may be controlled and a ticket with a barcode may be issued on which a value stored in the payout counter is recorded. After the processing has been conducted, the processing is shifted to step S2012 after clearing the mode flag, the BONUS symbol value storage area, and the like.

### <Coin-Insertion/Start Check Processing>

Next, with reference to FIG. 21, coin-insertion/start check processing is described. FIG. 21 is a flowchart of the coin-insertion/start check processing for the gaming machine 10 according to the embodiment of the present invention.

First, the input/credit check module 300 executed by the main CPU 222 determines whether or not insertion of a coin has been detected by the coin counter 232 (step S2141). When the main CPU 222 determines that the insertion of a coin has been detected, the main CPU 222 adds the value of the inserted coin to the value stored in the credit storage area (credit counter 320) (step S2142). It is to be noted that, in addition to the insertion of a coin, the main CPU 222 may determine whether or not insertion of a bill has been detected with the bill validator 246, and when determining that the insertion of a bill has been detected, the main CPU 222 may add a value corresponding to the amount of bill to the value stored in the credit counter 320.

After step S2142 or when determining in step S2141 that the insertion of a coin has not been detected, the main CPU 222 determines whether or not the credit counter 320 indicates zero (step S2143). When the main CPU 222 determines that the credit counter indicates a non-zero value, the main CPU 222 permits operation of the BET buttons (step S2144).

Next, the main CPU 222 determines whether or not operation of any of the BET buttons has been detected (step S2145). When the main CPU 222 detects press of a BET button by the player with a BET switch, the main CPU 222 makes an addition to a value stored in a bet storage area (the bet counter) provided in the RAM 226 and makes a subtraction in the credit counter 320, based on the type of the BET button (step S2146).

The main CPU 222 then determines whether or not the bet counter indicates a maximum value (step S2147). When the main CPU 222 determines that the BET counter indicates the maximum value, the main CPU 222 prohibits updating the bet counter (step S2148). After step S2148 or when determining in step S2147 that the bet counter does not indicate a maximum value, the main CPU 222 permits operation of the spin button (step S2149).

After step S2149, when determining in step S2145 that the operation of any of the BET buttons has not been detected, or when determining in step S2143 that the credit counter 320 indicates zero, the main CPU 222 determines whether or not operation of the spin button has been detected (step S2150). When the main CPU 222 determines that the operation of the spin button has not been detected, the processing is shifted to step S2141.

When the main CPU 222 determines that the operation of the spin button has been detected, the main CPU 222 calculates the amount to be stored for accumulation (step S2171). The main CPU 222 calculates the amount to be stored to the amount of the progressive jackpot by obtaining a product of the value stored in the BET counter by a predetermined rate for accumulation.

Next, the main CPU 222 transmits the calculated amount to be stored to the external control device 190 (Step S2172) and exits the coin-insertion/start check processing. Upon receipt of the amount to be stored, the external control device 190 updates the amount of the progressive jackpot.

### <Symbol Lottery Processing>

Next, with reference to FIG. 22, symbol lottery processing is described. FIG. 22 is a flowchart of the symbol lottery processing for the gaming machine 10 according to the embodiment of the present invention.

First, the random number generation module 302 executed by the main CPU 222 extracts five random values for symbol determination (step S2211). The main CPU 222 then determines to-be stopped symbols for the individual reels by lottery with the five random values (step S2212).

When the game mode is the base game mode, the processing of step S2212 determines five to-be stopped symbols with reference to the symbol determination table for base game mode illustrated in FIG. 14. When the game mode is the free game mode, the processing of step S2212 determines five to-be stopped symbols with reference to the symbol determination table for free game mode illustrated in FIG. 15.

That is to say, the main CPU 222 extracts five random values for symbol determination, and determines one symbol out of 22 symbols (code Nos. 0 to 21) as a to-be stopped symbol for each of the five reels M3a to M3e with reference to the symbol determination table in FIG. 14 or 15.

The appearance probabilities of the 22 symbols (code Nos. 0 to 21) depend on the weights in the symbol determination table in FIG. 14 or 15. Accordingly, the appearance probabilities of the 22 symbols (code Nos. 0 to 21) can be different depending on whether the game mode is the base game mode or the free game mode.

The processing of step S2212 determines five to-be stopped symbols for the five reels M3a to M3e. Each of the five reels M3a to M3e is controlled to be stopped so that the determined to-be stopped symbol stops on the middle row of the symbol matrix (the middle row of the display window 150).

The main CPU 222 then stores the determined to-be stopped symbols for the individual reels into a symbol storage area provided in the RAM 226 (step S2213). Next, the winning determination module 310 executed by the main CPU 222 references the payout table in FIG. 16 and determines whether any winning pattern is completed based on the symbols stored in the symbol storage area (step S2214). If any winning pattern is made, the main CPU 222 determines a payout in accordance with the Kind number.

### <Effect Content Determination Processing>

Next, with reference to FIG. 23, effect content determination processing is described. FIG. 23 is a flowchart of the effect content determination processing for the gaming machine 10 according to the embodiment of the present invention.

This processing is to determine motion of the five reels M3a to M3 from the start to stop of spin and is to determine effects of motion of the five reels M3a to M3e. Accordingly, this effect content determination processing is performed based on the result of the symbol lottery processing of step S2014 in FIG. 20.

Specifically, five to-be stopped symbols are first determined for the five reels M3a to M3e through the symbol lottery processing of step S2014 in FIG. 20. Next, with reference to the symbol determination table in FIG. 14 or 15, a symbol matrix composed of the symbols to be rearranged in the display window 150 is determined based on the determined five to-be stopped symbols. That is to say, all the fifteen symbols (a to-be stopped symbol matrix) to be rearranged in the display window 150 can be determined using the five to-be stopped symbols.

In this connection, a symbol matrix composed of the symbols rearranged in the display window 150 when all the five reels M3a to M3e are actually stopped is simply referred to as symbol matrix or stopped symbol matrix.

In the present embodiment, the symbols arrayed on the five reels M3a to M3e are common to the base game mode and the free game mode; accordingly, a to-be stopped symbol matrix can be determined regardless of the game mode by referring to the symbol determination table in FIG. 14 or 15.

Determining a to-be stopped symbol matrix leads to determination of the number of JACKPOTs included in the to-be stopped symbol matrix and the positional pattern of the JACKPOTs.

First, the main CPU 222 determines a to-be stopped symbol matrix using the five to-be stopped symbols determined by the symbol lottery processing of step S2014 in FIG. 20 (step S2311). The determined to-be stopped symbol matrix is stored in the RAM 226. Specifically, the code numbers of the fifteen symbols constituting the to-be stopped symbol matrix are stored in the RAM 226.

Next, the main CPU 222 performs Kind number identification processing (step S2313). As will be described later with reference to FIG. 27, the Kind number identification processing determines one of the first identifiers of I to VIII.

Next, the main CPU 222 performs stop pattern identification processing (step S2315). As will be described later with reference to FIG. 28, the stop pattern identification processing determines one of the second identifiers of Table A to Table R with reference to tables defining stop patterns illustrated in FIGS. 29A to 37.

Next, the main CPU 222 selects a predictive effect lottery table (step S2317). This processing selects a predictive effect lottery table from the predictive effect lottery tables illustrated in FIGS. 38A to 45B based on the first identifier determined in the processing of step S2313 and the second identifier determined in the processing of step S2315.

Next, the main CPU 222 determines predictive effects by lottery using the predictive effect lottery table selected in the processing of step S2317 (step S2319). The predictive effects are produced by motion of the five reels M3a to M3e from start of spinning of the five reels M3a to M3e until an intermediate state where at least one reel stops and the remaining reels keep spinning.

Each predictive effect lottery table defines weights for a plurality of kinds of predictive effects. The processing of step S2319 generates a random number and determines one kind of predictive effects from a plurality of kinds of predictive effects by referring to the selected predictive effect lottery table with the value of the generated random number. Accordingly, even if the Kind number and the stop pattern are the same, different predictive effects can be selected to provide various predictive effects.

The predictive effect lottery tables are defined for each of the base game mode and the free game mode to provide predictive effects differently depending on the game mode.

As understood from the above, predictive effects from start of spinning of the reels until an intermediate state can be determined with the number and the positional pattern of JACKPOTs. Determining predictive effects leads to determination of the direction, speed, and time of spinning of the five reels M3a to M3e and other motion in the spinning.

For each kind of predictive effects, motor control parameters for controlling the motors to drive the five reels M3a to M3e are specified and stored in the RAM 226 in advance. When a kind of predictive effects is determined, the main CPU 222 retrieves the corresponding motor control parameters and controls the motors to provide the effects with the five reels M3a to M3e.

Next, the main CPU 222 selects a li-zhi effect lottery table (step S2321). This processing selects a li-zhi effect lottery table based on the kind number and stop pattern of JACKPOTs and the number of stopped reels in the determined predictive effects. The li-zhi effect lottery table determination processing selects one of the li-zhi effect lottery tables illustrated in FIGS. 46A-1 to 53B-2.

In general, “li-zhi” is a state where a winning pattern is partially made with the symbols on a part of the plurality of reels when the part of the plurality of reels are stopped and the remaining reels are spinning but whether the winning pattern is finally completed depends on the symbols to appear when the spinning reels are stopped. That is to say, the li-zhi state can be defined as the last phase of the winning pattern undetermined state where a winning pattern is partially made but is not complete before determination whether a winning pattern is completed becomes available.

Instead of the winning pattern undetermined state, the li-zhi state in the present embodiment can be also defined as a payout undetermined state where the final payout is not determined. Specifically, the payout undetermined state is a state where a part of the plurality of reels are stopped and the remaining reels are spinning and a winning pattern to provide a payout is partially made with the symbols on the stopped reel but whether the payout is finally provided is determined by the symbols to appear when the spinning reels are stopped.

Accordingly, the li-zhi state may be either a state where a payout is provided or a state where a payout is not provided. In a usual li-zhi state, whether a payout is provided is undetermined; however, in a li-zhi state in the present embodiment, providing at least a part of a payout may be fixed. Even if providing some amount of payout is fixed in a li-zhi state, the final amount of payout is undetermined and is determined when all the reels are stopped.

For example, in the case where a payout is determined depending on the number of scatter symbols, if five scatter symbols are shown in a li-zhi state, a payout corresponding to the five scatter symbols is determined. If three more scatter symbols, or eight scatter symbols in total, are shown when all the reels are stopped, a payout corresponding to the total eight scatter symbols is determined. On the other hand, if no more scatter symbol, or five scatter symbols in total, are shown when all the reels are stopped, a payout corresponding to the five scatter symbols is determined. Like this example, a state where the final payout cannot be determined can be defined as li-zhi state even though providing a payout is determined before the final state is fixed. In this way, the present embodiment is configured to provide a first amount of benefit (such as a normal payout) in a li-zhi state and to further provide a second amount of benefit more than the first amount in the final state.

The present embodiment may be also configured to determine a normal payout in a li-zhi state and to further determine to provide a payout from the progressive jackpot by winning a jackpot in the final state. That is to say, a first kind of benefit (such as a normal payout) may be provided in a li-zhi state and a second kind of benefit (such as a payout from the progressive jackpot in response to winning a jackpot) may be provided in the final state.

Next, the main CPU 222 determines li-zhi effects by lottery using the li-zhi effect lottery table selected through the processing of step S2321 (step S2323) and exits this subroutine. The li-zhi effects are produced by motion of the reels from the intermediate state where at least one of the five reels M3a to M3e is stopped and the remaining reels keep spinning until all the five reels M3a to M3e are stopped.

Each li-zhi effect lottery table defines weights for a plurality of kinds of li-zhi effects. The processing of step S2323 generates a random number and determines one kind of li-zhi effects from the plurality of kinds of li-zhi effects by referring to the li-zhi effect lottery table with the value of the generated random number. Accordingly, even if the Kind number and stop pattern of JACKPOTs and the number of reels stopped in the predictive effects are the same, different li-zhi effects can be selected to provide various li-zhi effects.

The li-zhi effect lottery tables are defined for each of the base game mode and the free game mode to provide li-zhi effects differently depending on the game mode.

As understood from the above, li-zhi effects from the intermediate state of the reels until the reels are stopped can be determined with the number and the positional pattern of JACKPOTs in a to-be stopped symbol matrix and the number of reel stopped in the predictive effects. Like the predictive effects, determining li-zhi effects leads to determination of the direction, speed, and time of spinning of the five reels M3a to M3e and other motion in the spinning.

For each kind of li-zhi effects, motor control parameters for controlling the motors to drive the five reels M3a to M3e are specified and stored in the RAM 226 in advance. When a kind of li-zhi effects is determined, the main CPU 222 retrieves the corresponding motor control parameters and controls the motors to provide the effects with the five reels M3a to M3e.

### <Symbol Display Control Processing>

Next, with reference to FIG. 24, symbol display control processing is described. FIG. 24 is a flowchart of the symbol display control processing for the gaming machine 10 according to the embodiment of the present invention.

First, the reel control module 308 executed by the main CPU 222 spins the first to the fifth reels M3a to M3e in accordance with the predictive effects determined in the processing of S2319 in FIG. 23 (step S2411).

Specifically, the reel control module 308 sends a spin control signal to the reel assemblies M11 in accordance with the predictive effects determined in the processing of S2319 in FIG. 23. Next, the reel drivers 264 of the first to the fifth reels M3a to M3e supply the power to the reel motors 272 to spin the first to the fifth reels M3a to M3e. In accordance with this spin control, the first to the fifth reels M3a to M3e spin at a predetermined speed so that the symbol arrays attached on the first to the fifth reels M3a to M3e are scrolled in the display window 150 of the symbol display unit 40.

Next, the reel control module 308 executed by the main CPU 222 stops a part of the first to the fifth reels M3a to M3e specified by the predictive effects in accordance with the predictive effects determined in the processing of S2319 in FIG. 23 (step S2413).

Specifically, the spin control signal includes information on the stop positions of the first to the fifth reels M3a to M3e determined by the predictive effects. The reel drivers 264 of the first to the fifth reels M3a to M3e control the reel motors 272 to stop the part of the first to the fifth reels M3a to M3e specified by the predictive effects at the positions specified by the spin control signal.

In this way, the reel motors 272 made of stepping motors for the part of the reels specified by the predictive effects are stopped at desired positions to stop the scroll of the symbol arrays so that the to-be stopped symbols stop on the middle row of the symbol matrix formed in the display window 150.

Next, the reel control module 308 executed by the main CPU 222 spins the first to the fifth reels M3a to M3e in accordance with the li-zhi effects determined in the processing of S2323 in FIG. 23 (step S2415).

Specifically, the reel control module 308 sends a spin control signal to the reel assemblies M11 in accordance with the li-zhi effects determined in the processing of S2323 in FIG. 23. Next, the reel drivers 264 of the first to the fifth reels M3a to M3e supply the power to the reel motors 272 to spin the spinning reels excluding the stopped reels among the first to the fifth reels M3a to M3e. In accordance with this spin control, the spinning reels among the first to the fifth reels M3a to M3e spin at a predetermined speed so that the symbol arrays attached on those reels are scrolled in the display window 150 of the symbol display unit 40.

Next, the reel control module 308 executed by the main CPU 222 stops the spinning reels among the first to the fifth reels M3a to M3e in accordance with the li-zhi effects determined in the processing of S2323 in FIG. 23 (step S2417).

Specifically, the spin control signal includes information on the stop positions of the first to the fifth reels M3a to M3e determined by the li-zhi effects. The reel drivers 264 of the first to the fifth reels M3a to M3e control the reel motors 272 to stop the spinning reels among the first to the fifth reels M3a to M3e at the positions specified by the spin control signal.

As a result, all of the first to the fifth reels M3a to M3e stop so that fifteen symbols are rearranged in the display window 150 to form a symbol matrix.

### <Payout Determination Processing>

Next, with reference to FIG. 25, payout determination processing is described. FIG. 25 is a flowchart of the payout determination processing for the gaming machine 10 according to the embodiment of the present invention.

First, the main CPU 222 determines the amount of payout based on the payout associated with the completed winning pattern with reference to the symbol storage area and the payout table (FIG. 16) (step S2511).

For example, when four RED7s are stopped successively from the leftmost reel along one of the thirty paylines, the payout is determined to be 100.

The determined payout is stored in the payout counter in the payout storage area (step S2513).

Next, the main CPU 222 determines whether a jackpot is won (step S2515).

If determining that a jackpot is not won, the main CPU 222 immediately exits this subroutine.

If determining that a jackpot is won, the main CPU 222 notifies the external control device 190 of the winning the jackpot (step S2517). In response to the notification, the external control device 190 informs the gaming machine 10 of the amount of the progressive jackpot updated until the moment.

In this phase, the external control device 190 may pay out a part (for example, 80%) of the amount of the progressive jackpot while carrying over the remaining (in this example, 20%) for the next completion of a jackpot trigger.

The main CPU 222 receives the amount of the progressive jackpot from the external control device 190 (step S2519). Next, the main CPU 222 further stores the received amount of the progressive jackpot to the payout storage area (S2521). This is the end of the payout determination processing.

As described above, when winning a jackpot, the amount of the progressive jackpot is also paid out in addition to the normal payout.

Although the foregoing has described an example where the external control device 190 stores the amount of the progressive jackpot, each gaming machine 10 independently stores the amount of the progressive jackpot as a so-called standalone jackpot.

### <Free Game Mode Processing>

With reference to FIG. 26, free game mode processing is described. FIG. 26 is a flowchart of the free game mode processing for the gaming machine 10 according to the embodiment of the present invention.

First, the main CPU 222 conducts at-one-game-end initialization processing (step S2611). For example, the main CPU 222 clears data that becomes unnecessary after each game in the working areas of the RAM 226, such as the symbols determined by lottery.

In the free game mode, the main CPU 222 uses the same bet as the one used in the base game mode before entering the free game mode.

Next, the main CPU 222 determines whether operation of the spin button is detected (step S2613).

The main CPU 222 then conducts symbol lottery processing described with reference to FIG. 22 (step S2615). In the processing, to-be stopped symbols are determined based on random values for symbol determination. In this processing of step S2615, the symbol determination table in FIG. 15 defining weights in the free game mode is used to determine the to-be stopped symbols.

Next, the effect control module 312 executed by the main CPU 222 conducts effect content determination processing (step S2617). This processing is the same as the processing of step S2015 in FIG. 20.

The main CPU 222 then conducts symbol display control processing described with reference to FIG. 24 (step S2619). This processing is the same as the processing of step S2016 in FIG. 20.

Next, the main CPU 222 conducts payout determination processing described with reference to FIG. 25 (step S2621). This processing is the same as the processing of step S2017 in FIG. 20.

Next, the main CPU 222 conducts payout processing (step S2623). The main CPU 222 adds the value stored in the payout storage area (payout counter) to a value stored in a credit storage area (credit counter 320) provided in the RAM 226. It is to be noted that operations of the hopper 242 may be controlled so that coins corresponding to the value stored in the payout counter will be discharged from the coin payout exit. Alternatively, operations of the ticket printer 120 may be controlled and a ticket with a barcode may be issued on which a value stored in the payout counter is recorded.

Next, the main CPU 222 determines whether a retrigger is completed (step S2625). In the present embodiment, when the BONUS symbol on the reel M3c appears in the display window 150, a retrigger is completed.

When determining that a retrigger is completed, the main CPU 222 returns to step S2611. When determining that a retrigger is not completed, the main CPU 222 exits this subroutine.

In this way, when a retrigger is completed, the free game mode is maintained and one unit game is added in the free game mode. When a retrigger is not completed, the game mode returns from the free game mode to the base game mode.

### <Kind Number Identification Processing>

Next, with reference to FIG. 27, Kind number identification processing is described. FIG. 27 is a flowchart of the Kind number identification processing for the gaming machine 10 according to the embodiment of the present invention. The Kind number identification processing identifies the number of JACKPOTs included in a to-be stopped symbol matrix composed of the rearranged symbols when the five reels M3a to M3e are all stopped.

First, the main CPU 222 identifies whether the JACKPOTs are of 10Kind (step S2711). Since the JACKPOTs are scatter symbols as mentioned above, the identification of Step S2711 is to identify whether ten JACKPOTs appear in the display window 150.

If the identification is that the JACKPOTs are of 10Kind, the main CPU 222 determines the first identifier to be I (step S2713) and exits this subroutine.

If the identification is that the JACKPOTs are not of 10Kind, the main CPU 222 identifies whether the JACKPOTs are of 9Kind (step S2715). That is to say, the main CPU 222 determines whether nine JACKPOTs appear in the display window 150.

If the identification is that the JACKPOTs are of 9Kind, the main CPU 222 determines the first identifier to be II (step S2717) and exits this subroutine.

If the identification is that the JACKPOTs are not of 9Kind, the main CPU 222 identifies whether the JACKPOTs are of 8Kind (step S2719). That is to say, the main CPU 222 determines whether eight JACKPOTs appear in the display window 150.

If the identification is that the JACKPOTs are of 8Kind, the main CPU 222 determines the first identifier to be III (step S2721) and exits this subroutine.

If the identification is that the JACKPOTs are not of 8Kind, the main CPU 222 identifies whether the JACKPOTs are of 7Kind (step S2723). That is to say, the main CPU 222 determines whether seven JACKPOTs appear in the display window 150.

If the identification is that the JACKPOTs are of 7Kind, the main CPU 222 determines the first identifier to be IV (step S2725) and exits this subroutine.

If the identification is that the JACKPOTs are not of 7Kind, the main CPU 222 identifies whether the JACKPOTs are of 6Kind (step S2727). That is to say, the main CPU 222 determines whether six JACKPOTs appear in the display window 150.

If the identification is that the JACKPOTs are of 6Kind, the main CPU 222 determines the first identifier to be V (step S2729) and exits this subroutine.

If the identification is that the JACKPOTs are not of 6Kind, the main CPU 222 identifies whether the JACKPOTs are of 5Kind (step S2731). That is to say, the main CPU 222 determines whether five JACKPOTs appear in the display window 150.

If the identification is that the JACKPOTs are of 5Kind, the main CPU 222 determines the first identifier to be VI (step S2733) and exits this subroutine.

If the identification is that the JACKPOTs are not of 5Kind, the main CPU 222 identifies whether the JACKPOTs are of 4Kind (step S2735). That is to say, the main CPU 222 determines whether four JACKPOTs appear in the display window 150.

If the identification is that the JACKPOTs are of 4Kind, the main CPU 222 determines the first identifier to be VII (step S2737) and exits this subroutine.

If the identification is that the JACKPOTs are not of 4Kind, the main CPU 222 determines the first identifier to be VIII (step S2739) and exits this subroutine.

### <Stop Pattern Identification Processing>

Next, with reference to FIG. 28, stop pattern identification processing is described. FIG. 28 is a flowchart of the stop pattern identification processing for the gaming machine 10 according to the embodiment of the present invention. The stop pattern identification processing identifies the stop pattern of JACKPOTs included in a to-be stopped symbol matrix composed of the rearranged symbols when the five reels M3a to M3e are all stopped. As will be described with FIGS. 29A to 37, stop patterns can be defined with not only uniquely determined symbols but also symbols that are not uniquely determined and selected from a plurality of symbols. Accordingly, a symbol matrix may match two or more stop patterns in FIGS. 29A to 37; however, the stop pattern identification processing in FIG. 28 employs the first stop pattern that satisfies the requirements in the steps of this identification processing.

First, the main CPU 222 identifies whether the stop pattern of JACKPOTs is position A (step S2811). The position A is the pattern shown in FIG. 29A.

If the identification is that the stop pattern of JACKPOTs is position A, the main CPU 222 determines the second identifier to be Table A (step S2813) and exits this subroutine.

If the identification is that the stop pattern of JACKPOTs is not position A, the main CPU 222 identifies whether the stop pattern of JACKPOTs is position B (step S2815). The position B is the pattern shown in FIG. 29B.

If the identification is that the stop pattern of JACKPOTs is position B, the main CPU 222 determines the second identifier to be Table B (step S2817) and exits this subroutine.

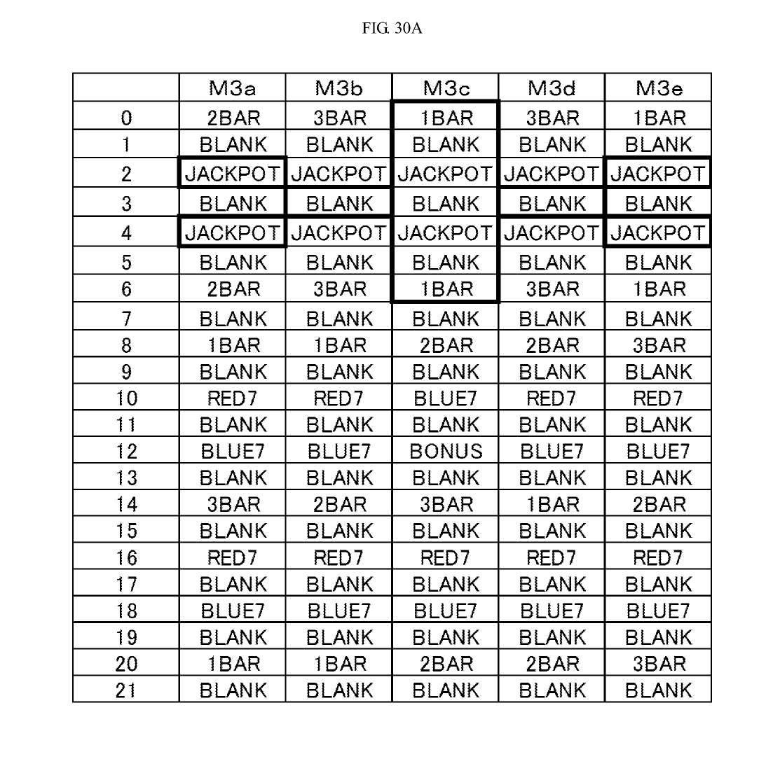

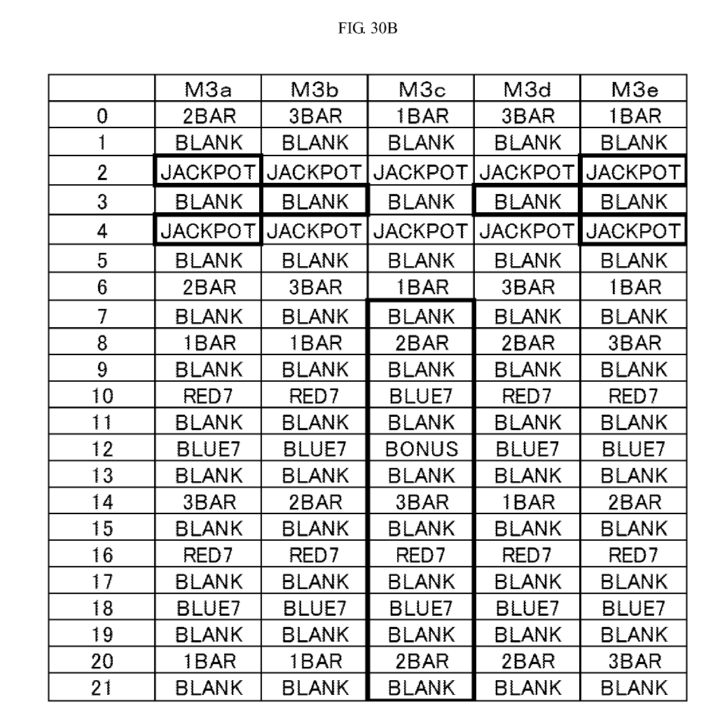

If the identification is that the stop pattern of JACKPOTs is not position B, the main CPU 222 identifies whether the stop pattern of JACKPOTs is position C (step S2819). The position C is the pattern shown in FIG. 30A.

If the identification is that the stop pattern of JACKPOTs is position C, the main CPU 222 determines the second identifier to be Table C (step S2821) and exits this subroutine.

If the identification is that the stop pattern of JACKPOTs is not position C, the main CPU 222 identifies whether the stop pattern of JACKPOTs is position D (step S2823). The position D is the pattern shown in FIG. 30B.

If the identification is that the stop pattern of JACKPOTs is position D, the main CPU 222 determines the second identifier to be Table D (step S2825) and exits this subroutine.

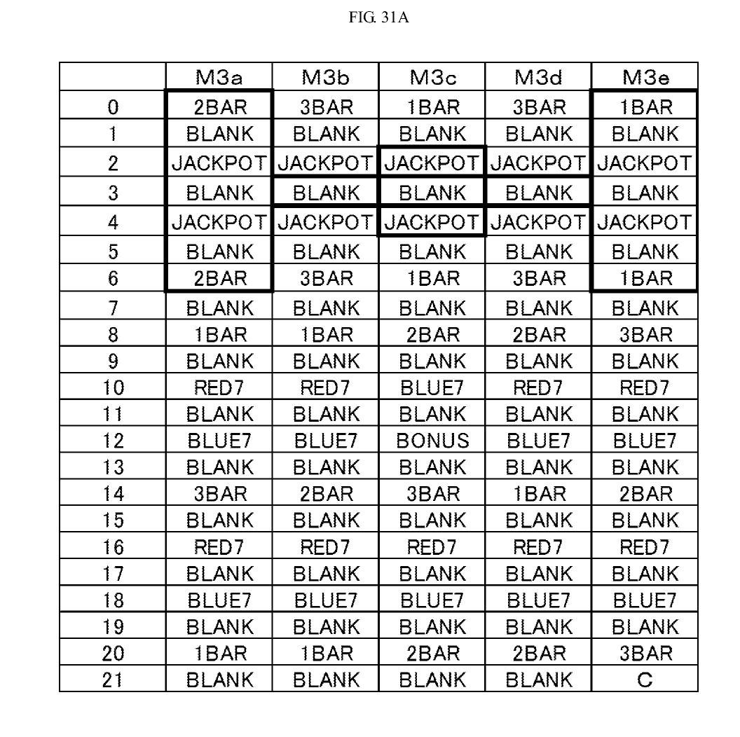

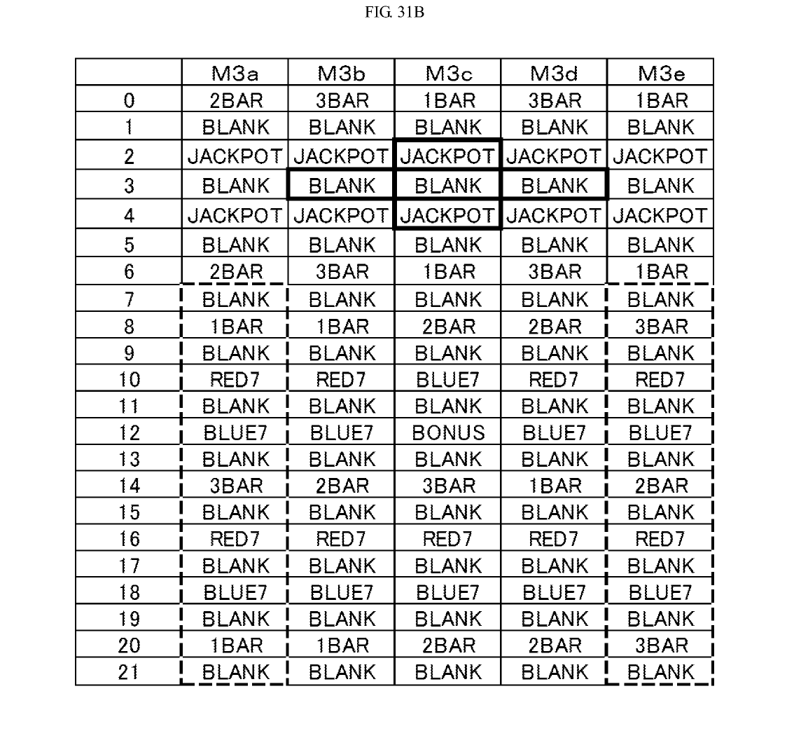

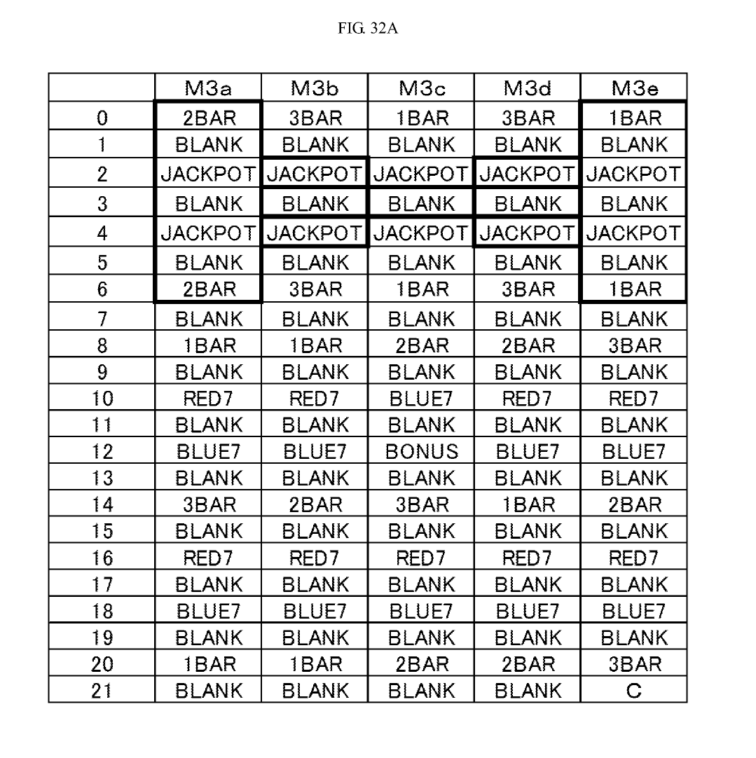

If the identification is that the stop pattern of JACKPOTs is not position D, the main CPU 222 identifies whether the stop pattern of JACKPOTs is position E (step S2827). The position E is the pattern shown in FIG. 31A.

If the identification is that the stop pattern of JACKPOTs is position E, the main CPU 222 determines the second identifier to be Table E (step S2829) and exits this subroutine.

If the identification is that the stop pattern of JACKPOTs is not position E, the main CPU 222 identifies whether the stop pattern of JACKPOTs is position F (step S2831). The position F is the pattern shown in FIG. 31B.

If the identification is that the stop pattern of JACKPOTs is position F, the main CPU 222 determines the second identifier to be Table F (step S2833) and exits this subroutine.

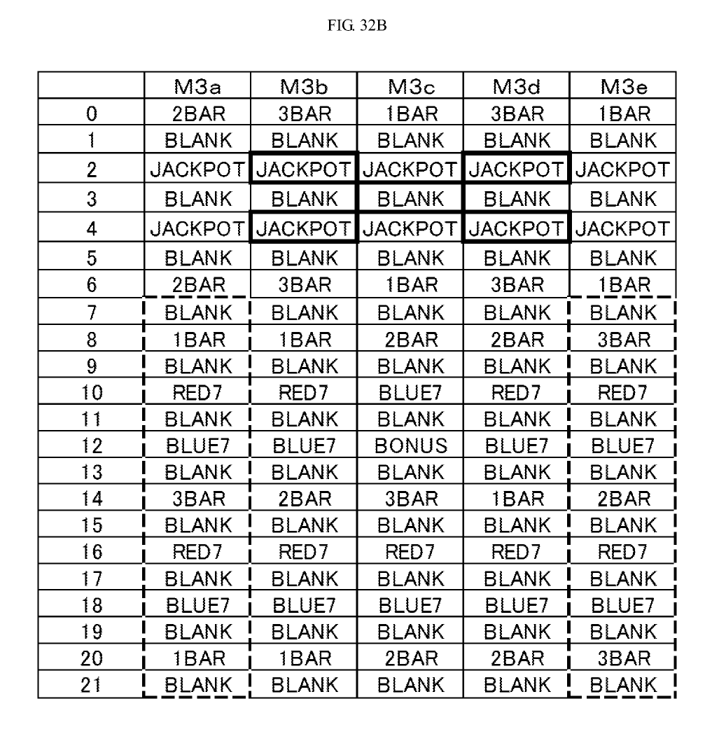

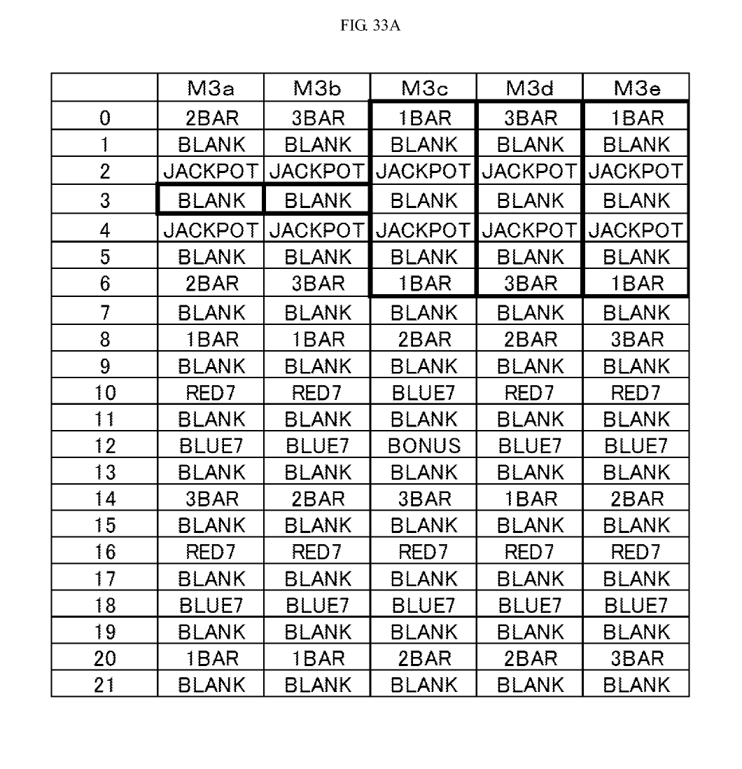

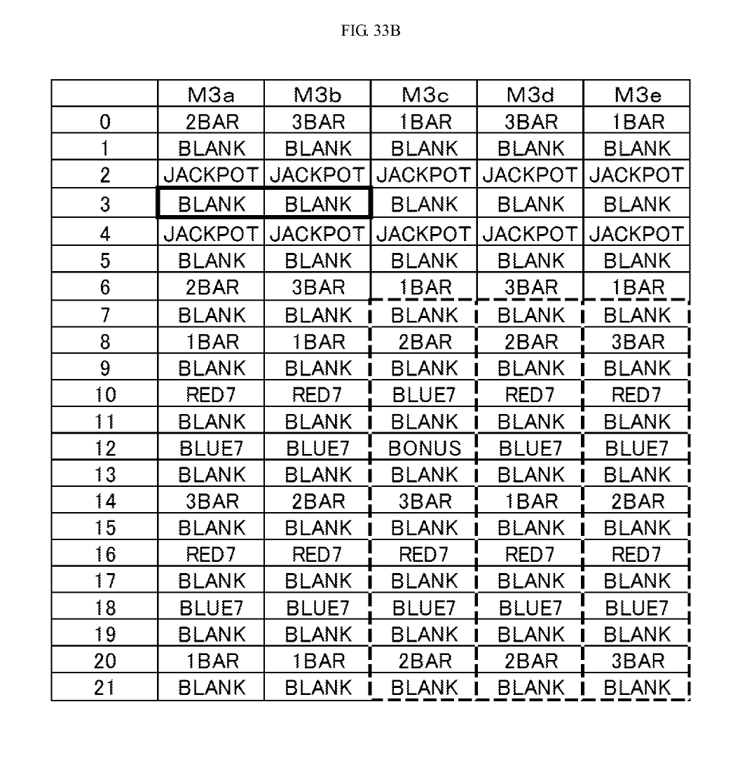

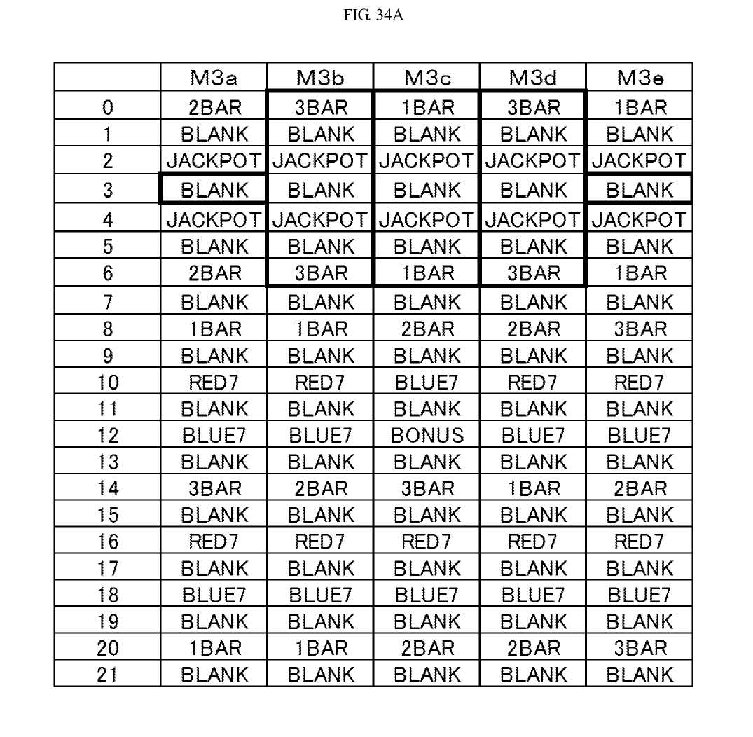

If the identification is that the stop pattern of JACKPOTs is not position F, the main CPU 222 identifies whether the stop pattern of JACKPOTs is position G (step S2835). The position G is the pattern shown in FIG. 32A.

If the identification is that the stop pattern of JACKPOTs is position G, the main CPU 222 determines the second identifier to be Table G (step S2837) and exits this subroutine.

If the identification is that the stop pattern of JACKPOTs is not position G, the main CPU 222 identifies whether the stop pattern of JACKPOTs is position H (step S2839). The position H is the pattern shown in FIG. 32B.

If the identification is that the stop pattern of JACKPOTs is position H, the main CPU 222 determines the second identifier to be Table H (step S2841) and exits this subroutine.

If the identification is that the stop pattern of JACKPOTs is not position H, the main CPU 222 identifies whether the stop pattern of JACKPOTs is position I (step S2843). The position I is the pattern shown in FIG. 33A.

If the identification is that the stop pattern of JACKPOTs is position I, the main CPU 222 determines the second identifier to be Table I (step S2845) and exits this subroutine.

If the identification is that the stop pattern of JACKPOTs is not position I, the main CPU 222 identifies whether the stop pattern of JACKPOTs is position J (step S2847). The position J is the pattern shown in FIG. 33B.

If the identification is that the stop pattern of JACKPOTs is position J, the main CPU 222 determines the second identifier to be Table J (step S2849) and exits this subroutine.

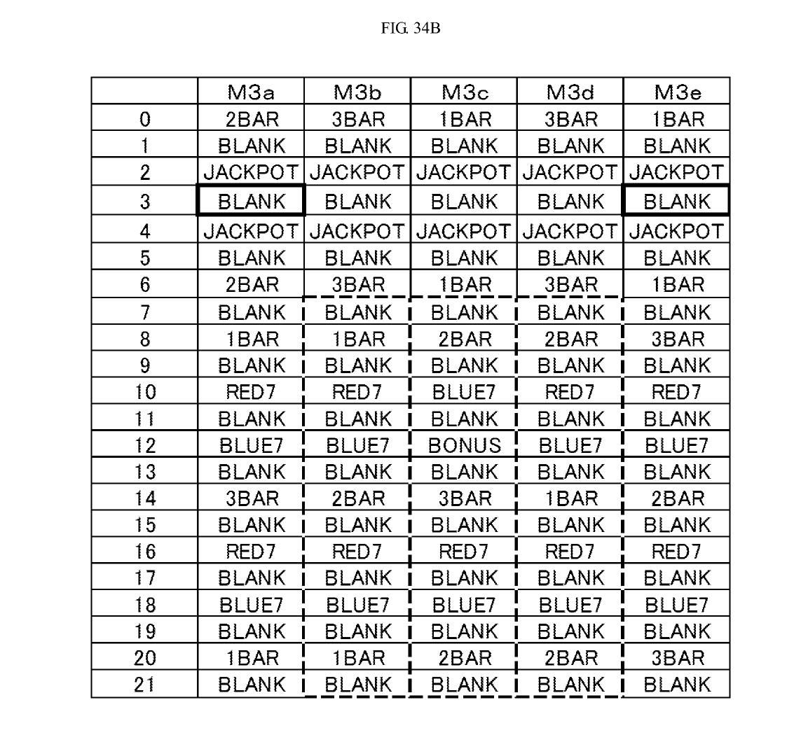

If the identification is that the stop pattern of JACKPOTs is not position J, the main CPU 222 identifies whether the stop pattern of JACKPOTs is position K (step S2851). The position K is the pattern shown in FIG. 34A.

If the identification is that the stop pattern of JACKPOTs is position K, the main CPU 222 determines the second identifier to be Table K (step S2853) and exits this subroutine.

If the identification is that the stop pattern of JACKPOTs is not position K, the main CPU 222 identifies whether the stop pattern of JACKPOTs is position L (step S2855). The position L is the pattern shown in FIG. 34B.

If the identification is that the stop pattern of JACKPOTs is position L, the main CPU 222 determines the second identifier to be Table L (step S2857) and exits this subroutine.

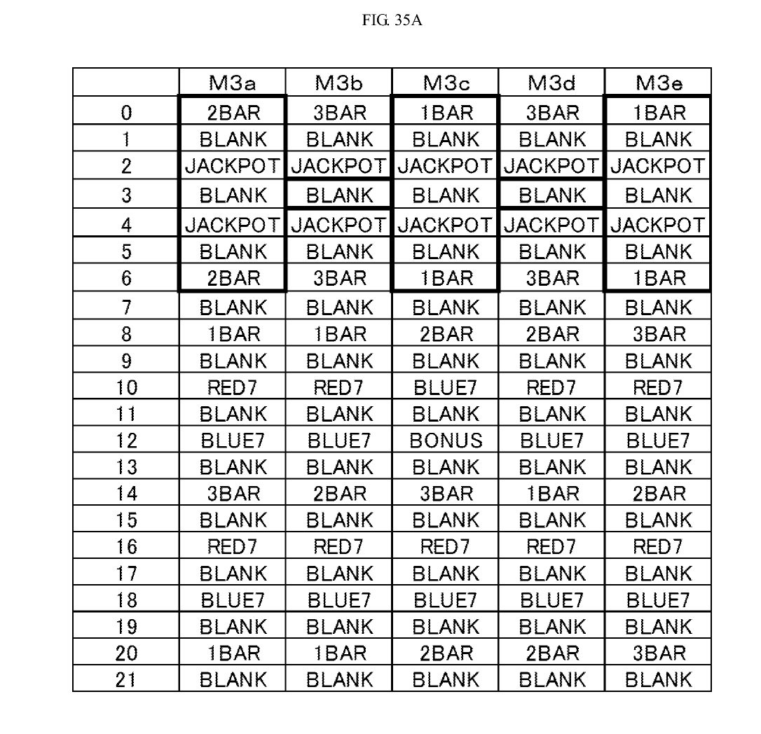

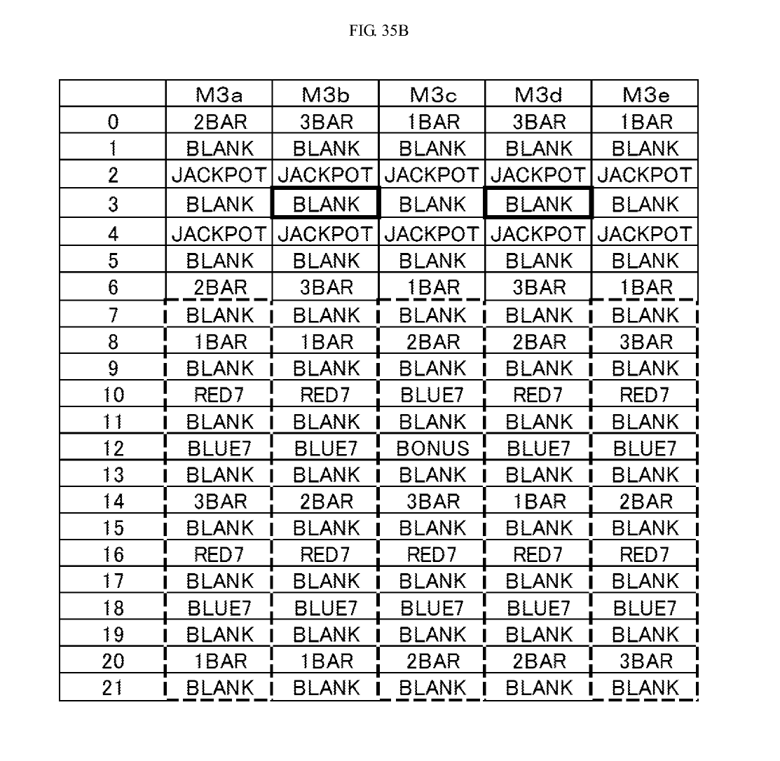

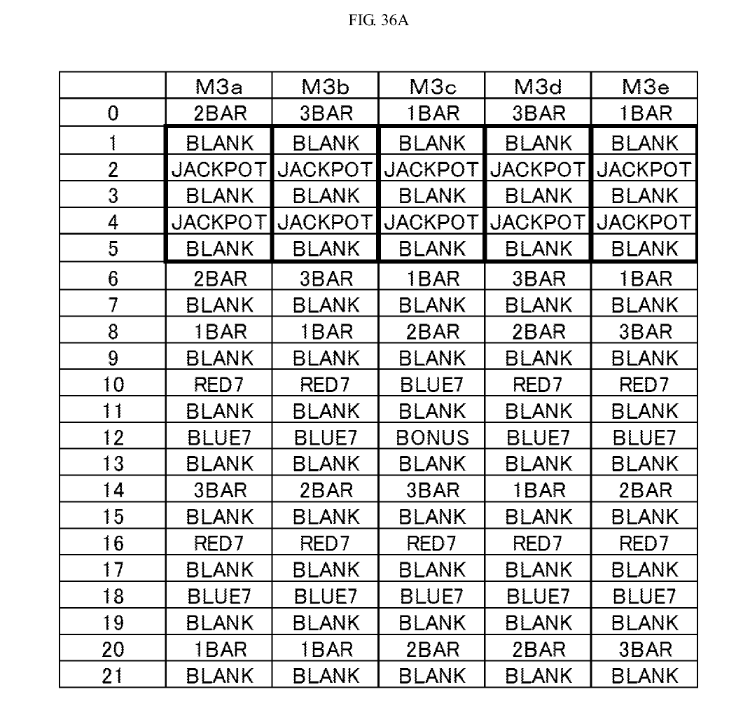

If the identification is that the stop pattern of JACKPOTs is not position L, the main CPU 222 identifies whether the stop pattern of JACKPOTs is position M (step S2859). The position M is the pattern shown in FIG. 35A.

If the identification is that the stop pattern of JACKPOTs is position M, the main CPU 222 determines the second identifier to be Table M (step S2861) and exits this subroutine.

If the identification is that the stop pattern of JACKPOTs is not position M, the main CPU 222 identifies whether the stop pattern of JACKPOTs is position N (step S2863). The position N is the pattern shown in FIG. 35B.

If the identification is that the stop pattern of JACKPOTs is position N, the main CPU 222 determines the second identifier to be Table N (step S2865) and exits this subroutine.

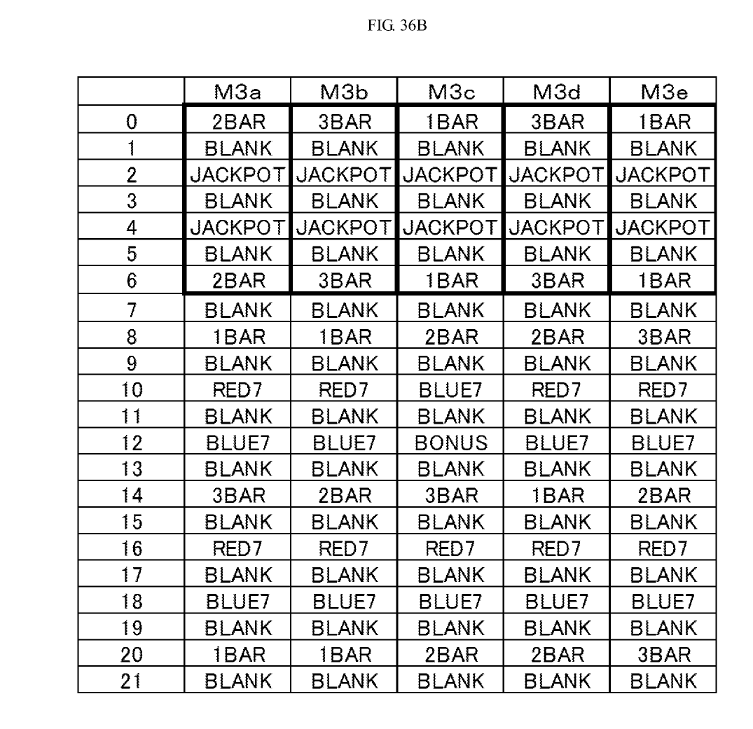

If the identification is that the stop pattern of JACKPOTs is not position N, the main CPU 222 identifies whether the stop pattern of JACKPOTs is position O (step S2867). The position O is the pattern shown in FIG. 36A.

If the identification is that the stop pattern of JACKPOTs is position O, the main CPU 222 determines the second identifier to be Table O (step S2869) and exits this subroutine.

If the identification is that the stop pattern of JACKPOTs is not position O, the main CPU 222 identifies whether the stop pattern of JACKPOTs is position P (step S2871). The position P is the pattern shown in FIG. 36B.

If the identification is that the stop pattern of JACKPOTs is position P, the main CPU 222 determines the second identifier to be Table P (step S2873) and exits this subroutine.

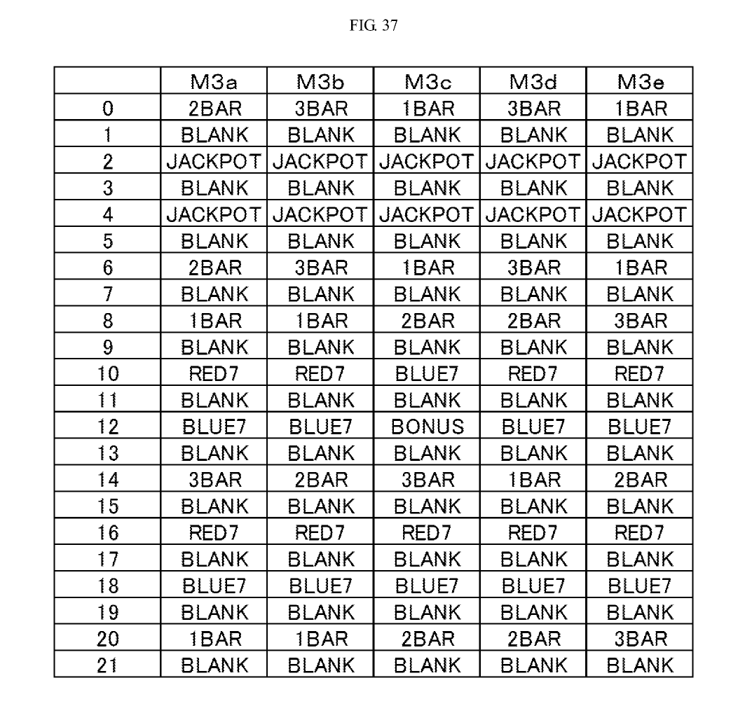

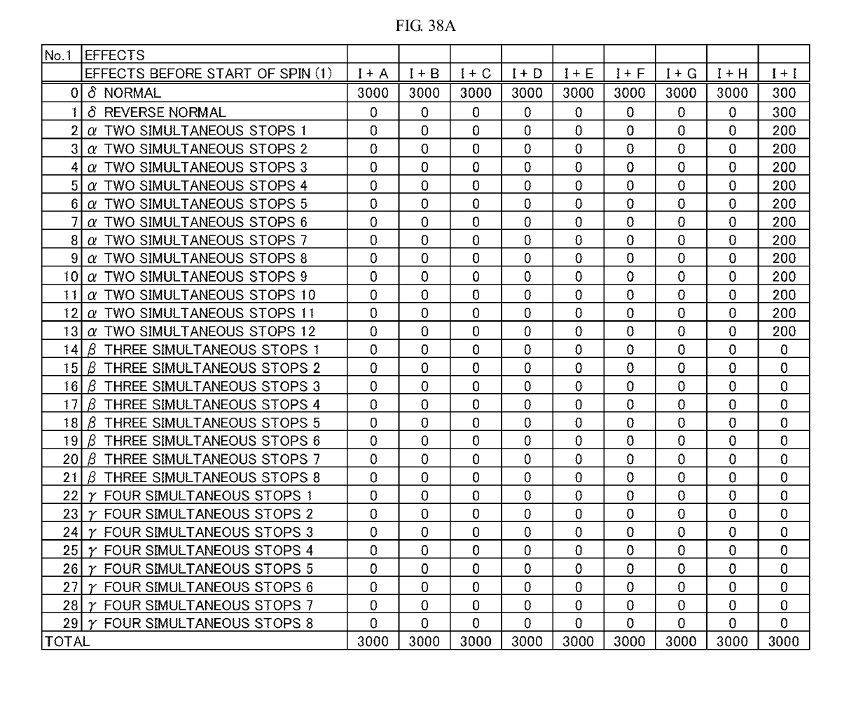

If the identification is that the stop pattern of JACKPOTs is not position P, the main CPU 222 identifies whether the stop pattern of JACKPOTs is position Q (step S2875). The position Q is the pattern shown in FIG. 37.

If the identification is that the stop pattern of JACKPOTs is position Q, the main CPU 222 determines the second identifier to be Table Q (step S2877) and exits this subroutine.

If the identification is that the stop pattern of JACKPOTs is not position Q, the main CPU 222 determines the second identifier to be Table R (step S2879) and exits this subroutine.

### <<Second Identifier Determination Tables>>

FIGS. 29A to 37 are tables for identifying the stop pattern of JACKPOTs to determine the second identifier. The tables in FIGS. 29A to 37 are to be read as follows: if one of the symbols surrounded by a thick line is positioned on the middle row of each reel, the requirements are satisfied.

The stop patterns illustrated in FIG. 29A are patterns where JACKPOTs are stopped on the top row and the bottom row of the reels M3a and M3e, a JACKPOT is stopped on the middle row of the reels M3b and M3d, and one of the symbols of code Nos. 0 to 6 is stopped on the middle row of the reel M3c. Accordingly, fixed symbols are stopped on the reels M3a, M3b, M3d, and M3e and one of the symbols of code Nos. 0 to 6 is selectively stopped on the reel M3c.

For example, the requirements for the stop patterns of FIG. 29A are satisfied when a JACKPOT, a BLANK, and a JACKPOT are respectively stopped on the top row, the middle row, and the bottom row of the reel M3a; a BLANK, a JACKPOT, and a BLANK are respectively stopped on the top row, the middle row, and the bottom row of the reel M3b; a BLANK, a JACKPOT, and a BLANK are respectively stopped on the top row, the middle row, and the bottom row of the reel M3c; a BLANK, a JACKPOT, and a BLANK are respectively stopped on the top row, the middle row, and the bottom row of the reel M3d; and a JACKPOT, a BLANK, and a JACKPOT are respectively stopped on the top row, the middle row, and the bottom row of the reel M3e.

The stop patterns illustrated in FIG. 29B are patterns where JACKPOTs are stopped on the top row and the bottom row of the reels M3a and M3e, a JACKPOT is stopped on the middle row of the reels M3b and M3d, and one of the symbols of code Nos. 7 to 21 is stopped on the middle row of the reel M3c. Accordingly, fixed symbols are stopped on the reels M3a, M3b, M3d, and M3e and one of the symbols of code Nos. 7 to 21 is selectively stopped on the reel M3c. Requirements for the reel M3c are the negation of the conditions for the stop patterns of FIG. 29A.

For example, the requirements for the stop patterns of FIG. 29B are satisfied when a JACKPOT, a BLANK, and a JACKPOT are respectively stopped on the top row, the middle row, and the bottom row of the reel M3a; a BLANK, a JACKPOT, and a BLANK are respectively stopped on the top row, the middle row, and the bottom row of the reel M3b; a 1BAR, a BLANK, and a 2BAR are respectively stopped on the top row, the middle row, and the bottom row of the reel M3c; a BLANK, a JACKPOT, and a BLANK are respectively stopped on the top row, the middle row, and the bottom row of the reel M3d; and a JACKPOT, a BLANK, and a JACKPOT are respectively stopped on the top row, the middle row, and the bottom row of the reel M3e.

The stop patterns illustrated in FIG. 30A are patterns where a JACKPOT is stopped on the middle row of the reels M3a and M3e, a BLANK is stopped on the middle row of the reels M3b and M3d, and one of the symbols of code Nos. 0 to 6 is stopped on the middle row of the reel M3c. Accordingly, fixed symbols are stopped on the reels M3a, M3b, M3d, and M3e and one of the symbols of code Nos. 0 to 6 is selectively stopped on the reel M3c.

For example, the requirements for the stop patterns of FIG. 30A are satisfied when a BLANK, a JACKPOT, a BLANK are respectively stopped on the top row, the middle row, and the bottom row of the reel M3a; a JACKPOT, a BLANK, and a JACKPOT are respectively stopped on the top row, the middle row, and the bottom row of the reel M3b; a BLANK, a JACKPOT, and a BLANK are respectively stopped on the top row, the middle row, and the bottom row of the reel M3c; a JACKPOT, a BLANK, and a JACKPOT are respectively stopped on the top row, the middle row, and the bottom row of the reel M3d; and a BLANK, a JACKPOT, and a BLANK are respectively stopped on the top row, the middle row, and the bottom row of the reel M3e.

The stop patterns illustrated in FIG. 30B are patterns where a JACKPOT is stopped on the middle row of the reels M3a and M3e, a BLANK is stopped on the middle row of the reels M3b and M3d, and one of the symbols of code Nos. 7 to 21 is stopped on the middle row of the reel M3c. Accordingly, fixed symbols are stopped on the reels M3a, M3b, M3d, and M3e and one of the symbols of code Nos. 7 to 21 is selectively stopped on the reel M3c. Requirements for the reel M3c are the negation of the conditions for the stop patterns of FIG. 30A.

For example, the requirements for the stop patterns of FIG. 30B are satisfied when a BLANK, a JACKPOT, a BLANK are respectively stopped on the top row, the middle row, and the bottom row of the reel M3a; a JACKPOT, a BLANK, and a JACKPOT are respectively stopped on the top row, the middle row, and the bottom row of the reel M3b; a 1BAR, a BLANK, and a 2BAR are respectively stopped on the top row, the middle row, and the bottom row of the reel M3c; a JACKPOT, a BLANK, and a JACKPOT are respectively stopped on the top row, the middle row, and the bottom row of the reel M3d; and a BLANK, a JACKPOT, and a BLANK are respectively stopped on the top row, the middle row, and the bottom row of the reel M3e.

The stop patterns illustrated in FIG. 31A are patterns where JACKPOTs are stopped on the top row and the bottom row of the reels M3b and M3d, a JACKPOT is stopped on the middle row of the reel M3c, and one of the symbols of code Nos. 0 to 6 is stopped on the middle row of the reels M3a and M3e. Accordingly, fixed symbols are stopped on the reels M3b, M3c, and M3d and one of the symbols of code Nos. 0 to 6 is selectively stopped on the reels M3a and M3e.

For example, the requirements for the stop patterns of FIG. 31A are satisfied when a 2BAR, a BLANK, and a JACKPOT are respectively stopped on the top row, the middle row, and the bottom row of the reel M3a; a JACKPOT, a BLANK, and a JACKPOT are respectively stopped on the top row, the middle row, and the bottom row of the reel M3b; a BLANK, a JACKPOT, and a BLANK are respectively stopped on the top row, the middle row, and the bottom row of the reel M3c; a JACKPOT, a BLANK, and a JACKPOT are respectively stopped on the top row, the middle row, and the bottom row of the reel M3d; and a BLANK, a 1BAR, and a BLANK are respectively stopped on the top row, the middle row, and the bottom row of the reel M3e.

The stop patterns illustrated in FIG. 31B are patterns where JACKPOTs are stopped on the top row and the bottom row of the reels M3b and M3d, a JACKPOT is stopped on the middle row of the reel M3c, and one of the symbols of code Nos. 7 to 21 is stopped on the middle row of the reels M3a and M3e. Accordingly, fixed symbols are stopped on the reels M3b, M3c, and M3d and one of the symbols of the codes other than code Nos. 7 to 21 is selectively stopped on the reels M3a and M3e. Requirements for the reels M3a and M3e are the negation of the conditions for the stop patterns of FIG. 31A. However, one of the symbols of code Nos. 0 to 6 may be selectively stopped on either the reel M3a or M3e.

For example, the requirements for the stop patterns of FIG. 31B are satisfied when a JACKPOT, a BLANK, and a JACKPOT are respectively stopped on the top row, the middle row, and the bottom row of the reel M3a; a JACKPOT, a BLANK, and a JACKPOT are respectively stopped on the top row, the middle row, and the bottom row of the reel M3b; a BLANK, a JACKPOT, and a BLANK are respectively stopped on the top row, the middle row, and the bottom row of the reel M3c; a JACKPOT, a BLANK, and a JACKPOT are respectively stopped on the top row, the middle row, and the bottom row of the reel M3d; and a BLANK, a BLUE7, and a BLANK are respectively stopped on the top row, the middle row, and the bottom row of the reel M3e.

The stop patterns illustrated in FIG. 32A are patterns where a JACKPOT is stopped on the middle row of the reels M3b and M3d, JACKPOTs are stopped on the top row and the bottom of the reel M3c, and one of the symbols of code Nos. 0 to 6 is stopped on the middle row of the reels M3a and M3e. Accordingly, fixed symbols are stopped on the reels M3b, M3c, and M3d and one of the symbols of code Nos. 0 to 6 is selectively stopped on the reels M3a and M3e.

For example, the requirements for the stop patterns of FIG. 32A are satisfied when a 2BAR, a BLANK, and a JACKPOT are respectively stopped on the top row, the middle row, and the bottom row of the reel M3a; a BLANK, a JACKPOT, and a BLANK are respectively stopped on the top row, the middle row, and the bottom row of the reel M3b; a JACKPOT, a BLANK, and a JACKPOT are respectively stopped on the top row, the middle row, and the bottom row of the reel M3c; a BLANK, a JACKPOT, and a BLANK are respectively stopped on the top row, the middle row, and the bottom row of the reel M3d; and a 1BAR, a BLANK, and a JACKPOT are respectively stopped on the top row, the middle row, and the bottom row of the reel M3e.

The stop patterns illustrated in FIG. 32B are patterns where a JACKPOT is stopped on the middle row of the reels M3b and M3d, JACKPOTs are stopped on the top row and the bottom of the reel M3c, and one of the symbols of code Nos. 7 to 21 is stopped on the middle row of the reels M3a and M3e. Accordingly, fixed symbols are stopped on the reels M3b, M3c, and M3d and one of the symbols of the codes other than code Nos. 7 to 21 is selectively stopped on the reels M3a and M3e. Requirements for the reels M3a and M3e are the negation of the conditions for the stop patterns of FIG. 32A. However, one of the symbols of code Nos. 0 to 6 may be selectively stopped on either the reel M3a or M3e.

For example, the requirements for the stop patterns of FIG. 32B are satisfied when a BLANK, a BLUE7, and a BLANK are respectively stopped on the top row, the middle row, and the bottom row of the reel M3a; a BLANK, a JACKPOT, and a BLANK are respectively stopped on the top row, the middle row, and the bottom row of the reel M3b; a JACKPOT, a BLANK, and a JACKPOT are respectively stopped on the top row, the middle row, and the bottom row of the reel M3c; a BLANK, a JACKPOT, and a BLANK are respectively stopped on the top row, the middle row, and the bottom row of the reel M3d; and a JACKPOT, a BLANK, and a JACKPOT are respectively stopped on the top row, the middle row, and the bottom row of the reel M3e.

The stop patterns illustrated in FIG. 33A are patterns where JACKPOTs are stopped on the top row and the bottom row of the reels M3a and M3b, one of the symbols of code Nos. 0 to 6 is stopped on the middle row of the reels M3c, M3d, and M3e. Accordingly, fixed symbols are stopped on the reels M3a and M3b and one of the symbols of code Nos. 0 to 6 is selectively stopped on the reels M3c, M3d, and M3e.

For example, the requirements for the stop patterns of FIG. 33A are satisfied when a JACKPOT, a BLANK, and a JACKPOT are respectively stopped on the top row, the middle row, and the bottom row of the reel M3a; a JACKPOT, a BLANK, and a JACKPOT are respectively stopped on the top row, the middle row, and the bottom row of the reel M3b; a JACKPOT, a BLANK, and a JACKPOT are respectively stopped on the top row, the middle row, and the bottom row of the reel M3c; a JACKPOT, a BLANK, and a JACKPOT are respectively stopped on the top row, the middle row, and the bottom row of the reel M3d; and a JACKPOT, a BLANK, and a JACKPOT are respectively stopped on the top row, the middle row, and the bottom row of the reel M3e.

The stop patterns illustrated in FIG. 33B are patterns where JACKPOTs are stopped on the top row and the bottom row of the reels M3a and M3b, one of the symbols of code Nos. 7 to 21 is stopped on the middle row of the reels M3c, M3d, and M3e. Accordingly, fixed symbols are stopped on the reels M3a and M3b and one of the symbols of code Nos. 7 to 21 is selectively stopped on the reels M3c, M3d, and M3e. Requirements for the reels M3c, M3d, and M3e are the negation of the conditions for the stop patterns of FIG. 33A. However, one of the symbols of code Nos. 0 to 6 may be selectively stopped on one or two of the reels M3c, M3d, and M3e.

For example, the requirements for the stop patterns of FIG. 33B are satisfied when a JACKPOT, a BLANK, and a JACKPOT are respectively stopped on the top row, the middle row, and the bottom row of the reel M3a; a JACKPOT, a BLANK, and a JACKPOT are respectively stopped on the top row, the middle row, and the bottom row of the reel M3b; a JACKPOT, a BLANK, and a JACKPOT are respectively stopped on the top row, the middle row, and the bottom row of the reel M3c; a JACKPOT, a BLANK, and a JACKPOT are respectively stopped on the top row, the middle row, and the bottom row of the reel M3d; and a BLANK, a RED7, and a BLANK are respectively stopped on the top row, the middle row, and the bottom row of the reel M3e.

The stop patterns illustrated in FIG. 34A are patterns where JACKPOTs are stopped on the top row and the bottom row of the reels M3a and M3e, one of the symbols of code Nos. 0 to 6 is stopped on the middle row of the reels M3b, M3c, and M3d. Accordingly, fixed symbols are stopped on the reels M3a and M3e and one of the symbols of code Nos. 0 to 6 is selectively stopped on the reels M3b, M3c, and M3d.

For example, the requirements for the stop patterns of FIG. 34A are satisfied when a JACKPOT, a BLANK, and a JACKPOT are respectively stopped on the top row, the middle row, and the bottom row of the reel M3a; a 3BAR, a BLANK, and a JACKPOT are respectively stopped on the top row, the middle row, and the bottom row of the reel M3b; a 1BAR, a BLANK, and a JACKPOT are respectively stopped on the top row, the middle row, and the bottom row of the reel M3c; a 3BAR, a BLANK, and a JACKPOT are respectively stopped on the top row, the middle row, and the bottom row of the reel M3d; and a JACKPOT, a BLANK, and a JACKPOT are respectively stopped on the top row, the middle row, and the bottom row of the reel M3e.

The stop patterns illustrated in FIG. 34B are patterns where JACKPOTs are stopped on the top row and the bottom row of the reels M3a and M3e, one of the symbols of code Nos. 7 to 21 is stopped on the middle row of the reels M3b, M3c, and M3d. Accordingly, fixed symbols are stopped on the reels M3a and M3e and one of the symbols of code Nos. 7 to 21 is selectively stopped on the reels M3b, M3c, and M3d. Requirements for the reels M3b, M3c, and M3d are the negation of the conditions for the stop patterns of FIG. 34A. However, one of the symbols of code Nos. 0 to 6 may be selectively stopped on one or two of the reels M3b, M3c, and M3d.

For example, the requirements for the stop patterns of FIG. 34B are satisfied when a JACKPOT, a BLANK, and a JACKPOT are respectively stopped on the top row, the middle row, and the bottom row of the reel M3a; a JACKPOT, a BLANK, and a 3BAR are respectively stopped on the top row, the middle row, and the bottom row of the reel M3b; a JACKPOT, a BLANK, and a 1BAR are respectively stopped on the top row, the middle row, and the bottom row of the reel M3c; a JACKPOT, a BLANK, and a 3BAR are respectively stopped on the top row, the middle row, and the bottom row of the reel M3d; and a JACKPOT, a BLANK, and a JACKPOT are respectively stopped on the top row, the middle row, and the bottom row of the reel M3e.

The stop patterns illustrated in FIG. 35A are patterns where JACKPOTs are stopped on the top row and the bottom row of the reels M3b and M3d, one of the symbols of code Nos. 0 to 6 is stopped on the middle row of the reels M3a, M3c, and M3e. Accordingly, fixed symbols are stopped on the reels M3b and M3d and one of the symbols of code Nos. 0 to 6 is selectively stopped on the reels M3a, M3c, and M3e.

For example, the requirements for the stop patterns of FIG. 35A are satisfied when a 2BAR, a BLANK, and a JACKPOT are respectively stopped on the top row, the middle row, and the bottom row of the reel M3a; a JACKPOT, a BLANK, and a JACKPOT are respectively stopped on the top row, the middle row, and the bottom row of the reel M3b; a BLANK, a JACKPOT, and a BLANK are respectively stopped on the top row, the middle row, and the bottom row of the reel M3c; a JACKPOT, a BLANK, and a JACKPOT are respectively stopped on the top row, the middle row, and the bottom row of the reel M3d; and a BLANK, a 1BAR, and a BLANK are respectively stopped on the top row, the middle row, and the bottom row of the reel M3e.

The stop patterns illustrated in FIG. 35B are patterns where JACKPOTs are stopped on the top row and the bottom row of the reels M3b and M3d, one of the symbols of code Nos. 7 to 21 is stopped on the middle row of the reels M3a, M3c, and M3e. Accordingly, fixed symbols are stopped on the reels M3b and M3d and one of the symbols of code Nos. 7 to 21 is selectively stopped on the reels M3a, M3c, and M3e. Requirements for the reels M3a, M3c, and M3e are the negation of the conditions for the stop patterns of FIG. 35A. However, one of the symbols of code Nos. 0 to 6 may be selectively stopped on one or two of the reels M3a, M3c, and M3e.

For example, the requirements for the stop patterns of FIG. 35B are satisfied when a 2BAR, a BLANK, and a JACKPOT are respectively stopped on the top row, the middle row, and the bottom row of the reel M3a; a JACKPOT, a BLANK, and a JACKPOT are respectively stopped on the top row, the middle row, and the bottom row of the reel M3b; a BLANK, a BONUS, and a BLANK are respectively stopped on the top row, the middle row, and the bottom row of the reel M3c; a JACKPOT, a BLANK, and a JACKPOT are respectively stopped on the top row, the middle row, and the bottom row of the reel M3d; and a JACKPOT, a BLANK, and a 1BAR are respectively stopped on the top row, the middle row, and the bottom row of the reel M3e.

### <<Predictive Effect Lottery Tables>>

FIGS. 38A to 45B are predictive effect lottery tables for determining predictive effects. The predictive effect lottery tables illustrated in FIGS. 38A to 45B are tables to be used in the base game mode. Predictive effect lottery tables to be used in the free game mode are also defined (not shown). These tables are stored in the RAM 226.

As described above, predictive effects are produced by motion of the five reels M3a to M3e from start of spinning of the five reels M3a to M3e until an intermediate state where at least one reel stops and the remaining reels keep spinning.

A predictive effect lottery table is selected based on both of the Kind number and the stop pattern. The Kind number determines a first identifier. There are eight identifiers of I to VIII for the first identifiers. The stop pattern determines a second identifier. There are eighteen identifiers of Table A to Table R for the second identifiers. The eight predictive effect lottery tables in FIGS. 38A to 45B each correspond to one of the eight first identifiers (I to VIII). Each of the eight predictive effect lottery tables in FIGS. 38A to 45B defines the weights of individual kinds of predictive effects for the eighteen second identifiers (Table A to Table R).

There are thirty kinds of predictive effects: δ normal, δ reverse normal, α two simultaneous stops 1 to α two simultaneous stops 12, β three simultaneous stops 1 to β three simultaneous stops 8, and γ four simultaneous stops 1 to γ four simultaneous stops 8. The effects δ normal provides motion that all the five reels M3a to M3e spin forward. The δ reverse normal provides motion that all the five reels M3a to M3e spin reversely. For predictive effects from the start of spinning of the five reels M3a to M3e until the intermediate state where at least one reel stops and the remaining reels keep spinning, one of thirty kinds of predictive effects are selected in accordance with the first identifier and the second identifier. Thirty kinds of predictive effects are selectively performed so that diverse reel motion variations can be provided based on the to-be stopped symbol matrix.

The twelve kinds of predictive effects α two simultaneous stops 1 to α two simultaneous stops 12 provide motion that two of the five reels M3a to M3e stop simultaneously. Accordingly, the remaining three reels M3 keep spinning.

In α two simultaneous stops 1 (↓↓↓↓↓), after the five reels M3a to M3e spin forward for a predetermined time, two reels M3a and M3b stop and the remaining three reels M3c, M3d, and M3e keep spinning.

In α two simultaneous stops 2 (↑↑↓↓↓), after two reels M3a and M3b spin reversely and the remaining three reels M3c, M3d, and M3e spin forward for a predetermined time, two reels M3a and M3b stop and the remaining three reels M3c, M3d, and M3e keep spinning.

In α two simultaneous stops 3 (↓↓↓↓↓), after the five reels M3a to M3e spin forward for a predetermined time, two reels M3a and M3e stop and the remaining three reels M3b, M3c, and M3d keep spinning.

In α two simultaneous stops 4 (↑↓↓↓↑), after two reels M3a and M3e spin reversely and the remaining three reels M3b, M3c, and M3d spin forward for a predetermined time, two reels M3a and M3e stop and the remaining three reels M3b, M3c, and M3d keep spinning.

In α two simultaneous stops 5 (↓↓↓↓↓), after the five reels M3a to M3e spin forward for a predetermined time, two reels M3b and M3d stop and the remaining three reels M3a, M3c, and M3e keep spinning.

In α two simultaneous stops 6 (↓↑↓↑↓), after two reels M3b and M3d spin reversely and the remaining three reels M3a, M3c, and M3e spin forward for a predetermined time, two reels M3b and M3d stop and the remaining three reels M3a, M3c, and M3e keep spinning.

In α two simultaneous stops 7 (↓↓↑↑↑), after two reels M3a and M3b spin forward and the remaining three reels M3c, M3d, and M3e spin reversely for a predetermined time, two reels M3a and M3b stop and the remaining three reels M3c, M3d, and M3e keep spinning.

In α two simultaneous stops 8 (↑↑↑↑↑), after the five reels M3a to M3e spin reversely for a predetermined time, two reels M3a and M3b stop and the remaining three reels M3c, M3d, and M3e keep spinning.

In α two simultaneous stops 9 (↓↑↑↑↓), after two reels M3a and M3e spin forward and the remaining three reels M3b, M3c, and M3d spin reversely for a predetermined time, two reels M3a and M3e stop and the remaining three reels M3b, M3c, and M3d keep spinning.

In α two simultaneous stops 10 (↑↑↑↑↑), after the five reels M3a to M3e spin reversely for a predetermined time, two reels M3a and M3e stop and the remaining three reels M3b, M3c, and M3d keep spinning.

In α two simultaneous stops 11 (↑↓↑↓↑), after two reels M3b and M3d spin forward and the remaining three reels M3a, M3c, and M3e spin reversely for a predetermined time, two reels M3b and M3d stop and the remaining three reels M3a, M3c, and M3e keep spinning.

In α two simultaneous stops 12 (↑↑↑↑↑), after the five reels M3a to M3e spin reversely for a predetermined time, two reels M3b and M3d stop and the remaining three reels M3a, M3c, and M3e keep spinning.

The eight kinds of predictive effects β three simultaneous stops 1 to β three simultaneous stops 8 provide motion that three of the five reels M3a to M3e stop simultaneously. Accordingly, the remaining two reels M3 keep spinning.

In β three simultaneous stops 1 (↓↓↓↓↓), after the five reels M3a to M3e spin forward for a predetermined time, three reels M3b, M3c, and M3d stop and the remaining two reels M3a and M3e keep spinning.

In β three simultaneous stops 2 (↓↓↑↓↓), after four reels M3a, M3b, M3d, and M3e spin forward and the remaining one reel M3c spins reversely for a predetermined time, three reels M3b, M3c, and M3d stop and the remaining two reels M3a and M3e keep spinning.

In β three simultaneous stops 3 (↓↑↓↑↓), after three reels M3a, M3c, and M3e spin forward and the remaining two reels M3b and M3d spin reversely for a predetermined time, three reels M3b, M3c, and M3d stop and the remaining two reels M3a and M3e keep spinning.

In β three simultaneous stops 4 (↓↑↑↑↓), after two reels M3a and M3e spin forward and the remaining three reels M3b, M3c, and M3d spin reversely for a predetermined time, three reels M3b, M3c, and M3d stop and the remaining two reels M3a and M3e keep spinning.

In β three simultaneous stops 5 (↑↓↓↓↑), after three reels M3b, M3c, and M3d spin forward and the remaining two reels M3a and M3e spin reversely for a predetermined time, three reels M3b, M3c, and M3d stop and the remaining two reels M3a and M3e keep spinning.

In β three simultaneous stops 6 (↑↓↑↓↑), after two reels M3b and M3d spin forward and the remaining three reels M3a, M3c, and M3e spin reversely for a predetermined time, three reels M3b, M3c, and M3d stop and the remaining two reels M3a and M3e keep spinning.

In β three simultaneous stops 7 (↑↑↓↑↑), after one reel M3c spins forward and the remaining four reels M3a, M3b, M3d, and M3e spin reversely for a predetermined time, three reels M3b, M3c, and M3d stop and the remaining two reels M3a and M3e keep spinning.

In β three simultaneous stops 8 (↑↑↑↑↑), after the five reels M3a to M3e spin reversely for a predetermined time, three reels M3b, M3c, and M3d stop and the remaining two reels M3a and M3e keep spinning.

The eight kinds of predictive effects γ four simultaneous stops 1 to γ four simultaneous stops 8 provide motion that four of the five reels M3a to M3e stop simultaneously. Accordingly, the remaining one reel M3 keeps spinning.

In γ four simultaneous stops 1 (↓↓↓↓↓), after the five reels M3a to M3e spin forward for a predetermined time, four reels M3a, M3b, M3d, and M3e stop and the remaining one reel M3c keeps spinning.

In γ four simultaneous stops 2 (↓↑↓μ↓), after three reels M3a, M3c, and M3e spin forward and the remaining two reels M3b and M3d spin reversely for a predetermined time, four reels M3a, M3b, M3d, and M3e stop and the remaining one reel M3c keeps spinning.

In γ four simultaneous stops 3 (↑↓↓↓↑), after three reels M3b, M3c, and M3d spin forward and the remaining two reels M3a and M3e spin reversely for a predetermined time, four reels M3a, M3b, M3d, and M3e stop and the remaining one reel M3c keeps spinning.

In γ four simultaneous stops 4 (↑↑↓↑↑), after one reel M3c spins forward and the remaining four reels M3a, M3b, M3d, and M3e spin reversely for a predetermined time, four reels M3a, M3b, M3d, and M3e stop and the remaining one reel M3c keeps spinning.

In γ four simultaneous stops 5 (↓↓↑↓↓), after four reels M3a, M3b, M3d, and M3e spin forward and the remaining one reel M3c spins reversely for a predetermined time, four reels M3a, M3b, M3d, and M3e stop and the remaining one reel M3c keeps spinning.

In γ four simultaneous stops 6 (↓↑↑↑↓), after two reels M3a and M3e spin forward and the remaining three reels M3b, M3c, and M3d spin reversely for a predetermined time, four reels M3a, M3b, M3d, and M3e stop and the remaining one reel M3c keeps spinning.

In γ four simultaneous stops 7 (↑↓↑↓↑), after two reels M3b and M3d spin forward and the remaining three reels M3a, M3c, and M3e spin reversely for a predetermined time, four reels M3a, M3b, M3d, and M3e stop and the remaining one reel M3c keeps spinning.

In γ four simultaneous stops 8 (↑↑↑↑↑), after the five reels M3a to M3e spin reversely for a predetermined time, four reels M3a, M3b, M3d, and M3e stop and the remaining one reel M3c keeps spinning.

The predictive effect lottery tables in FIGS. 38A to 45B define the weights of the above-described thirty kinds of predictive effects in relation to the eight first identifiers (I to VIII) and eighteen second identifiers (Table A to Table R). Determining one of the first identifiers (I to VIII) and determining one of the second identifiers (Table A to Table R) lead to determination of one predictive effect lottery table. The main CPU 222 can determine one kind of predictive effects by generating a random number and referring to the determined predictive effect lottery table.

As described above, there are thirty kinds of predictive effects of δ normal, δ reverse normal, α two simultaneous stops 1 to α two simultaneous stops 12, β three simultaneous stops 1 to β three simultaneous stops 8, and γ four simultaneous stops 1 to γ four simultaneous stops 8. Determining the predictive effects results in determination of a third identifier, α, β, γ, or δ.

The third identifiers (such as α, β, and γ) primarily represent the number of reels to be stopped in the predictive effects. For example, in the case of α, two reels M3 simultaneously stop at the end of the predictive effects. In the case of β, three reels M3 simultaneously stop at the end of the predictive effects. In the case of γ, four reels M3 simultaneously stop at the end of the predictive effects. To perform li-zhi effects subsequent to the predictive effects, if two reels M3 are stopped in the predictive effects, the li-zhi effects need to be performed on the remaining three reels M3. In similar, if three reels M3 are stopped in the predictive effects, the li-zhi effects need to be performed on the remaining two reels M3. If four reels M3 are stopped in the predictive effects, the li-zhi effects need to be performed on the remaining one reel M3.

To attain consistency between the reels stopped in the predictive effects and the reels to be moved in the li-zhi effects, third identifiers are used. When switching from the predictive effects to the li-zhi effects, the reels need to move smoothly. To prevent the reels stopped in the predictive effects from abruptly starting spinning in the li-zhi effects or to prevent some reels from keeping spinning even after the end of li-zhi effects, predictive effects should be smoothly succeeded by li-zhi effects. The third identifiers enable li-zhi effects to be determined appropriately for the predictive effects.

FIGS. 38A and 38B are tables defining the weights of thirty kinds of predictive effects for each of Table A to Table R in the case where the first identifier is I.

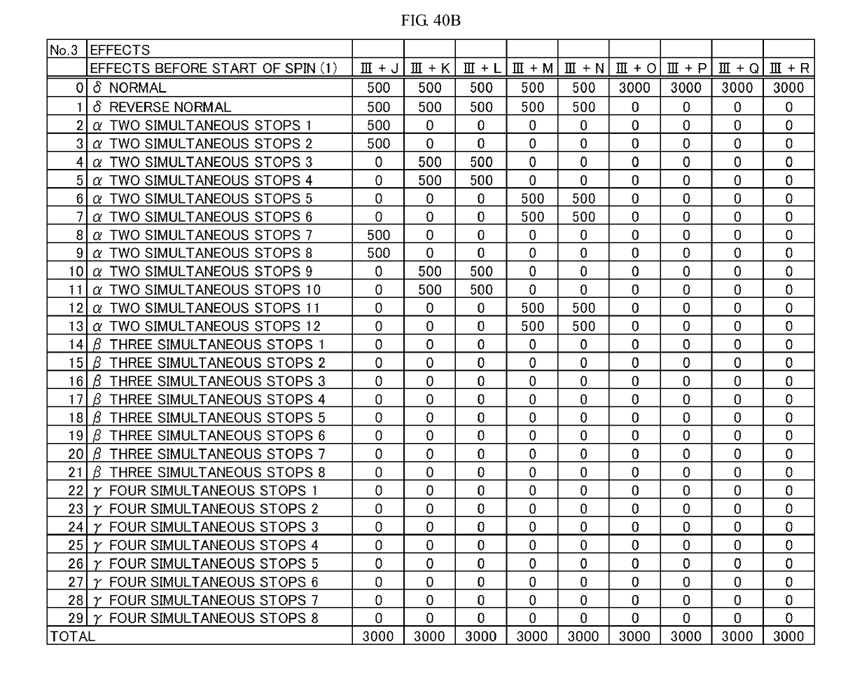

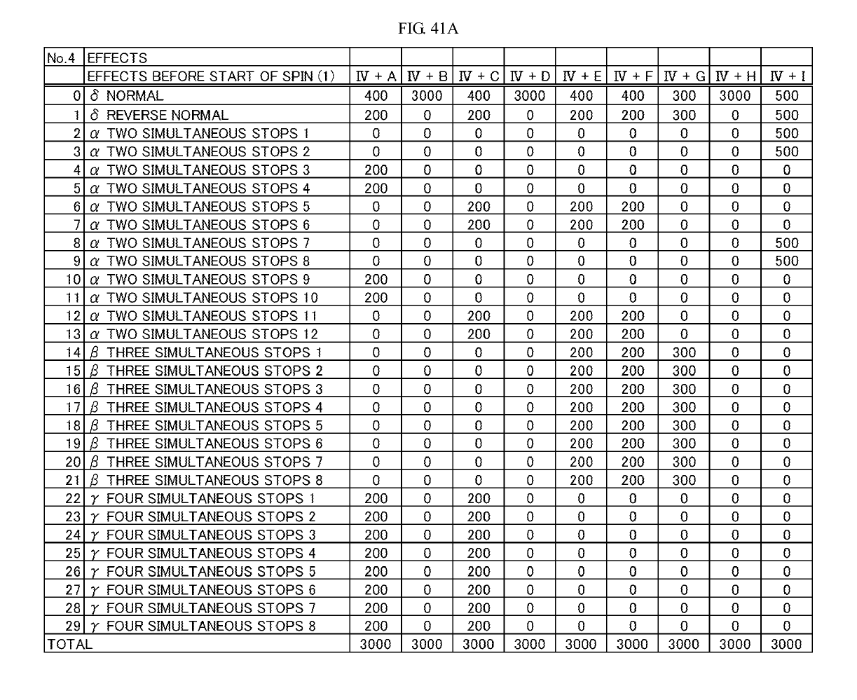

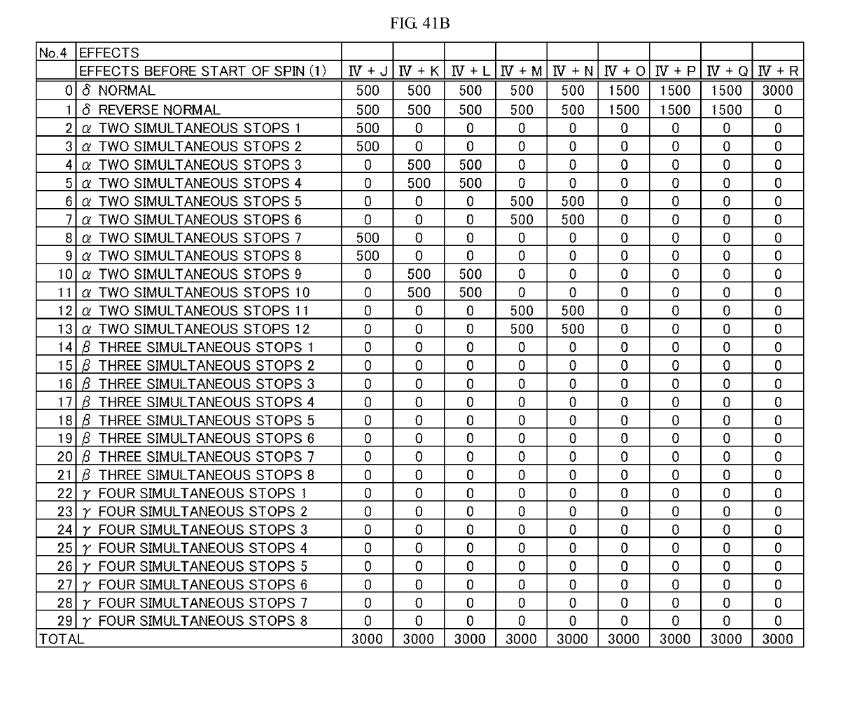

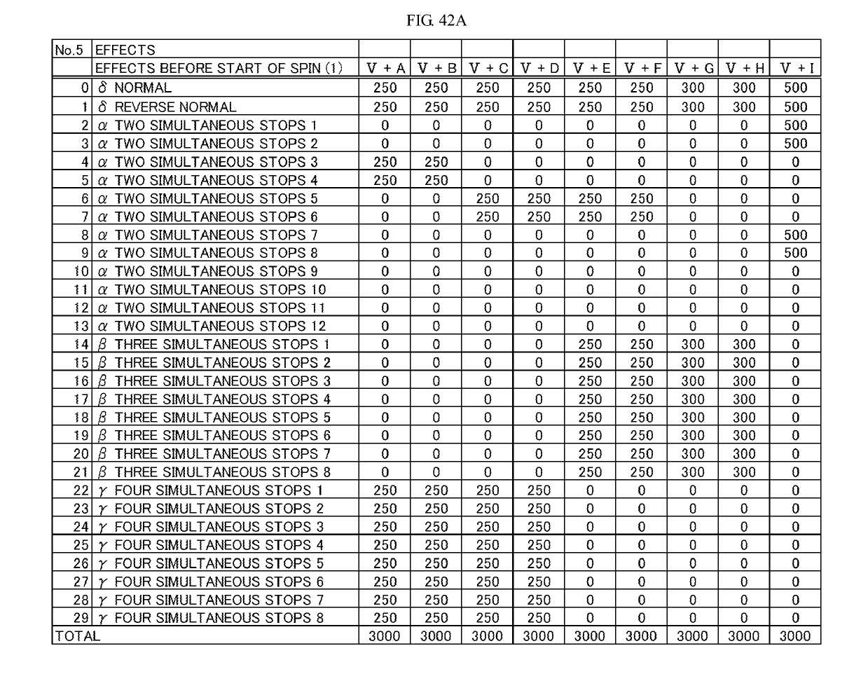

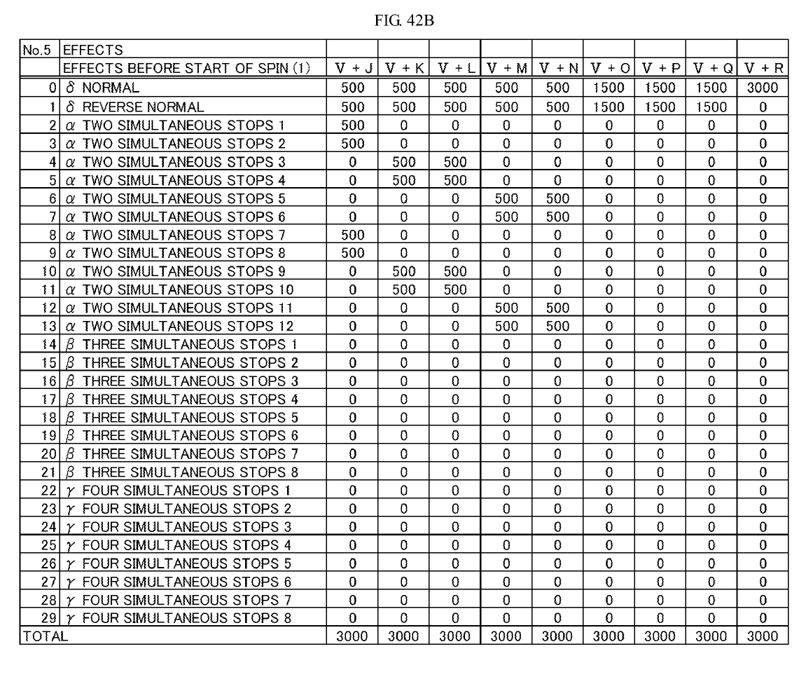

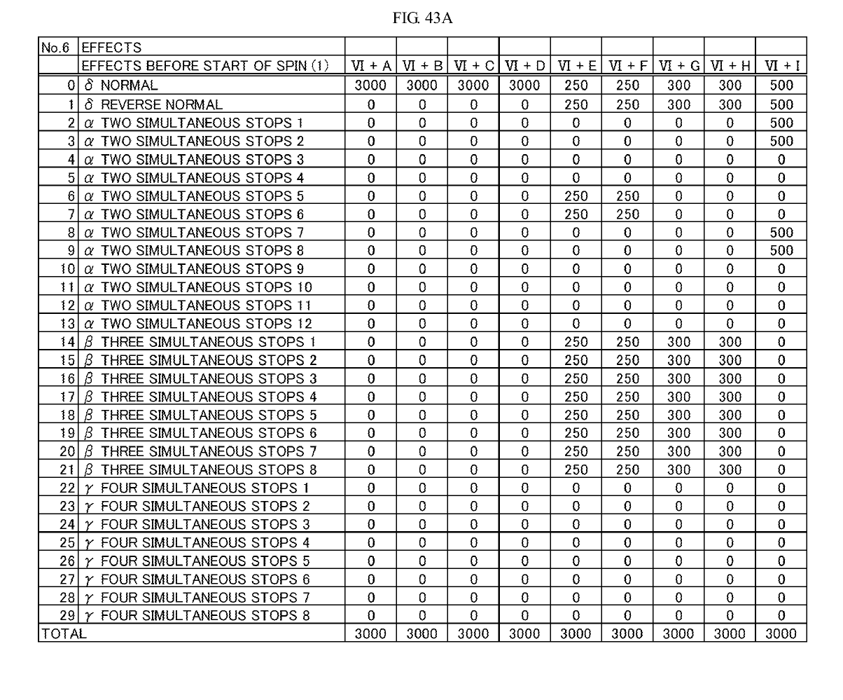

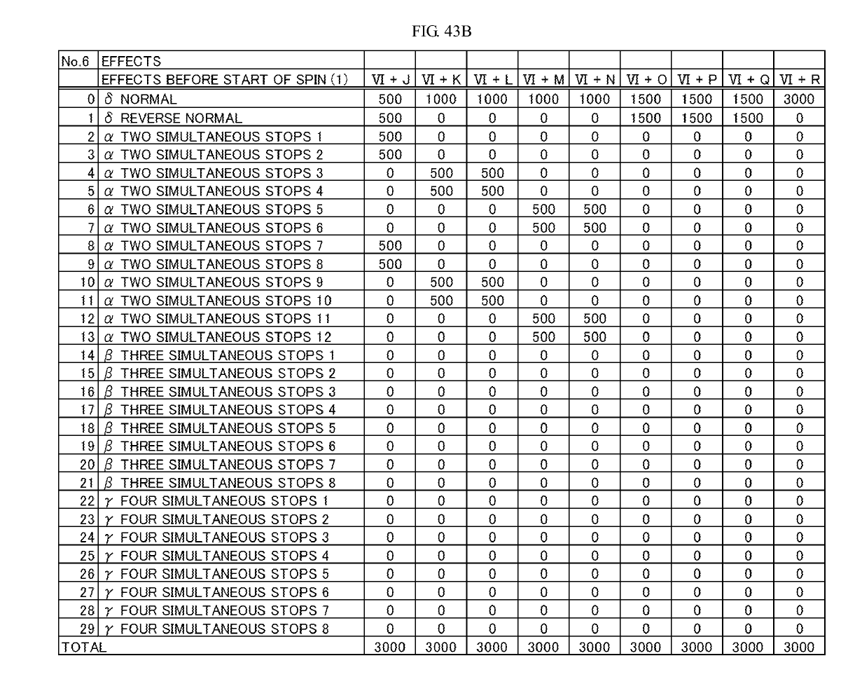

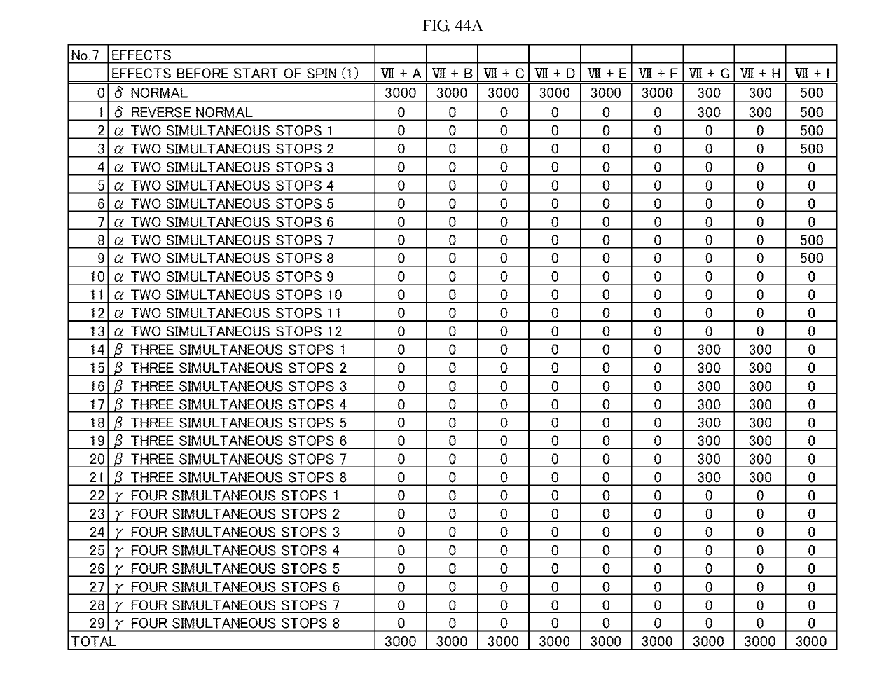

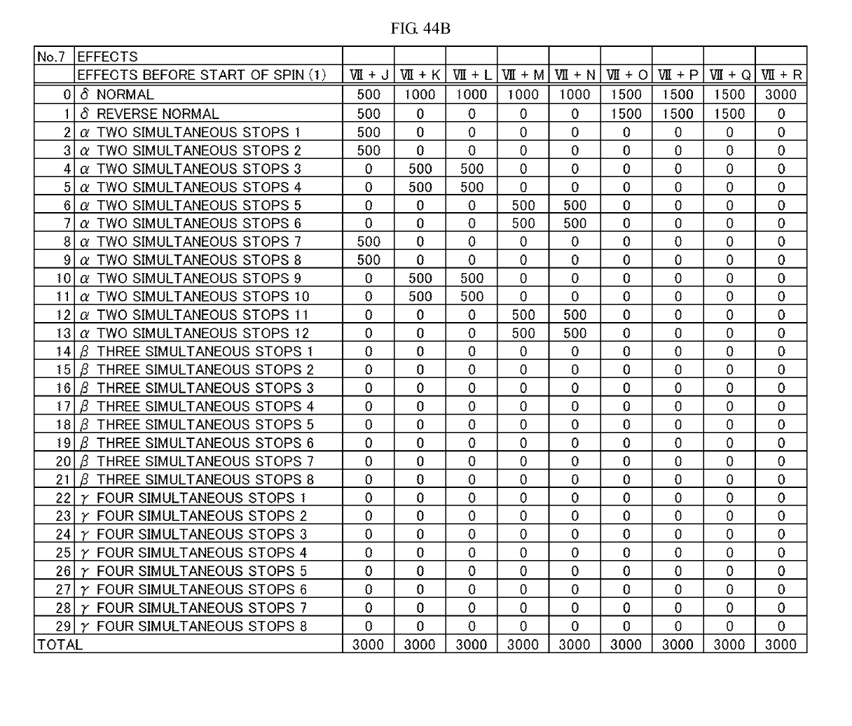

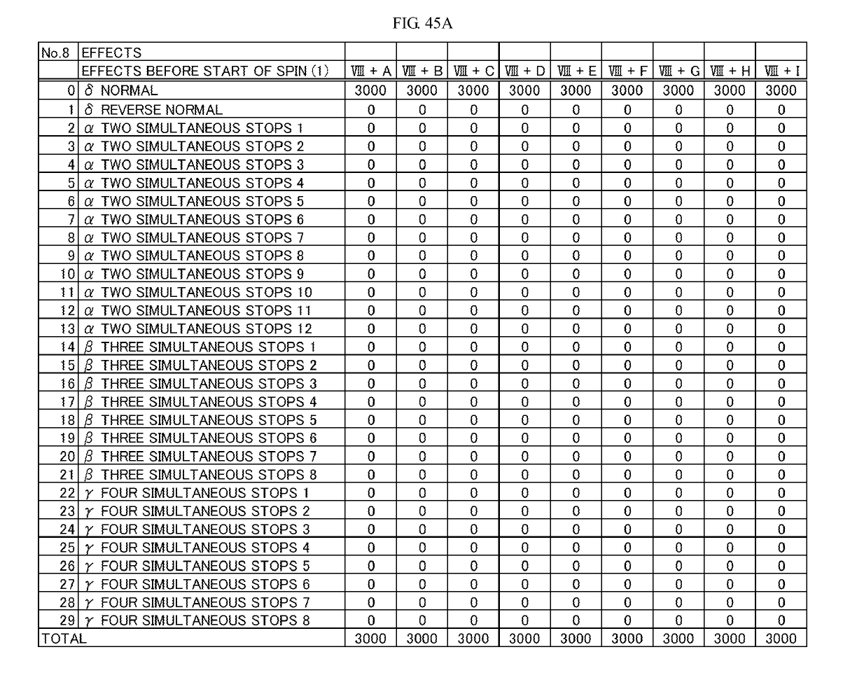

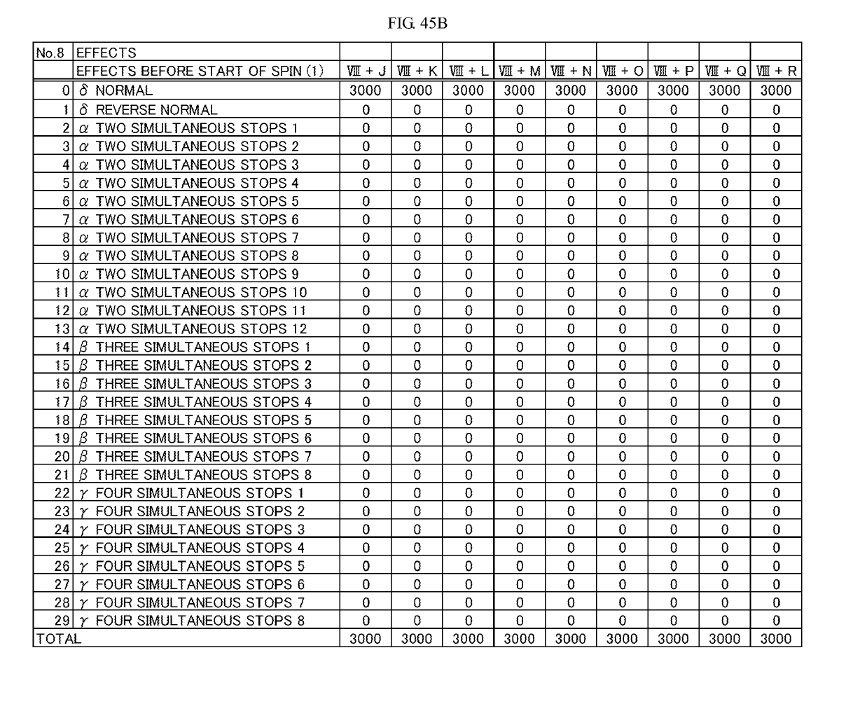

Likewise, FIGS. 39A and 39B are predictive effect lottery tables in the case where the first identifier is II; FIGS. 40A and 40B are predictive effect lottery tables in the case where the first identifier is III; FIGS. 41A and 41B are predictive effect lottery tables in the case where the first identifier is IV; FIGS. 42A and 42B are predictive effect lottery tables in the case where the first identifier is V; FIGS. 43A and 43B are predictive effect lottery tables in the case where the first identifier is VI; FIGS. 44A and 44B are predictive effect lottery tables in the case where the first identifier is VII; and FIGS. 45A and 45B are predictive effect lottery tables in the case where the first identifier is VIII.

### <<Li-Zhi Effect Lottery Tables>>

FIGS. 46A-1 to 53B-2 are li-zhi effect lottery tables for determining li-zhi effects. The li-zhi effect lottery tables illustrated in FIGS. 46A-1 to 53B-2 are tables to be used in the base game mode. Li-zhi effect lottery tables to be used in the free game mode are also defined (not shown). These tables are stored in the RAM 226.

As described above, li-zhi effects are produced by motion of the reels from the intermediate state where at least one of the five reels M3a to M3e is stopped and the remaining reels keep spinning until all the five reels M3a to M3e are stopped.

A li-zhi effect lottery table is selected based on three of the Kind number, the stop pattern, and the predictive effects. The Kind number determines a first identifier. There are eight identifiers of I to VIII for the first identifiers. The stop pattern determines a second identifier. There are eighteen identifiers of Table A to Table R for the second identifiers. The predictive effects determine a third identifier. There are four identifiers of α, β, γ, and δ for the third identifiers.

The eight li-zhi effect lottery tables in FIGS. 46A-1 to 49B-2 are li-zhi effect lottery tables in the case where the third identifier is α. The eight li-zhi effect lottery tables in FIGS. 50A-1 to 53B-2 are li-zhi effect lottery tables in the case where the third identifier is β. Although FIGS. 46A-1 to 53B-2 show the li-zhi effect lottery tables in the cases where the third identifiers are α and β, li-zhi effect lottery tables in the cases of γ and δ are likewise defined and stored in the RAM 226.

There are thirteen kinds of li-zhi effects for the li-zhi effects defined by the li-zhi effect lottery tables in FIGS. 46A-1 to 49B-2: α normal, α frame-by-frame forwarding 1 (in rotation from the leftmost li-zhi reel), α frame-by-frame forwarding 2 (all li-zhi reels together), α frame-by-frame forwarding 3 (repeated back and forth), α slow and fast together, α high-speed simultaneous stop, α high to super-high speed, α low to super-low speed random stop, α low-speed repeated back and forth, α low-speed spin together, α stock 1, α stock 2, and α stock 3. These kinds of li-zhi effects are to determine the motion of the remaining three reels M3 after two of the five reels M3a to M3e are stopped in the predictive effects.

The li-zhi effect lottery tables in FIGS. 46A-1 to 49B-2 define the weights of the above-described thirteen kinds of li-zhi effects in relation to the eight first identifiers (I to VIII) and eighteen second identifiers (Table A to Table R). Determining one of the first identifiers (I to VIII), determining one of the second identifiers (Table A to Table R), and determining one of the third identifiers (α, β, γ, and δ) lead to determination of one li-zhi effect lottery table. The main CPU 222 can determine one kind of li-zhi effects by generating a random number and referring to the determined li-zhi effect lottery table.

There are thirteen kinds of li-zhi effects for the li-zhi effects defined by the li-zhi effect lottery tables in FIGS. 50A-1 to 53B-2: β normal, β frame-by-frame forwarding 4 (in alternate between left and right li-zhi reels), β frame-by-frame forwarding 5 (all li-zhi reels together), β frame-by-frame forwarding 6 (repeated back and forth), β slow and fast together, β high-speed simultaneous stop, β high to super-high speed, β low to super-low speed random stop, β low-speed repeated back and forth, β low-speed spin together, β stock 4, β stock 5, and β stock 6. These kinds of li-zhi effects are to determine the motion of the remaining two reels M3 after three of the five reels M3a to M3e are stopped in the predictive effects.

The li-zhi effect lottery tables in FIGS. 50A-1 to 53B-2 define the weights of the above-described thirteen kinds of li-zhi effects in relation to the eight first identifiers (I to VIII) and eighteen second identifiers (Table A to Table R). Determining one of the first identifiers (I to VIII), determining one of the second identifiers (Table A to Table R), and determining one of the third identifiers (α, β, γ, and δ) lead to determination of one li-zhi effect lottery table. The main CPU 222 can determine one kind of li-zhi effects by generating a random number and referring to the determined li-zhi effect lottery table.

FIGS. 46A-1, 46A-2, 50A-1 and 50A-2 are tables defining the weights of the thirteen kinds of li-zhi effects for Table A to Table R in the case where the first identifier is I.

In similar, FIGS. 46B-1, 46B-2, 50B-1 and 50B-2 are li-zhi effect lottery tables in the case where the first identifier is II; FIGS. 47A-1, 47A-2, 51A-1 and 51A-2 are li-zhi effect lottery tables in the case where the first identifier is III; FIGS. 47B-1, 47B-2, 51B-1 and 51B-2 are li-zhi effect lottery tables in the case where the first identifier is IV; FIGS. 48A-1, 48A-2, 52A-1 and 52A-2 are li-zhi effect lottery tables in the case where the first identifier is V; FIGS. 48B-1, 48B-2, 52B-1 and 52B-2 are li-zhi effect lottery tables in the case where the first identifier is VI; FIGS. 49A-1, 49A-2, 53A-1 and 53A-2 are li-zhi effect lottery tables in the case where the first identifier is VII; and FIGS. 49B-1, 49B-2, 53B-1 and 53B-2 are li-zhi effect lottery tables in the case where the first identifier is VIII.

Specific examples of the li-zhi effects (α, β, γ and δ) are described hereinafter. Selecting and performing the following kinds of li-zhi effects allow diverse reel motion variations based on the to-be stopped symbol matrix and predictive effects.

The frame-by-frame forwarding 1 (in rotation from the leftmost li-zhi reel) is effects of a series of actions of stopping all the remaining three spinning reels temporarily, forwarding the first reel by one frame, forwarding the second reel by one frame, forwarding the third reel by one frame, repeating the forwarding in the same order among the remaining three reels, and rearranging the to-be stopped symbols to form a final symbol matrix.

The frame-by-frame forwarding 2 (all li-zhi reels together) is effects of a series of actions of stopping all the remaining three spinning reels temporarily, forwarding these reels frame by frame together, and rearranging the to-be stopped symbols to form a final symbol matrix.

The frame-by-frame forwarding 3 (repeated back and forth) is effects of a series of actions of stopping all the remaining three spinning reels temporarily, slightly moving the reels back and forth repeatedly, forwarding the reels frame by frame, and rearranging the to-be stopped symbols to form a final symbol matrix.

The slow and fast together is effects of a series of actions as follows. First, the remaining three spinning reels are all stopped temporarily and then spun forward at high speed all together.

During the spin, the spinning speed of these three reels is changed to low speed when JACKPOTs are coming in the display window 150, and is returned to the high speed when the JACKPOTs have gone from the display window 150. After a predetermined time, to-be stopped symbols are rearranged to form a final symbol matrix.

Such actions make the player expect JACKPOTs to stop. Not only JACKPOTs but also symbols having a special feature, such as the BONUS, can be selected for the symbols to be shown on the slowly spinning reel.

The high-speed simultaneous stop is effects of a series of actions of spinning all the remaining three spinning reels at high speed and rearranging the to-be stopped symbols by simultaneously stopping the reels to form a final symbol matrix.

The high to super-high speed is effects of a series of actions of spinning all the remaining three spinning reels at high speed, further spinning the reels faster than the high speed, and rearranging the to-be stopped symbols by simultaneously stopping the reels to form a final symbol matrix.

The low to super-low speed random stop is effects of a series of actions of spinning all the remaining three spinning reels at low speed, further spinning the reels slower than the low speed, and rearranging the to-be stopped symbols by randomly stopping the reels to form a final symbol matrix.

The low-speed repeated back and forth is effects of a series of actions of spinning all the remaining three spinning reels back and forth repeatedly at low speed and rearranging the to-be stopped symbols to form a final symbol matrix.

The low-speed spin together is effects of a series of actions of spinning all the remaining three spinning reels at low speed and rearranging the to-be stopped symbols to form a final symbol matrix.

The high and low speed at random is effects of a series of actions of selecting one or more reels to be spun at high speed and one or more reels to be spun at low speed from the remaining three spinning reels, spinning the selected reels at high speed and low speed, and then rearranging the to-be stopped symbols to form a final symbol matrix.

The frame-by-frame forwarding 4 (in alternate between left and right li-zhi reels) is effects of a series of actions of stopping the remaining two spinning reels temporarily, forwarding the first reel by one frame, forwarding the second reel by one frame, repeating the forwarding in the same order, and rearranging the to-be stopped symbols to form a final symbol matrix.

The frame-by-frame forwarding 5 (all li-zhi reels together) is effects of a series of actions of stopping both the remaining two spinning reels temporarily, forwarding these reels frame by frame together, and rearranging the to-be stopped symbols to form a final symbol matrix.

The frame-by-frame forwarding 6 (repeated back and forth) is effects of a series of actions of stopping both the remaining two spinning reels temporarily, slightly moving the reels back and forth repeatedly, forwarding the reels frame by frame, and rearranging the to-be stopped symbols to form a final symbol matrix.

The slow and fast together is effects of a series of actions as follows. First, the remaining two spinning reels are both stopped temporarily and these two reels are spun forward at high speed together. During the spin, the spinning speed of these two reels is changed to low speed when JACKPOTs are coming in the display window 150, and is returned to the high speed when the JACKPOTs have gone from the display window 150. After a predetermined time, to-be stopped symbols are rearranged to form a final symbol matrix.

The high-speed simultaneous stop is effects of a series of actions of spinning both the remaining two spinning reels at high speed and rearranging the to-be stopped symbols by simultaneously stopping the reels to form a final symbol matrix.

The high to super-high speed is effects of a series of actions of spinning both of the remaining two spinning reels at high speed, further spinning the reels faster than the high speed, and rearranging the to-be stopped symbols by simultaneously stopping the reels to form a final symbol matrix.

The low to super-low speed random stop is effects of a series of actions of spinning both of the remaining two spinning reels at low speed, further spinning the reels slower than the low speed, and rearranging the to-be stopped symbols by randomly stopping the reels to form a final symbol matrix.

The low-speed repeated back and forth is effects of a series of actions of spinning both the remaining two spinning reels back and forth repeatedly at low speed and rearranging the to-be stopped symbols to form a final symbol matrix.

The low-speed spin together is effects of a series of actions of spinning both the remaining two spinning reels at low speed and rearranging the to-be stopped symbols to form a final symbol matrix.

The high and low speed at random is effects of a series of actions of randomly selecting one reel to be spun at high speed from the remaining two spinning reels, spinning the selected reel at high speed and spinning the other reel at low speed, and then rearranging the to-be stopped symbols to form a final symbol matrix.

The frame-by-frame forwarding 7 (one by one) is effects of a series of actions of stopping the remaining one spinning reel temporarily, forwarding the reel frame by frame, and rearranging the to-be stopped symbol to form a final symbol matrix.

The frame-by-frame forwarding 8 (repeated back and forth) is effects of a series of actions of stopping the remaining one spinning reel temporarily, slightly moving the reel back and forth repeatedly, forwarding the reel frame by frame, and rearranging the to-be stopped symbol to form a final symbol matrix.

The slow and fast is effects of a series of actions as follows. First, the remaining one spinning reel is stopped temporarily and the reel is spun forward at high speed. During the spin, the spinning speed of the reel is changed to low speed when the JACKPOTs are coming in the display window 150, and is returned to the high speed when the JACKPOTs have gone from the display window 150. After a predetermined time, the to-be stopped symbol is rearranged to form a final symbol matrix.

The high to super-high speed is effects of a series of actions of spinning the remaining one spinning reel at high speed, further spinning the reel faster than the high speed, and rearranging the to-be stopped symbol to form a final symbol matrix.

The low to super-low speed is effects of a series of actions of spinning the remaining one spinning reel at low speed, further spinning the reel slower than the low speed, and rearranging the to-be stopped symbol to form a final symbol matrix.

The low-speed repeated back and forth is effects of a series of actions of spinning the remaining one spinning reel back and forth repeatedly at low speed and rearranging the to-be stopped symbol to form a final symbol matrix.

The high to super-high speed into super-low, low, middle, high to super high speed is effects of a series of actions of spinning the remaining one spinning reel at high speed, further spinning the reel faster than the high speed, thereafter spinning the reel while changing the spinning speed to super-low speed, low speed, middle speed, high speed, and then super-high speed, and rearranging the to-be stopped symbol to form a final symbol matrix.

The high and low speed at random is effects of a series of actions of randomly selecting one or more reels to be spun at high speed and low speed, spinning the selected reels at high speed and low speed, and rearranging the to-be stopped symbols to form a final symbol matrix.

The high-speed spin together is effects of a series of actions of spinning all the remaining spinning reels at high speed and rearranging the to-be stopped symbols to form a final symbol matrix.

The super-low speed random stop is effects of a series of actions of randomly selecting one or more reels to be spun at super-low speed, spinning the selected reels at super-low speed, and rearranging the to-be stopped symbols to form a final symbol matrix.

The low-speed spin together is effects of a series of actions of spinning all the remaining spinning reels at low speed and rearranging the to-be stopped symbols to form a final symbol matrix.

The high-speed simultaneous stop is effects of a series of actions of spinning all the remaining spinning reels at high speed and rearranging the to-be stopped symbols by simultaneously stopping the reels to form a final symbol matrix.

The frame-by-frame forwarding 9 (current frame-by-frame forwarding) is effects of a series of actions of forwarding all the remaining spinning reels frame by frame and rearranging the to-be stopped symbols to form a final symbol matrix.

The slow and fast is effects of a series of actions as follows. First, all the remaining spinning reels are stopped temporarily and are spun forward at high speed all together. During the spin, the spinning speed of all the reels is changed to low speed when JACKPOTs are coming in the display window 150, and is returned to the high speed when the JACKPOTs have gone from the display window 150. After a predetermined time, to-be stopped symbols are rearranged to form a final symbol matrix.

The high to super-high speed is effects of a series of actions of spinning all the remaining spinning reels at high speed, further spinning the reels faster than the high speed, and rearranging the to-be stopped symbols by simultaneously stopping the reels to form a final symbol matrix.

The low to super-low speed stop is effects of a series of actions of spinning all the remaining spinning reels at low speed, further spinning the reels slower than the low speed, and rearranging the to-be stopped symbols by simultaneously stopping the reels to form a final symbol matrix.

The high and low speed at random is effects of a series of actions of randomly selecting one or more reels to be spun at high speed and one or more reels to be spun at low speed from the remaining spinning reels, spinning the selected reels at high speed and low speed, and then rearranging the to-be stopped symbols to form a final symbol matrix.

<<<Specific Examples of Effects of Reel Actions>>>

Hereinafter, specific examples of effects of reel actions are described using FIGS. 54A to 57D.

### First Example

FIGS. 54A to 54E are views illustrating the first example of effects of reel actions. FIGS. 54A to 54E are views illustrating the actions of the five reels M3a to M3e in a single unit game.

This first example is a case where code No. 3 is determined for the reels M3a, M3b, M3d, and M3e and code No. 2 is determined for the reel M3c through symbol lottery processing. Accordingly, at the end of the unit game, symbols are rearranged as shown in FIG. 54E, where a JACKPOT, a BLANK, and a JACKPOT are respectively stopped on the top row, the middle row, and the bottom row of the reel M3a; a JACKPOT, a BLANK, and a JACKPOT are respectively stopped on the top row, the middle row, and the bottom row of the reel M3b; a BLANK, a JACKPOT, and a BLANK are respectively stopped on the top row, the middle row, and the bottom row of the reel M3c; a JACKPOT, a BLANK, and a JACKPOT are respectively stopped on the top row, the middle row, and the bottom row of the reel M3d; and a JACKPOT, a BLANK, and a JACKPOT are respectively stopped on the top row, the middle row, and the bottom row of the reel M3e.

### Predictive Effects in First Example

In this first example, the number of JACKPOTs is nine; accordingly, the first identifier is II (steps S2715 and S2717 in FIG. 27). The stop pattern of this example is position E; accordingly, the second identifier is Table E (steps S2827 and S2829 in FIG. 28 and FIG. 31A).

Since the first identifier is II and the second identifier is Table E as described above, the predictive effect lottery table II+E is selected (II+E in FIG. 39A). This predictive effect lottery table II+E is a predictive effect lottery table in which the weight of δ normal is defined as 120, the weight of δ reverse normal as 120, the weights of α two simultaneous stops 1 to α two simultaneous stops 12 as 50, the weights of β three simultaneous stops 1 to β three simultaneous stops 8 as 270, and the weights of γ four simultaneous stops 1 to γ four simultaneous stops 8 as 0. A lottery with reference to this predictive effect lottery table II+E leads to determination of one kind of predictive effects.

For example, a lottery with reference to this predictive effect lottery table II+E draws β three simultaneous stops 1. Selecting this β three simultaneous stops 1 determines the third identifier to be β.

Upon start of the unit game, all the five reels M3a to M3e spin as shown in FIG. 54A.

When a predetermined time has passed, a JACKPOT, a BLANK, and a JACKPOT are stopped on the top row, the middle row, and the bottom row of the reel M3b; a BLANK, a JACKPOT, and a BLANK are stopped on the top row, the middle row, and the bottom row of the reel M3c; and a JACKPOT, a BLANK, and a JACKPOT are stopped on the top row, the middle row, and the bottom row of the reel M3d as shown in FIG. 54B. The remaining two reels M3a and M3e do not stop and still keep spinning. This state is an intermediate state.

In this intermediate state, three reels M3b to M3d are stopped. As to these reels M3b to M3d, to-be stopped symbols are rearranged and the final symbol matrix is partially formed (see FIGS. 54B and 54E).

### <Li-Zhi Effects in First Example>

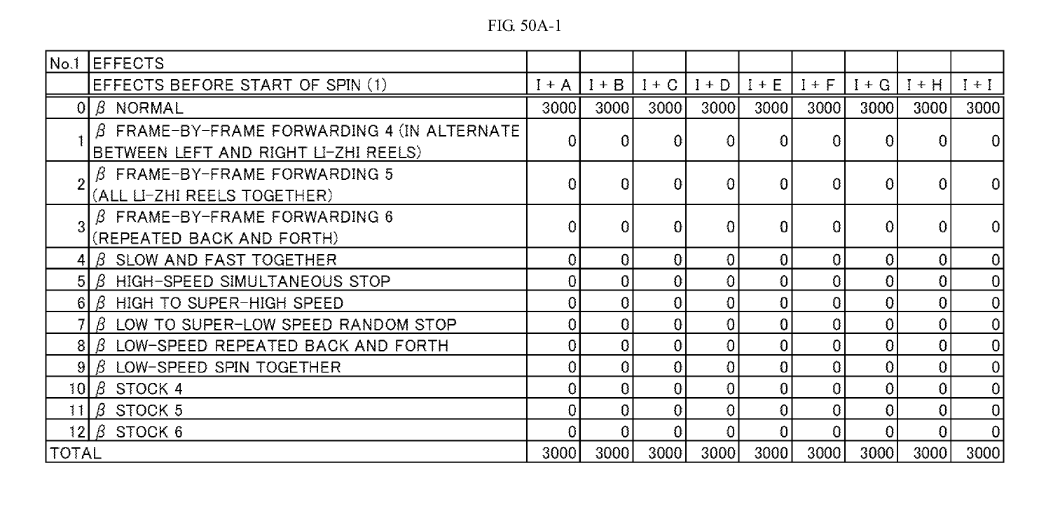

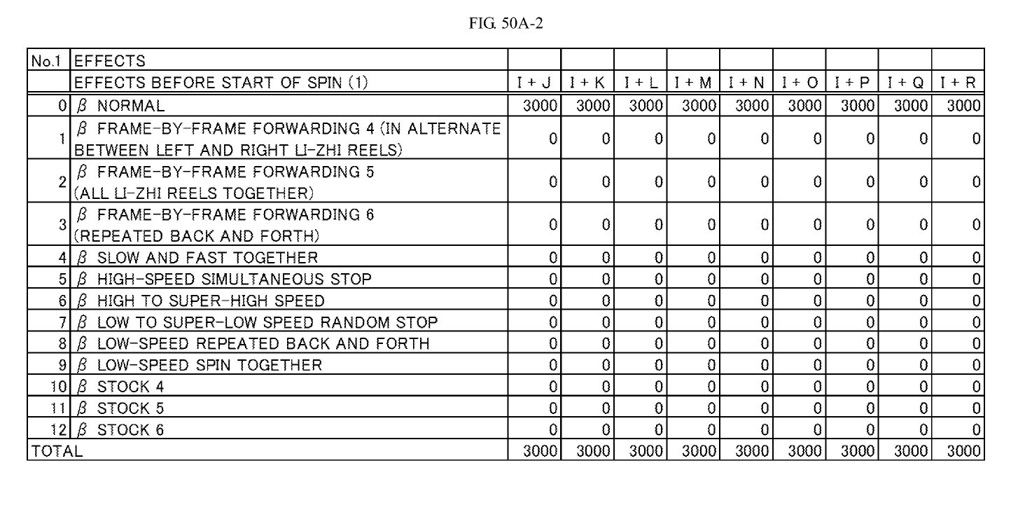

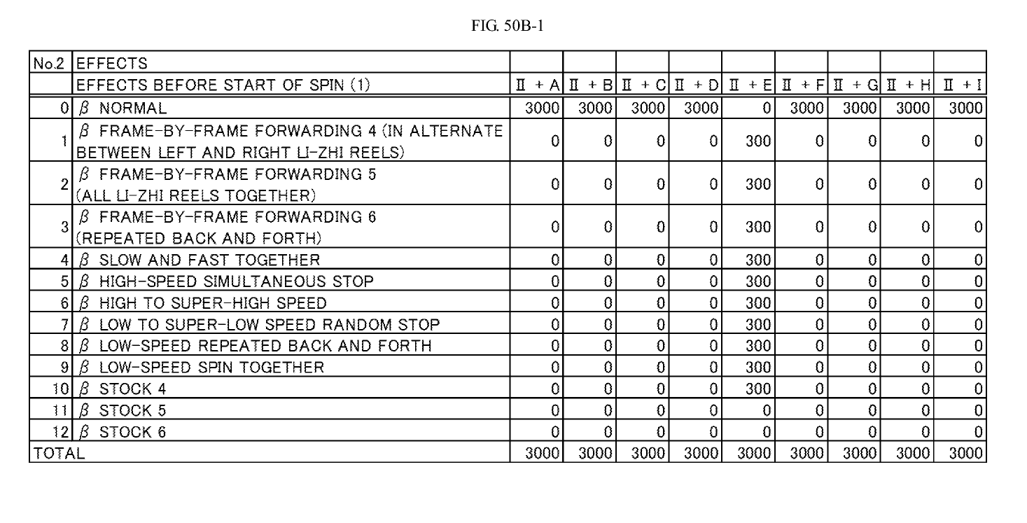

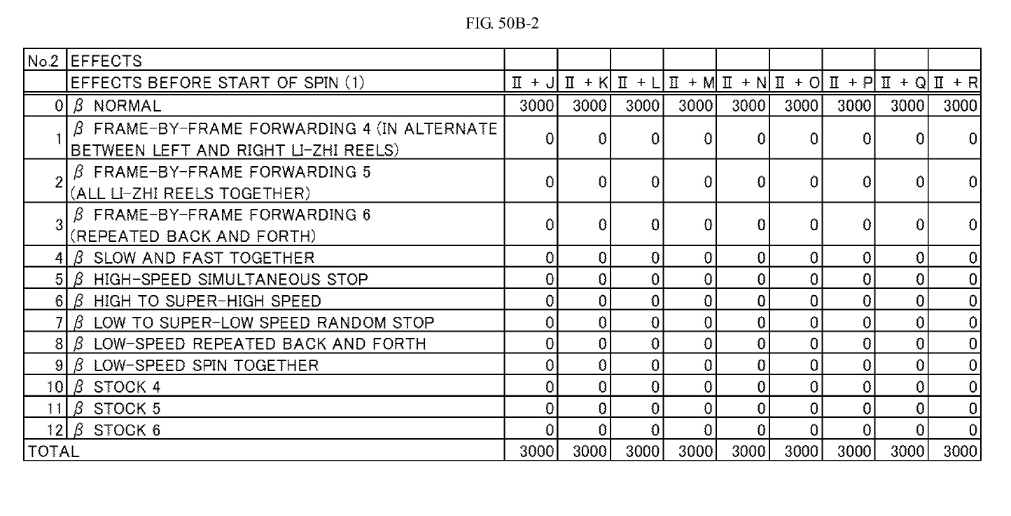

As described above, the first identifier is II and the second identifier is Table E in the first example. Further, the third identifier is determined to be β by selecting β three simultaneous stops 1. Accordingly, the li-zhi effect lottery table II+E of FIG. 50B-1 is selected.

The li-zhi effect lottery table II+E of FIG. 50B-1 is a lottery table in which the weight of β normal is defined as 0, the weight of β frame-by-frame forwarding 4 (in alternate between left and right li-zhi reels) as 300, β frame-by-frame forwarding 5 (all li-zhi reels together) as 300, β frame-by-frame forwarding 6 (repeated back and forth) as 300, the weight of β slow and fast together as 300, the weight of β high-speed simultaneous stop as 300, the weight of β high to super-high speed as 300, the weight of β low to super-low speed random stop as 300, the weight of β repeated slow up and down as 300, the weight of β low-speed spin together as 300, the weight of β stock 4 as 300, the weight of β stock 5 as 0, and the weight of β stock 6 as 0.

For example, assume that a lottery with reference to the li-zhi effect lottery table II+E in FIG. 50B-1 results in selection of β frame-by-frame forwarding 4 (in alternate between left and right li-zhi reels). In this case, after forwarding the reels M3a and M3e alternately by one frame is repeated, the aforementioned to-be stopped symbols are rearranged to form the final symbol matrix.

Accordingly, after the intermediate state shown in FIG. 54B, all the five reels M3a to M3e are temporarily stopped as shown in FIG. 54C.

Thereafter, the reels M3a and M3e are alternately forwarded by one frame as shown in FIG. 54D. The reel M3a is first forwarded by one frame and the reel M3e is next forwarded by one frame. The reels M3a and M3e are kept forwarded alternately one frame by one frame until the to-be stopped symbols are rearranged on the reels M3a and M3e.

As shown in FIG. 54E, a JACKPOT, a BLANK, and a JACKPOT are respectively stopped on the top row, the middle row, and the bottom row of the reel M3a; a JACKPOT, a BLANK, and a JACKPOT are respectively stopped on the top row, the middle row, and the bottom row of the reel M3b; a BLANK, a JACKPOT, and a BLANK are respectively stopped on the top row, the middle row, and the bottom row of the reel M3c; a JACKPOT, a BLANK, and a JACKPOT are respectively stopped on the top row, the middle row, and the bottom row of the reel M3d; and a JACKPOT, a BLANK, and a JACKPOT are respectively stopped on the top row, the middle row, and the bottom row of the reel M3e, forming the final symbol matrix. As a result, nine JACKPOTs are finally stopped in display and the unit game ends.

### Second Example

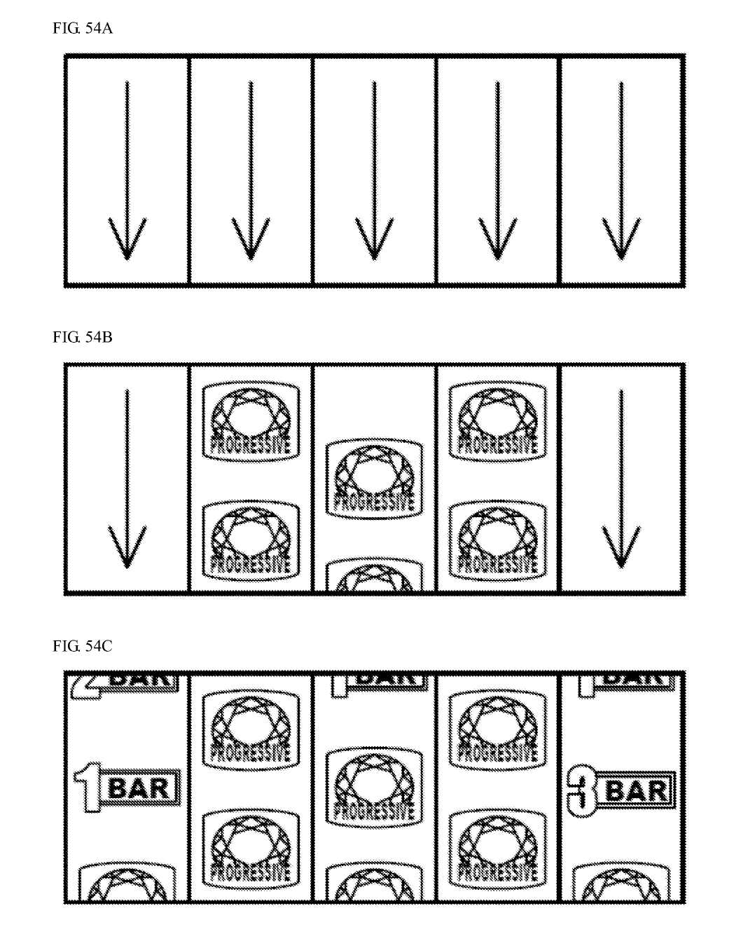

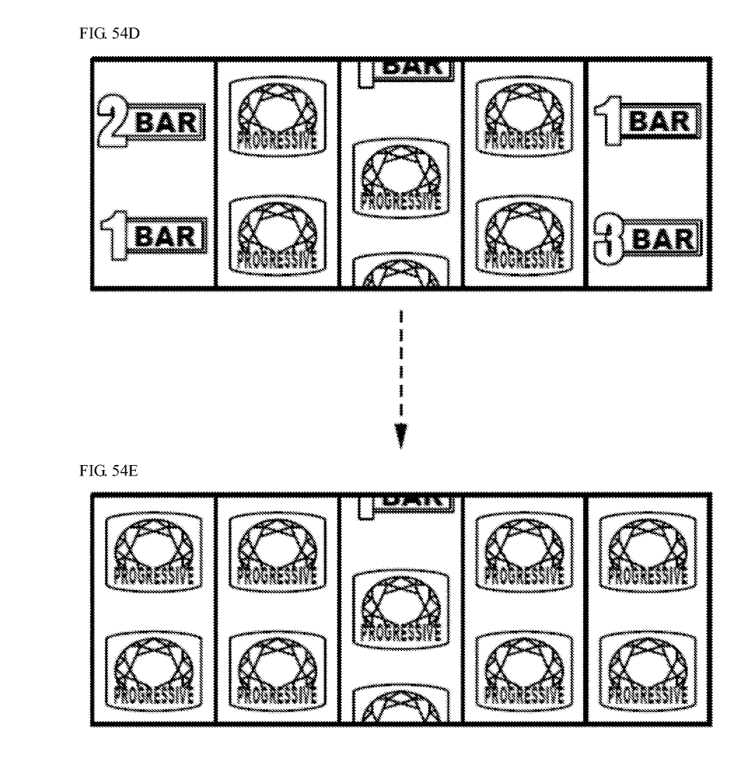

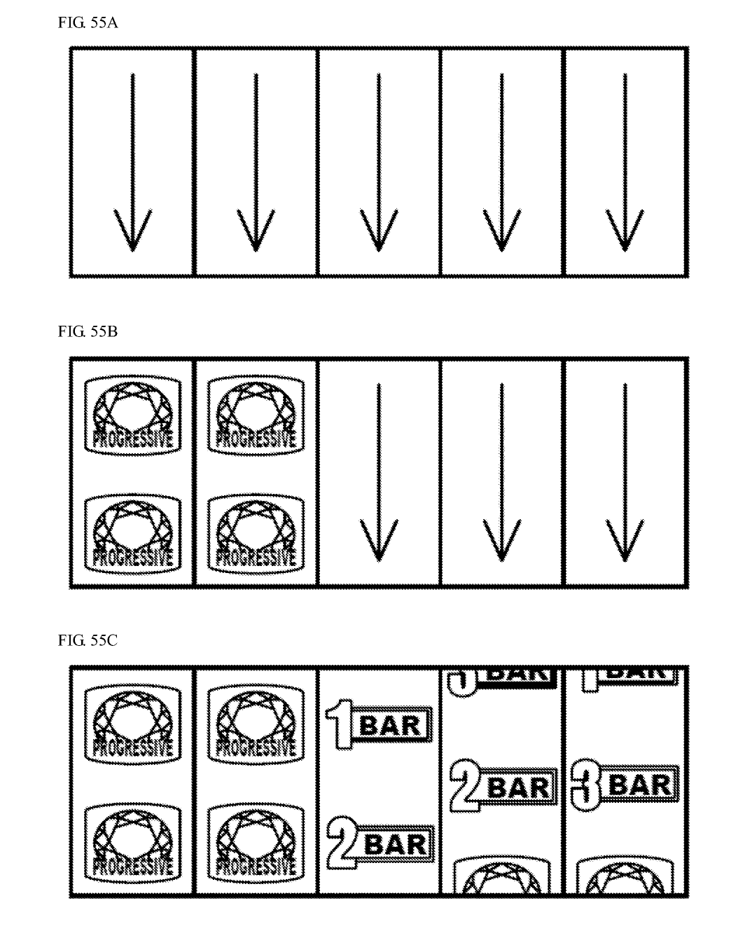

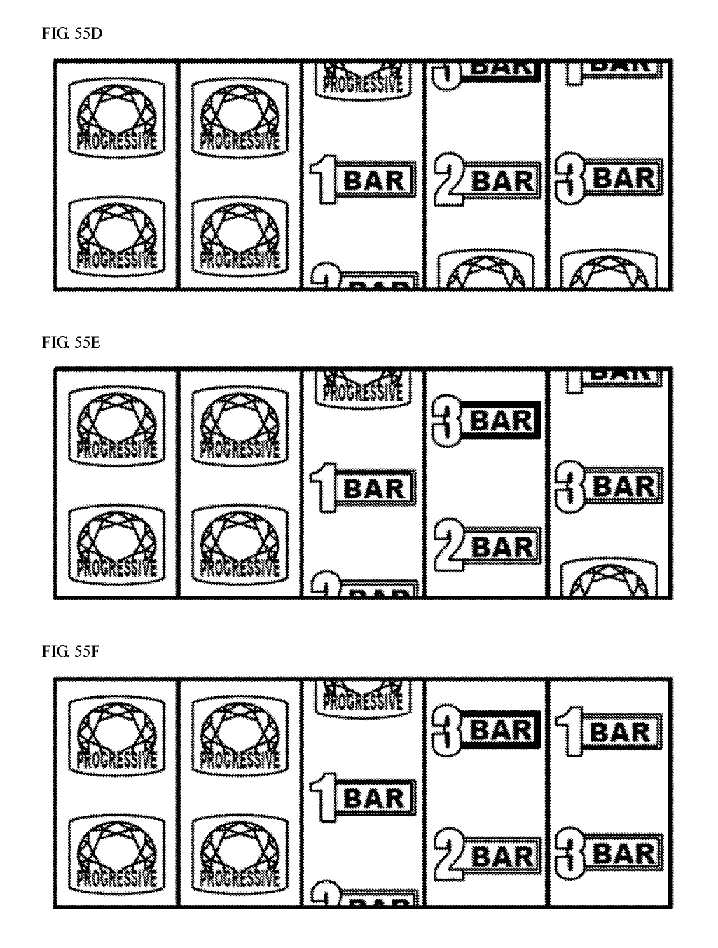

FIGS. 55A to 56C are views illustrating the second example of effects of reel actions. FIGS. 55A to 56C are views illustrating the actions of the five reels M3a to M3e in a single unit game, like the first example.

This second example is a case where code No. 3 is determined for the reels M3a, M3b, M3d, and M3e and code No. 2 is determined for the reel M3c through symbol lottery processing. Accordingly, at the end of the unit game, symbols are rearranged as shown in FIG. 56C, where a JACKPOT, a BLANK, and a JACKPOT are respectively stopped on the top row, the middle row, and the bottom row of the reel M3a; a JACKPOT, a BLANK, and a JACKPOT are respectively stopped on the top row, the middle row, and the bottom row of the reel M3b; a BLANK, a JACKPOT, and a BLANK are respectively stopped on the top row, the middle row, and the bottom row of the reel M3c; a JACKPOT, a BLANK, and a JACKPOT are respectively stopped on the top row, the middle row, and the bottom row of the reel M3d; and a JACKPOT, a BLANK, and a JACKPOT are respectively stopped on the top row, the middle row, and the bottom row of the reel M3e.

### Predictive Effects in Second Example

In this second example, the number of JACKPOTs is nine; accordingly, the first identifier is II (steps S2715 and S2717 in FIG. 27). The stop pattern of this example is position E; accordingly, the second identifier is Table E (steps S2827 and S2829 in FIG. 28 and FIG. 31A).

Since the first identifier is II and the second identifier is Table E as described above, the predictive effect lottery table II+E is selected (II+E in FIG. 39A). This predictive effect lottery table II+E is a predictive effect lottery table in which the weight of δ normal is defined as 120, the weight of δ reverse normal as 120, the weights of α two simultaneous stops 1 to α two simultaneous stops 12 as 50, the weights of β three simultaneous stops 1 to β three simultaneous stops 8 as 270, and the weights of γ four simultaneous stops 1 to γ four simultaneous stops 8 as 0. A lottery with reference to this predictive effect lottery table II+E leads to determination of one kind of predictive effects.

For example, assume that a lottery with reference to this predictive effect lottery table II+E draws α two simultaneous stops 1. Selecting this α two simultaneous stops 1 determines the third identifier to be α.

Upon start of the unit game, all the five reels M3a to M3e spin as shown in FIG. 55A.

When a predetermined time has passed, a JACKPOT, a BLANK, and a JACKPOT are stopped on the top row, the middle row, and the bottom row of the reel M3a and a JACKPOT, a BLANK, and a JACKPOT are stopped on the top row, the middle row, and the bottom row of the reel M3b as shown in FIG. 55B. The remaining three reels M3c, M3d, and M3e do not stop and still keep spinning. This state is an intermediate state.

In this intermediate state, two reels M3a and M3b are stopped. As to these reels M3a and M3b, to-be stopped symbols are rearranged and the final symbol matrix is partially formed (see FIGS. 55B and 56C).

### <Li-Zhi Effects in Second Example>

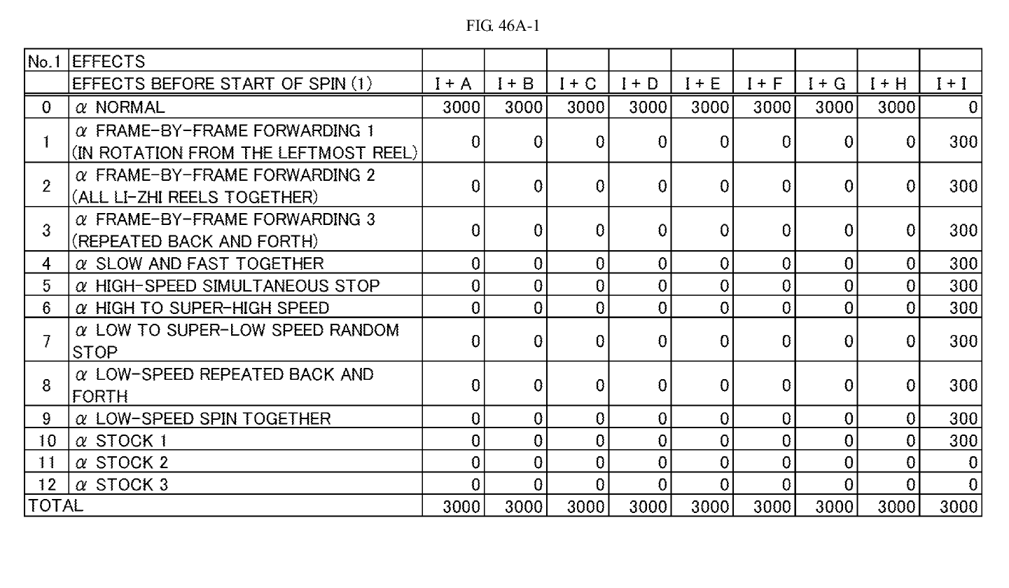

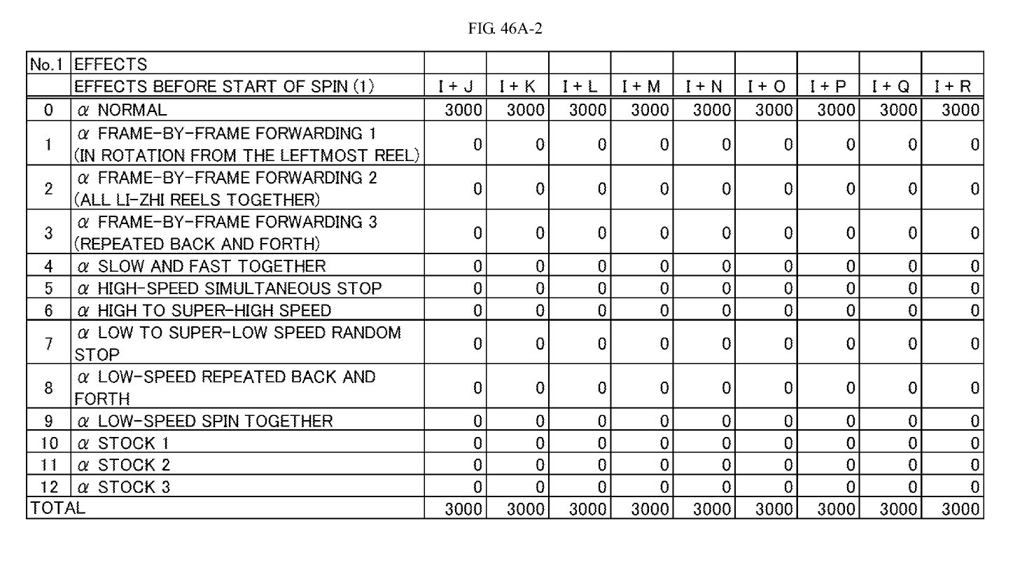

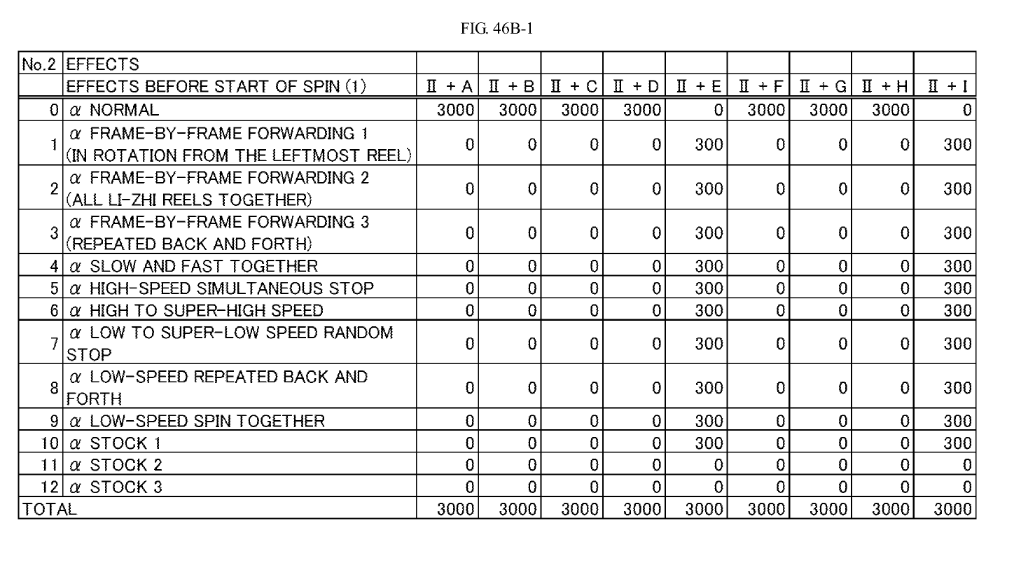

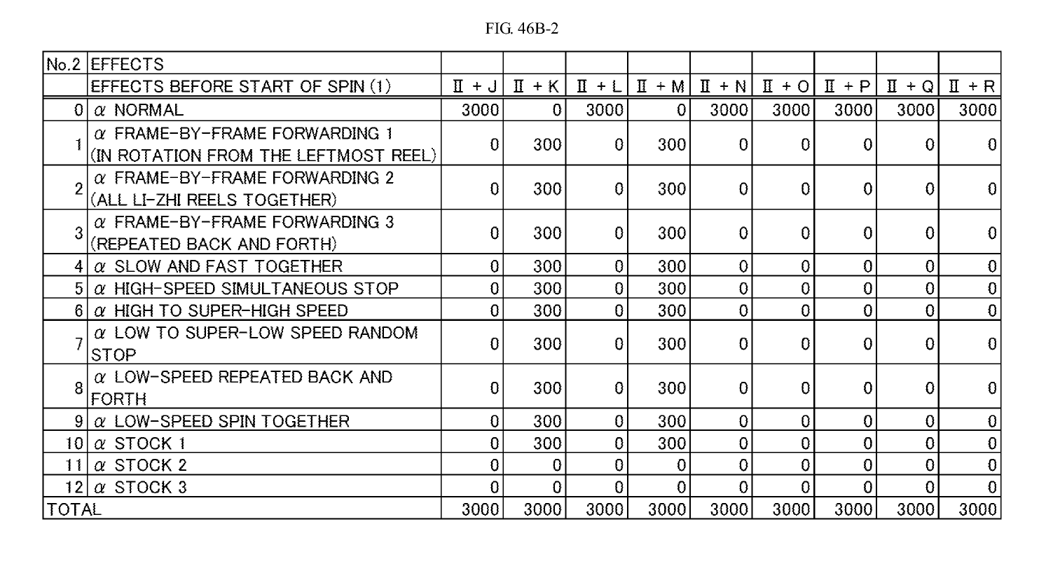

As described above, the first identifier is II and the second identifier is Table E in the second example. Further, the third identifier is determined to be α by selecting α two simultaneous stops 1. Accordingly, the li-zhi effect lottery table II+E of FIG. 46B-1 is selected.

The li-zhi effect lottery table II+E of FIG. 46B-1 is a lottery table in which the weight of α normal is defined as 0, the weight of α frame-by-frame forwarding 1 (in rotation from the leftmost li-zhi reel) as 300, α frame-by-frame forwarding 2 (all li-zhi reels together) as 300, α frame-by-frame forwarding 3 (repeated back and forth) as 300, the weight of α slow and fast together as 300, the weight of α high-speed simultaneous stop as 300, the weight of α high to super-high speed as 300, the weight of α low to super-low speed random stop as 300, the weight of α repeated slow up and down as 300, the weight of α low-speed spin together as 300, the weight of α stock 1 as 300, the weight of α stock 2 as 0, and the weight of α stock 3 as 0.

For example, assume that a lottery with reference to the li-zhi effect lottery table II+E in FIG. 46B-1 results in selection of α frame-by-frame forwarding 3 (repeated back and forth). In this case, after slightly moving the reels M3c, M3d, and M3e back and forth repeatedly, forwarding the reels M3c, M3d, and M3e in turn of this order by one frame is repeated until the to-be stopped symbols appear, and the aforementioned to-be stopped symbols are rearranged to form the final symbol matrix.

Accordingly, after the intermediate state shown in FIG. 55B, all the five reels M3a to M3e are temporarily stopped as shown in FIG. 55C.

Thereafter, the reels M3c, M3d, and M3e are forwarded in turn by one frame as shown in FIGS. 55D to 56B. The reel M3c is first forwarded by one frame (FIG. 55D); the reel M3d is next forwarded by one frame (FIG. 55E), and the reel M3e is then forwarded by one frame (FIG. 55F). The reels M3c, M3d, and M3e are kept forwarded in turn one frame by one frame until the to-be stopped symbols are rearranged on the reels M3d, M3d, and M3e (FIGS. 55G to 56B).

As shown in FIG. 56C, a JACKPOT, a BLANK, and a JACKPOT are respectively stopped on the top row, the middle row, and the bottom row of the reel M3a; a JACKPOT, a BLANK, and a JACKPOT are respectively stopped on the top row, the middle row, and the bottom row of the reel M3b; a BLANK, a JACKPOT, and a BLANK are respectively stopped on the top row, the middle row, and the bottom row of the reel M3c; a JACKPOT, a BLANK, and a JACKPOT are respectively stopped on the top row, the middle row, and the bottom row of the reel M3d; and a JACKPOT, a BLANK, and a JACKPOT are respectively stopped on the top row, the middle row, and the bottom row of the reel M3e, forming the final symbol matrix. AS a result, nine JACKPOTs are finally stopped in display and the unit game ends.

### Third Example

### Predictive Effects in Third Example

In the third example, the number of JACKPOTs is five; accordingly, the first identifier is VI (steps S2731 and S2733 in FIG. 27). The stop pattern of this example is position E; accordingly, the second identifier is Table E (steps S2827 and S2829 in FIG. 28 and FIG. 31A).

Since the first identifier is VI and the second identifier is Table E as described above, the predictive effect lottery table VI+E is selected (VI+E in FIG. 43A). This predictive effect lottery table VI+E is a predictive effect lottery table in which the weight of δ normal is defined as 250, the weight of δ reverse normal as 250, the weights of α two simultaneous stops 5 and α two simultaneous stops 6 as 250, and the weights of β three simultaneous stops 1 to β three simultaneous stops 8 as 250. A lottery with reference to this predictive effect lottery table VI+E leads to determination of one kind of predictive effects.

For example, assume that a lottery with reference to this predictive effect lottery table VI+E draws β three simultaneous stops 1. Selecting this β three simultaneous stops 1 determines the third identifier to be β.

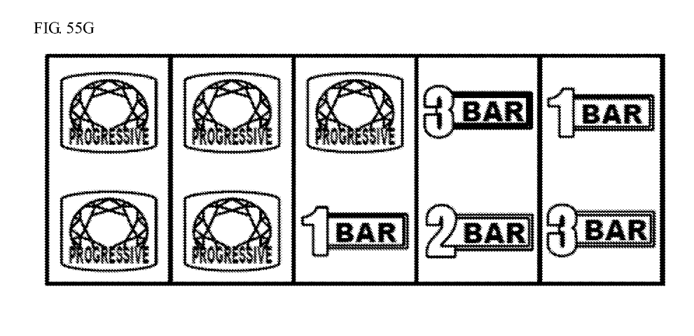

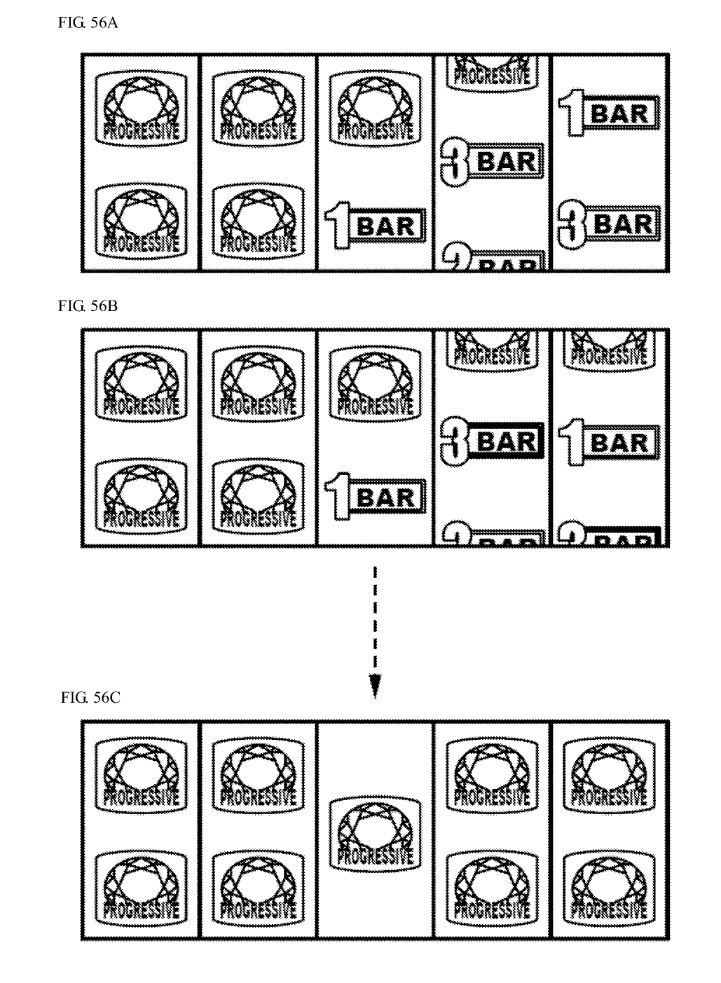

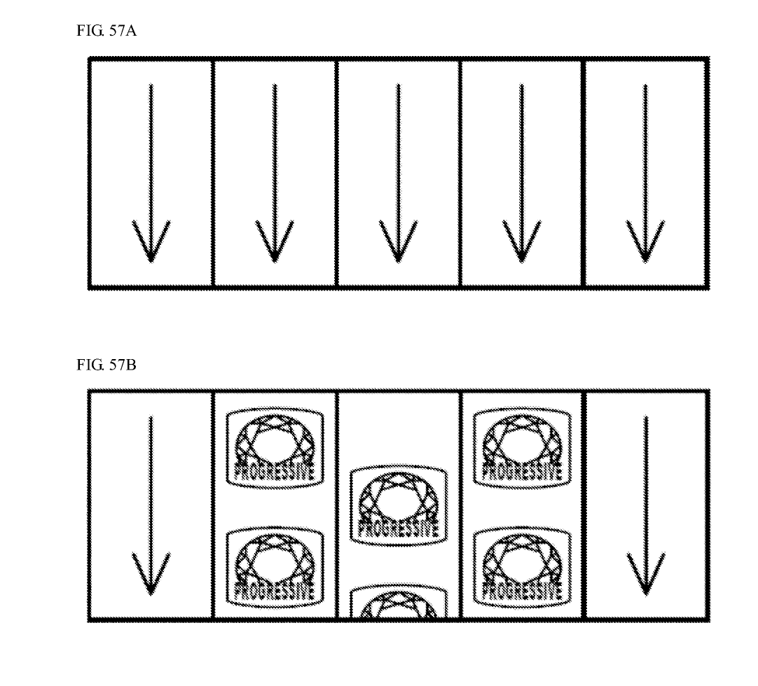

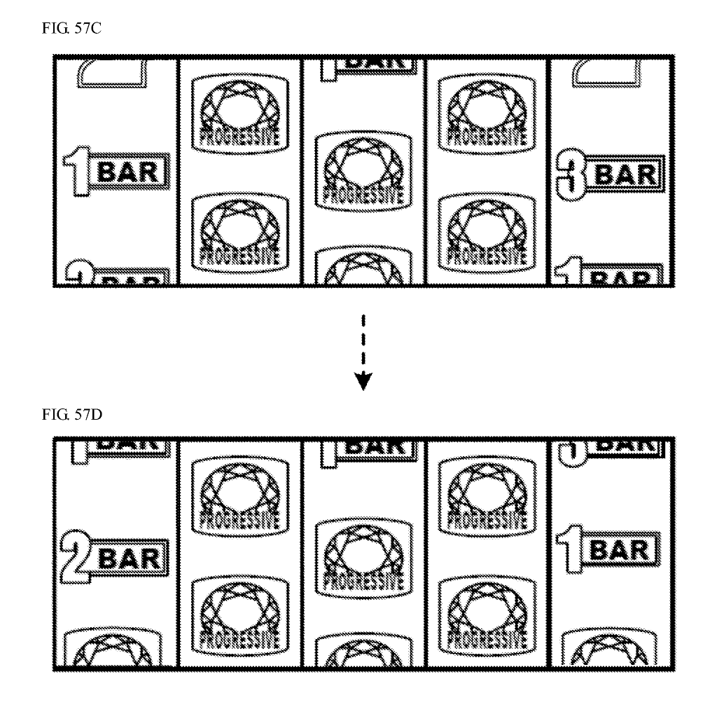

Upon start of the unit game, all the five reels M3a to M3e spin as shown in FIG. 57A.

When a predetermined time has passed, a JACKPOT, a BLANK, and a JACKPOT are stopped on the top row, the middle row, and the bottom row of the reel M3b; a BLANK, a JACKPOT, and a BLANK are stopped on the top row, the middle row, and the bottom row of the reel M3c; and a JACKPOT, a BLANK, and a JACKPOT are stopped on the top row, the middle row, and the bottom row of the reel M3d as shown in FIG. 57B. The remaining two reels M3a and M3e do not stop and still keep spinning. This state is an intermediate state.

In this intermediate state, three reels M3b to M3d are stopped. As to these reels M3b to M3d, to-be stopped symbols are rearranged and the final symbol matrix is partially formed (see FIGS. 57B and 57D).

### <Li-Zhi Effects in Third Example>

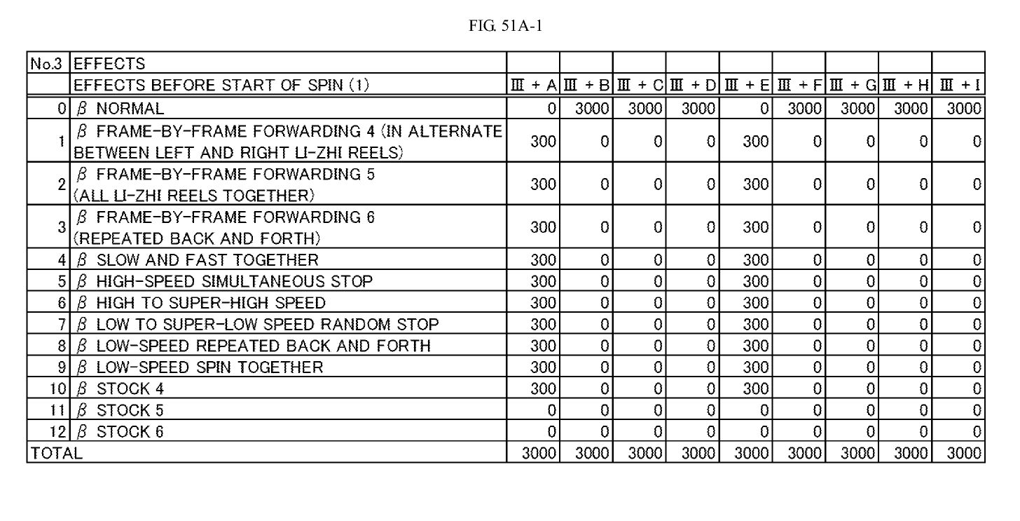

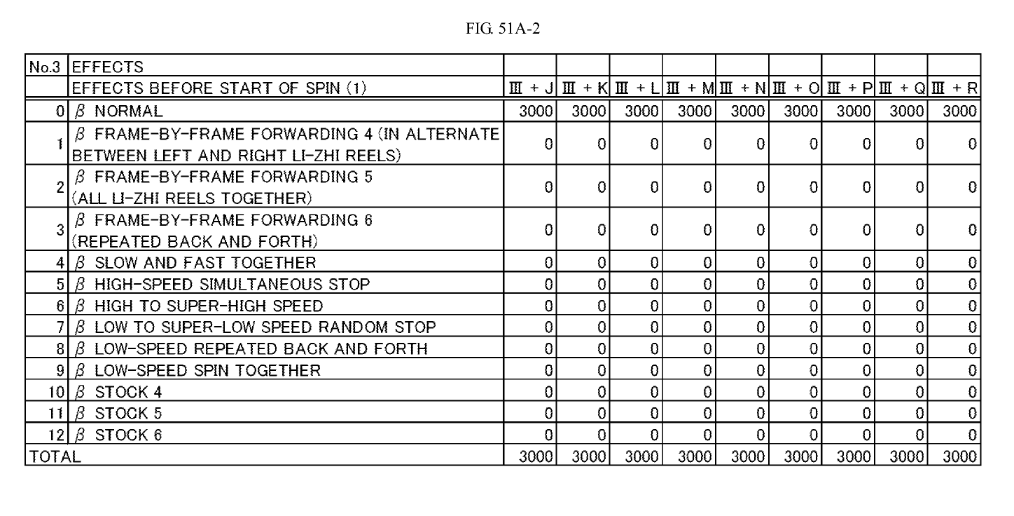

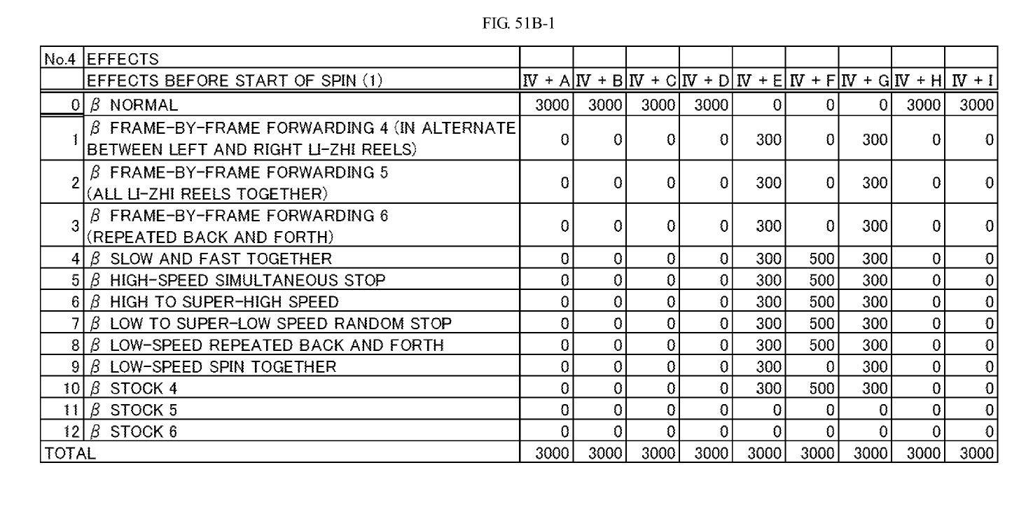

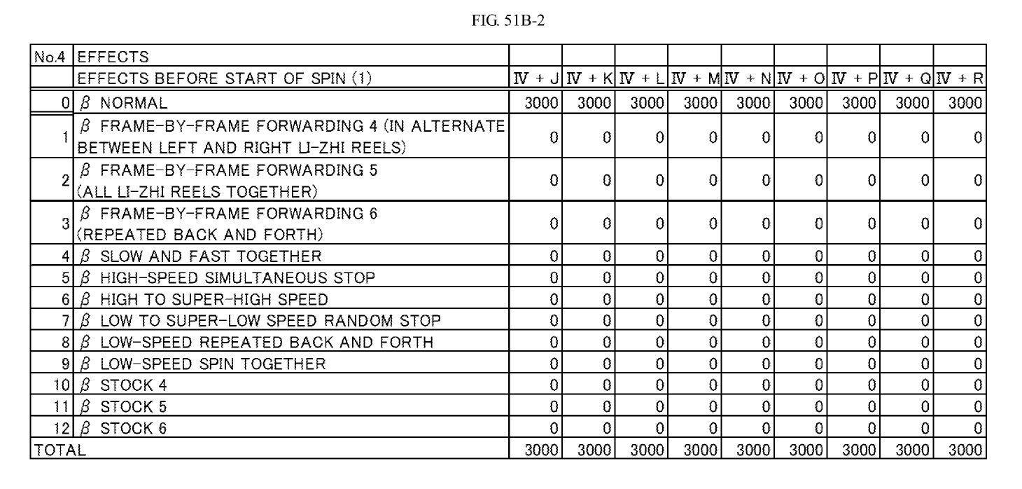

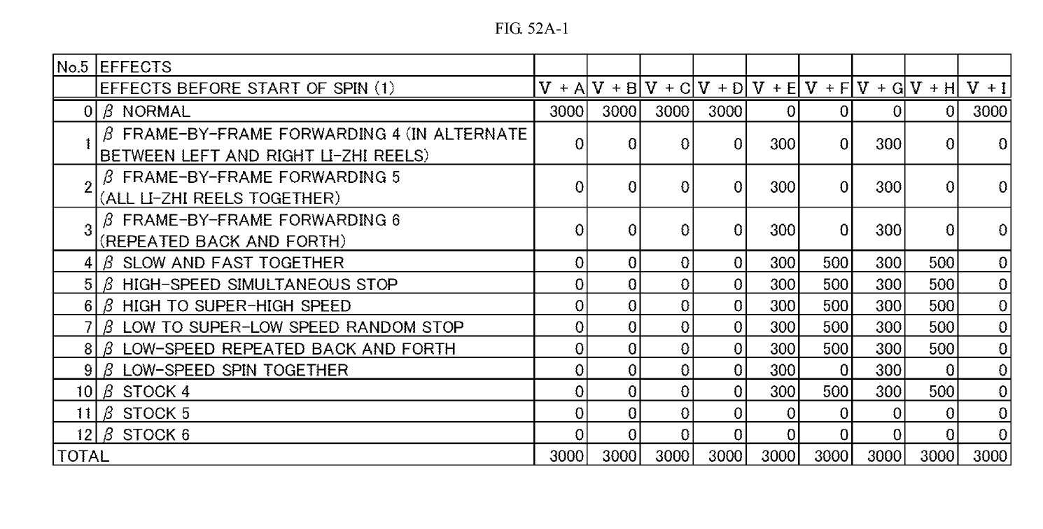

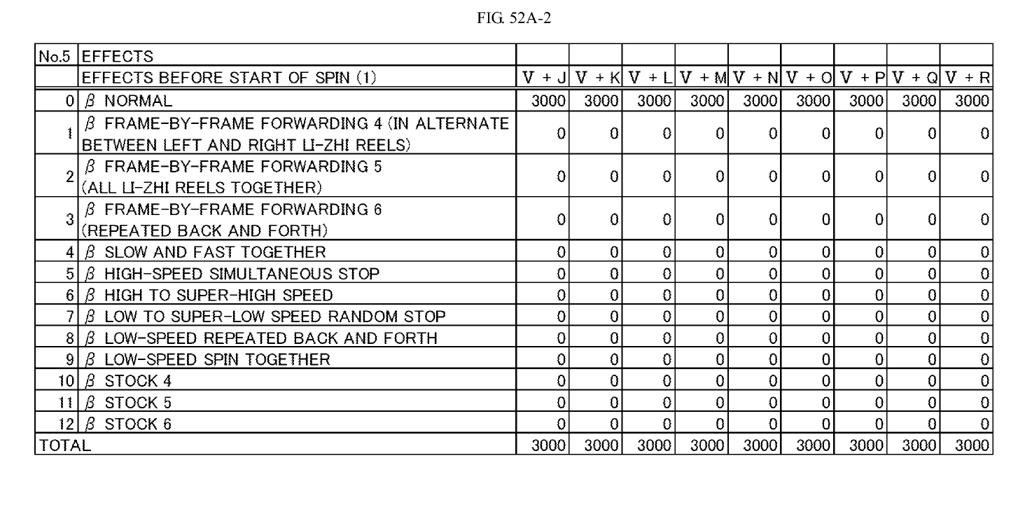

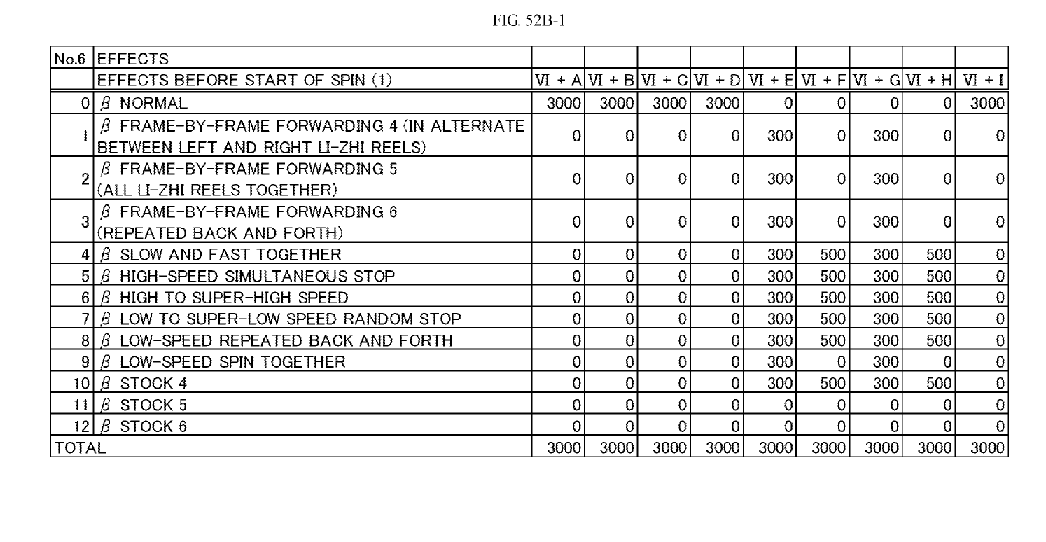

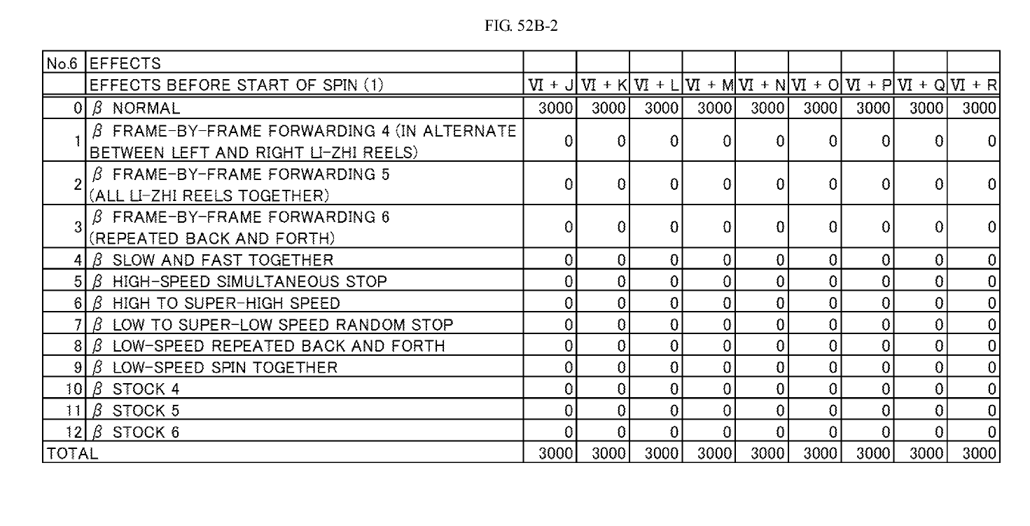

As described above, the first identifier is VI and the second identifier is Table E in the first example. Further, the third identifier is determined to be β by selecting β three simultaneous stops 1. Accordingly, the li-zhi effect lottery table VI+E of FIG. 52B-1 is selected.

The li-zhi effect lottery table VI+E of FIG. 52B-1 is a lottery table in which the weight of β normal is defined as 0, the weight of β frame-by-frame forwarding 4 (in alternate between left and right li-zhi reels) as 300, β frame-by-frame forwarding 5 (all li-zhi reels together) as 300, β frame-by-frame forwarding 6 (repeated back and forth) as 300, the weight of β slow and fast together as 300, the weight of β high-speed simultaneous stop as 300, the weight of β high to super-high speed as 300, the weight of β low to super-low speed random stop as 300, the weight of β repeated slow up and down as 300, the weight of β low-speed spin together as 300, the weight of β stock 4 as 300, the weight of β stock 5 as 0, and the weight of β stock 6 as 0.

For example, assume that a lottery with reference to the li-zhi effect lottery table VI+E in FIG. 52B-1 results in selection of β frame-by-frame forwarding 4 (in alternate between left and right li-zhi reels). In this case, after forwarding the reels M3a and M3e alternately by one frame is repeated, the aforementioned to-be stopped symbols are rearranged to form the final symbol matrix.

Accordingly, after the intermediate state shown in FIG. 57B, all the five reels M3a to M3e are temporarily stopped as shown in FIG. 57C.

Thereafter, the reels M3a and M3e are alternately forwarded by one frame. The reel M3a is first forwarded by one frame and the reel M3e is next forwarded by one frame. The reels M3a and M3e are kept forwarded alternately one frame by one frame until the to-be stopped symbols are rearranged on the reels M3a and M3e.

As shown in FIG. 57D, a BLANK, a 2BAR, and a BLANK are respectively stopped on the top row, the middle row, and the bottom row of the reel M3a; a JACKPOT, a BLANK, and a JACKPOT are respectively stopped on the top row, the middle row, and the bottom row of the reel M3b; a BLANK, a JACKPOT, and a BLANK are respectively stopped on the top row, the middle row, and the bottom row of the reel M3c; a JACKPOT, a BLANK, and a JACKPOT are respectively stopped on the top row, the middle row, and the bottom row of the reel M3d; and a BLANK, a 1BAR, and a BLANK are respectively stopped on the top row, the middle row, and the bottom row of the reel M3e, forming the final symbol matrix. As a result, five JACKPOTs are finally stopped in display and the unit game ends.

In such an example where five JACKPOTs are stopped in the predictive effects but the number of JACKPOTs does not increase in the li-zhi effects and the five stopped JACKPOTs stay in display, a winning pattern for normal payout is completed in the predictive effects and the winning pattern remains in the li-zhi effects. However, the player wants to see the game result while expecting the intermediate state will change into the first example; accordingly, the gaming machine 10 can attract the player's attention until the end of the unit game.

### <<<Combinations of Predictive Effects (First Effects) and Li-Zhi Effects (Second Effects)>>>

Combinations of predictive effects (first effects) and li-zhi effects (second effects) are described.

The predictive effects are produced by motion of five reels M3a to M3e from start of spinning of the five reels M3a to M3e until an intermediate state where at least one reel is stopped and the remaining reels still keep spinning There are a plurality of kinds of predictive effects defined; a kind of predictive effects is determined with reference to a predictive effect lottery table selected based on both of the Kind number and the stop pattern. In accordance with the determined predictive effects, the motion of the five reels M3a to M3e is controlled from the start of spinning until the intermediate state. Through the predictive effects, at least one reel is stopped and to-be stopped symbols appear in the display window 150, forming a part of a to-be stopped symbol matrix.

The li-zhi effects are produced by motion of the five reels M3a to M3e from the intermediate state where at least one reel is stopped and the remaining reels still keep spinning until all the five reels M3a to M3e are stopped. There are a plurality of kinds of li-zhi effects defined; a kind of li-zhi effects is determined with reference to a li-zhi effect lottery table selected based on three of the Kind number, the stop pattern, and the predictive effects. In accordance with the determined li-zhi effects, the motion of the five reels M3a to M3e is controlled from the intermediate state until all the reels are stopped. Through the li-zhi effects, the remaining reels that are not stopped in the predictive effects are stopped and all to-be stopped symbols appear in the display window 150.

In this way, predictive effects from the start of spinning of the five reels M3a to M3e until the intermediate state are performed and successively li-zhi effects from the intermediate state until all the five reels M3a to M3e are stopped are performed, so that a to-be stopped symbol matrix composed of fifteen (=5×3) symbols is formed (rearranged) in the display window 150 as an actually stopped symbol matrix.

(1) At the End of Predictive Effects: No Benefit; at the End of Li-Zhi Effects: No Benefit

In the case where the number of JACKPOTs stopped in the predictive effects is less than four and the final number of JACKPOTs shown after the li-zhi effects is less than four, no winning pattern is made; the game is lost.

(2) At the End of Predictive Effects: No Benefit; at the End of Li-Zhi Effects: Normal Payout

In the case where the number of JACKPOTs stopped in the predictive effects is less than four and the final number of JACKPOTs shown after the li-zhi effects is four or five, no winning pattern is made in the predictive effects and a winning pattern to provide a normal payout is made.

(3) At the End of Predictive Effects: No Benefit; at the End of Li-Zhi Effects: Normal Payout Plus Payout from Progressive Jackpot

In the case where the number of JACKPOTs stopped in the predictive effects is less than four and the final number of JACKPOTs shown after the li-zhi effects is six or more, no winning pattern is made in the predictive effects and a winning pattern to provide a normal payout and a payout from the progressive jackpot is made.

It is preferable to configure the gaming machine 10 to determine one of the foregoing (1) to (3) in each unit game. As a result, the player finds difficulty in identifying the pattern; the gaming machine 10 can attract the player until the end of each unit game.

(4) At the End of Predictive Effects: Normal Payout; at the End of Li-Zhi Effects: Normal Payout

In the case where the number of JACKPOTs stopped in the predictive effects is four or five and the final number of JACKPOTs shown after the li-zhi effects is four or five, a winning pattern to provide a normal payout is made in the predictive effects and a winning pattern to provide a normal payout is made in the li-zhi effects. This combination includes a case where JACKPOTs are increased in such a manner that four JACKPOTs are stopped in the predictive effects and five JACKPOTS are shown after the li-zhi effects. The JACKPOTs may not be increased in the li-zhi effects. The player can feel expectation for a benefit provided in the li-zhi effects.

(5) At the End of Predictive Effects: Normal Payout; at the End of Li-Zhi Effects: Normal Payout Plus Payout from Progressive Jackpot

In the case where the number of JACKPOTs stopped in the predictive effects is four or five and the final number of JACKPOTs shown after the li-zhi effects is six or more, a winning pattern to provide a normal payout is made in the predictive effects and a winning pattern to provide a normal payout and a payout from the progressive jackpot is made.

It is preferable to configure the gaming machine 10 to determine either the foregoing (4) or (5) in each unit game. As a result, the player finds difficulty in identifying the pattern; the gaming machine 10 can attract the player until the end of each unit game.

(6) At the End of Predictive Effects and at the End of Li-Zhi Effects: Normal Payout Plus Payout from Progressive Jackpot

In the case where the number of JACKPOTs stopped in the predictive effects is six or more and the final number of JACKPOTs shown after the li-zhi effects is six or more, a winning pattern to provide a normal payout and a payout from the progressive jackpot is made in the predictive effects and a winning pattern to provide a normal payout and a payout from the progressive jackpot is made in the li-zhi effects. This combination includes a case where JACKPOTs are increased in such a manner that more JACKPOTs are shown after the li-zhi effects than the JACKPOTS stopped in the predictive effects. It is preferable to configure the gaming machine 10 to determine whether to increase or maintain the JACKPOTs in each unit game. As a result, the player finds difficulty in identifying the pattern, the gaming machine 10 can attract the player until the end of each unit game.

As understood from the above, the gaming machine 10 provides two kinds of benefits; the benefit determined in the predictive effects and the benefit determined in the li-zhi effects. Accordingly, the gaming machine 10 can keep the player to feel expectation for the final benefit until the end of each unit game.

What is claimed is:

1. A gaming machine comprising:
a symbol display device including a display region for displaying a result of a unit game by rearranging symbols including special symbols; and
a controller programmed to perform the following processing of (1-1) to (1-3):
(1-1) symbol determination processing of randomly determining symbols to be rearranged in the display region;
(1-2) processing of identifying an arrangement pattern of special symbols in the display region, the arrangement pattern being determined with the symbols determined in the symbol determination processing; and
(1-3) symbol effect determination processing of determining symbol effects by motion of symbols from start of movement until completion of rearranging the symbols based on the arrangement pattern.

2. The gaming machine according to claim 1, wherein the controller is programmed to perform the following processing of (2-1) and (2-2):
(2-1) processing of identifying the number of special symbols to be displayed among the symbols determined in the symbol determination processing; and
(2-2) symbol effect determination processing of determining symbol effects by motion of symbols from start of movement until completion of rearranging the symbols based on the number of special symbols to be displayed and the arrangement pattern.

3. The gaming machine according to claim 1,
wherein the symbol display device is capable of displaying a plurality of symbol arrays being scrolled, the plurality of symbol arrays being composed of the symbols,
wherein the symbol display device starts the movement by starting displaying scroll of all the symbol arrays,
wherein the symbol display device completes the rearranging by stopping displaying the scroll of all the symbol arrays,
wherein the symbol effects include:
first effects from the start of the movement until stop of display of scroll of a part of the symbol arrays; and
second effects by displaying scroll of remaining symbol array or arrays after stopping displaying scroll of the part of the symbol arrays.

4. The gaming machine according to claim 3, wherein the second effects are determined based on the first effects.

5. The gaming machine according to claim 3, wherein the controller is programmed to perform the following processing of (5-1) to (5-3):
(5-1) processing of determining whether the number of special symbols in the symbols determined in the processing of (1-1) is a predetermined number or more;
(5-2) processing of rearranging the symbols by stopping the plurality of symbol arrays and determining a payout corresponding to the number of the special symbols in a case where the number of the special symbols is the predetermined number or more; and
(5-3) processing of stopping symbol arrays to show a special symbol first among the plurality of symbol arrays and stopping remaining symbol arrays not to show a special symbol afterwards in a case where the number of the special symbols is less than the predetermined number.

6. The gaming machine according to claim 3, wherein the controller is programmed to perform the following processing of (5-1), (5-4), and (5-3):
(5-1) processing of determining whether the number of special symbols in the symbols determined in the processing of (1-1) is a predetermined number or more;
(5-4) processing of stopping symbol arrays to show a special symbols first among the plurality of symbol arrays and stopping remaining symbol arrays not to show a special symbol afterwards in a case where the number of the special symbols is the predetermined number or more; and
(5-3) processing of stopping symbol arrays to show a special symbol first among the plurality of symbol arrays and stopping remaining symbol arrays not to show a special symbol afterwards in a case where the number of the special symbols is less than the predetermined number.

7. A gaming machine comprising:
a symbol display device including a display region for displaying a result of a unit game by rearranging symbols including special symbols in a form of a matrix;
a memory for storing tables; and
a controller programmed to perform the following processing of (1-1) to (1-8):
(1-1) symbol determination processing of randomly determining symbols to be rearranged in the display region;
(1-2) processing of identifying the final number of special symbols included in the symbols determined in the symbol determination processing and to be finally displayed;
(1-3) processing of identifying an arrangement pattern of special symbols determined with the symbols determined in the symbol determination processing; and
(1-4) first table selection processing of selecting a first table for determining first motion of the symbols from start of movement until an intermediate state between the start of movement and completion of rearranging the symbols based on the final number and the arrangement pattern;
(1-5) first motion determination processing of determining the first motion with reference to the first table;
(1-6) second table selection processing of selecting a second table for determining second motion of the symbols from the intermediate state until the completion of rearranging the symbols based on the final number, the arrangement pattern, and the first table;
(1-7) second motion determination processing of determining the second motion with reference to the second table; and
(1-8) symbol motion control processing of controlling the symbols to perform the first motion and the second motion.

8. The gaming machine according to claim 7, wherein the controller is programmed to perform the following processing of (3-1) to (3-4):
(3-1) first kind of payout determination processing of determining to provide a first kind of payout in a case where the final number is a first predetermined number or more;
(3-2) second kind of payout determination processing of determining to provide a second kind of payout in a case where the final number is a second predetermined number or more, the second predetermined number being greater than the first predetermined number;
(3-3) first-a stop processing of displaying stop of scatter symbols not less than the first predetermined number and less than the second predetermined number included in a part of the symbol arrays in the display region, when stopping display of scroll of the part of the symbol arrays and keeping display of scroll of the remaining symbol arrays in accordance with the first motion in a case where the final number is the second predetermined number or more; and
(3-4) first-b stop processing of displaying stop of the final number of scatter symbols in the display region, when stopping the remaining symbol arrays and rearranging the determined symbols in accordance with the second motion after the processing of (3-3).

9. The gaming machine according to claim 8, wherein the controller is programmed to perform the following processing of (4-1) and (4-2):
(4-1) second-a stop processing of displaying stop of scatter symbols not less than the first predetermined number and less than the second predetermined number included in a part of the symbol arrays in the display region, when stopping display of scroll of the part of the symbol arrays and keeping display of scroll of the remaining symbol arrays in accordance with the first motion in a case where the final number is not less than the first predetermined number and less than the second predetermined number; and
(4-2) second-b stop processing of displaying stop of the final number of scatter symbols in the display region, when stopping the remaining symbol arrays and rearranging the determined symbols in accordance with the second motion after the processing of (4-1).

10. The gaming machine according to claim 7,
wherein the memory stores first tables which are tables for determining motion of the plurality of symbol arrays from the start of movement until the intermediate state and for randomly selecting one kind of motion for the first motion from a plurality of kinds of motion, and
wherein the memory stores second tables which are tables for determining motion of the plurality of symbol arrays from the intermediate state until the rearranging and for randomly selecting one kind of motion for the second motion from a plurality of kinds of motion.

11. The gaming machine according to claim 7,
wherein the memory stores stop pattern tables storing a plurality of stop patterns of the special symbols, and
wherein the processing of (1-3) identifies an arrangement pattern of special symbols from the plurality of stop patterns with reference to the stop pattern tables based on the final number of the special symbols.
